(19) United States
(12) Patent Application Publication
(10) Pub. No.: US 2012/0231217 A1
(43) Pub. Date: Sep. 13, 2012

(54) OPTICAL FILM, PHASE DIFFERENCE FILM, POLARIZING PLATE AND LIQUID CRYSTAL DISPLAY DEVICE

(75) Inventors: Yasuyuki SASADA, Kanagawa (JP); Masaya SUZUKI, Kanagawa (JP); Hiroyuki KAWANISHI, Kanagawa (JP)

(73) Assignee: FUJIFILM CORPORATION, Tokyo (JP)

(21) Appl. No.: 13/414,326

(22) Filed: Mar. 7, 2012

(30) Foreign Application Priority Data
Mar. 7, 2011 (JP) 2011-049489
Mar. 5, 2012 (JP) 2012-048277

(51) Int. Cl. B32B 23/00; B32B 5/00; B29C 39/12; B32B 3/00

(52) U.S. Cl. 428/141; 428/220; 428/485; 264/255

(57) ABSTRACT

An optical film, including: an additive; a wax component; and a cellulose ester, wherein the optical film satisfies the following equations (1) and (2): Equation (1): |ΔC/Ct|≧0.1×(Ct/d−0.3) and Equation (2): Ct/d≧0.375; wherein Ct represents a total content of the additive whose unit is % by mass, d represents a film thickness whose unit is μm, and ΔC is represented by Ct−Cs; wherein Cs represents a surface content of the additive in at least one side of the optical film.

### CROSS-REFERENCE TO RELATED APPLICATION(S)

The present application claims priority from Japanese Patent Application Nos. 2011-049489 filed on Mar. 7, 2011 and 2012-048277 filed on Mar. 5, 2012, the entire content of which is incorporated herein by reference.

### BACKGROUND

1. Field

The present invention relates to an optical film containing cellulose ester that exhibits good adhesion to a polarization film and is capable of being directly attached to a polarization film, a phase difference film using the optical film, and a highly reliable polarizing plate, a liquid crystal panel, and a liquid crystal display device using the optical film.

2. Description of Related Art

Films of polymers typified by cellulose esters, polyesters, polycarbonates, cycloolefin polymers, vinyl polymers, polyimides, and the like are used in silver halide photographic photosensitive materials, phase difference films, polarizing plates and image display devices. From these polymers, films which are excellent in flatness and uniformity may be prepared, and thus are widely employed as films in optical applications.

Among them, it is possible for a cellulose acylate film having an appropriate moisture permeability to be online directly attached to a polarization film including polyvinyl alcohol (PVA)/iodine, which is most commonly used. Therefore, a cellulose acylate film, particularly a cellulose acetate film, is widely employed as a protective film of a polarizing plate.

When these films are used in optical applications such as a phase difference film, a support of a phase difference film, a protective film of a polarizing plate and a liquid crystal display device, it is a very important factor in determining the display device performance (for example, visibility) to control the optical anisotropy. With the recent demand for viewing angle enhancement in liquid crystal display devices, improvement of retardation compensation has been desired, and the retardation value in an in-plane direction (Re; hereinafter, simply referred to as “Re”) and the retardation value in a thickness direction (Rth; hereinafter, simply referred to as “Rth”), of a phase difference film disposed between a polarization film and a liquid crystal cell, are required to be appropriately controlled. For example, in liquid crystal display devices in an IPS mode, which are widely used for use in liquid crystal TV sets, both Re and Rth are required to be reduced, and thus, for example, JP-A-2009-098674 discloses a technology which allows polyester diol having a hydroxyl group at both terminals thereof to be contained in cellulose acylate in an amount of 5% by mass or more. Both Re and Rth are all required to be increased in liquid crystal display devices in a VA mode, and thus in order to achieve appropriate adjustment of Re and Rth, technologies for performing adjustment of materials constituting a film or adjustment of a film forming method, and a film stretching operation are disclosed (see, for example, EP Patent No. 0911656, JP-A-5-257014, JP-A-2005-138358 and JP-A-2001-100039).

Meanwhile, it has been found that, as a liquid crystal display device becomes thinner, circular light unevenness occurs when the display surface is observed from the front side under a specific condition. While the mechanism of the occurrence of such light unevenness has not altogether been clarified, one of the causes is a contact between a backlight member and a liquid crystal panel (particularly, the polarizing plate on the backlight side). Therefore, JP-A-2009-169393 discloses a method for inhibiting the occurrence of light unevenness by forming unevenness on the surface of the backlight side protective film of a polarizing plate on the backlight side so as to prevent a contact with a backlight member.

However, when a polyethylene terephthalate film is used as a protective film of a polarizing plate as in JP-A-2009-169393, there is difficulty in processability of a polarizing plate, and thus, there are some obvious problems that a decrease in production rate of a polarizing plate is caused, that warpage of a liquid crystal panel using the polarizing plate occurs, or that a light unevenness occurs on the outer periphery of a specific display surface.

Therefore, in order to solve these problems in the related art, the present inventors have studied to manufacture an optical film and a polarizing plate, which have excellent processability of a polarizing plate and do not generate circular light unevenness on the display surface of a liquid crystal display device or light unevenness on the outer periphery of a liquid crystal display device, as an object of the present invention. It has been found that these problems may be solved by using, as an optical film containing cellulose ester, in which elastic modulus, photoelasticity, film thickness, moisture absorptivity and humidity dependence of Rth are reduced.

However, if these films are continuously manufactured, new problems became obvious in that the haze of a film is increased as time passes or haze unevenness occurs to the film.

The present inventors have conducted intensively studies to solve the above-mentioned problems, and as a result, have found out that the problem of haze is derived from the surface shape transfer of a casting support. That is, it can be thought that when a dope including large amounts of additives as in the present invention or a thin film is manufactured, the casting support is prone to be contaminated and the shape transferability is high due to high drying rate on the support, and thus the haze is increased. When pressure is applied on these films, for example, as in the case where the casting support is made into a roll shape, the transferred surface shape is crumbled and thus the haze is changed. Accordingly, it has been found that it is preferred that the amount of an additive into a portion in contact with the casting support is locally reduced or the kind of an additive used is selected in order to inhibit the casting support from being contaminated, the solid concentration in the portion in contact with the casting support is reduced in order to inhibit the shape transferability, and the surface hardness is increased when the surface roughness (Ra) is high in order to inhibit the change in the surface shape, and that a film in which even problems of the light unevenness and the haze unevenness have been solved may be manufactured by appropriately combining them, thereby completing the present invention.

### SUMMARY

That is, the present invention may be accomplished by the following means.

(1) An optical film, including: an additive; a wax component; and a cellulose ester, wherein the optical film satisfies the following equations (1) and (2):

|ΔC/Ct|≧0.1×(Ct/d−0.3) Equation (1)

Ct/d≧0.375 Equation (2)

wherein Ct represents a total content of the additive whose unit is % by mass, d represents a film thickness whose unit is μm, ΔC is represented by Ct−Cs:

wherein Cs represents a surface content of the additive in at least one side of the optical film, and Ct and Cs are represented by the following formulae, respectively:

Ct=(total mass of the additive contained in the entire optical film)/(total mass of the cellulose ester contained in the entire optical film)×100

Cs=(mass of the additive contained in a region from the surface of the optical film to 3 μm away from the surface of the optical film)/(mass of the cellulose ester contained in a region from the surface of the optical film to 3 μM away from the surface of the optical film)×100.

(2) The optical film according to (1), wherein the additive is a compound having repeating units.
(3) The optical film according to (1), wherein the additive contains a condensate between a polyalcohol and a polybasic acid.
(4) The optical film according to (3), wherein the additive is a condensate between a glycol having carbon atoms of 2 to 12 and a dibasic acid having carbon atoms of 4 to 12.
(5) The optical film according to (1), wherein the wax component contains at least one selected from the group consisting of a fatty acid, a metal salt of fatty acid and a fatty acid ester.
(6) The optical film according to (1), wherein the ΔC is greater than zero.
(7) The optical film according to (1), wherein the ΔC is calculated by using a smaller value among Cs at one side of the optical film and Cs at the other side of the optical film
(8) The optical film according to (1), wherein absolute value of the ΔC is 50% by mass or less.
(9) The optical film according to (1), wherein the Cs is 50% by mass or less.
(10) The optical film according to (1), further including a compound represented by Formula (1) or (2):

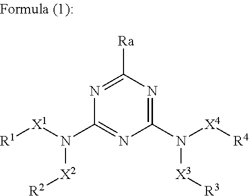

wherein Ra represents a substituted or unsubstituted alkyl group, a substituted or unsubstituted alkenyl group, a substituted or unsubstituted alkynyl group, a substituted or unsubstituted heterocyclic group, or a substituted or unsubstituted aryl group,

X¹, X², X³ and X⁴ each independently represent a single bond or a divalent linking group, and

R¹, R², R³ and R⁴ each independently represent a hydrogen atom, a substituted or unsubstituted alkyl group, a substituted or unsubstituted alkenyl group, a substituted or unsubstituted alkynyl group, a substituted or unsubstituted aryl group, a substituted or unsubstituted acyl group or a substituted or unsubstituted heterocyclic group:

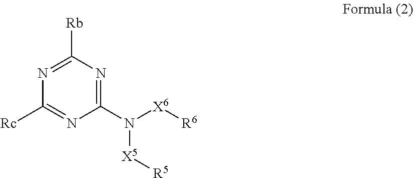

wherein Rb and Rc each independently represent a substituted or unsubstituted alkyl group, a substituted or unsubstituted alkenyl group, a substituted or unsubstituted alkynyl group, a substituted or unsubstituted heterocyclic group, or a substituted or unsubstituted aryl group, and

X⁵ and X⁶ each independently represent a single bond or a divalent linking group,

R⁵ and R⁶ each independently represent a hydrogen atom, a substituted or unsubstituted alkyl group, a substituted or unsubstituted alkenyl group, a substituted or unsubstituted alkynyl group, a substituted or unsubstituted aryl group, a substituted or unsubstituted acyl group, or a substituted or unsubstituted heterocyclic group.

(11) The optical film according to (1), wherein a surface roughness (Ra) on at least one surface is more than 3 nm, and a surface hardness on the surface is 50 N/mm² or more.
(12) The optical film according to (1), wherein a surface roughness (Ra) on at least one surface is 3 nm or less.
(13) The optical film according to (1), wherein a thickness of the optical film is 5 to 120 μm.
(14) The optical film according to (1), wherein the cellulose ester contains at least cellulose acylate, and the cellulose acylate satisfies a relation of DSs≦DSc:

wherein DSs represents a degree of substitution of acyl of the cellulose acylate contained in a region from the surface of the optical film to 1 μm away in a thickness direction of the optical film, and

DSc represents a degree of substitution of acyl of cellulose acylate contained in a region from the center in the thickness direction of the optical film to 1 μm away in the thickness direction.

(15) A laminate including at least two optical films according to (1).
(16) A phase difference film including at least the optical film according to (1).
(17) A polarizing plate including at least the optical film according to (1).
(18) An image display device including at least the optical film according to (1).
(19) A method for manufacturing the optical film according to (1), the method including: casting at least two layers by a co-casting method, wherein at least one layer of the at least two layers is a layer comprising the additive, the wax component and the cellulose ester, and

in the at least two layers, content (c1) of the additive relative to the cellulose ester in a dope solution for forming the at least one layer, whose unit is % by mass, and content (c2) of an additive relative to the cellulose ester in a dope solution for forming a layer other than the at least one layer, whose unit is % by mass, satisfy a relation of |Δc=c2−c1|≧2.

(20) The method according to (19), wherein the Δc is greater than zero, and the dope solution having the additive content of c2 is disposed on a side in contact with a casting support.
(21) A method for manufacturing the optical film according to (1), the method including: casting at least two layers by a co-casting method, wherein at least one layer of the at least two layers is a layer containing the additive, the wax component and the cellulose ester, in the at least two layers, solid concentration (d1) in a dope solution for forming the at least one layer and solid concentration (d2) in a dope solution for forming the other layer satisfy a relationship of d1>d2, and the dope solution having the solid concentration of d2 is disposed on a side in contact with a casting support.
(22) The method according to (19), wherein absolute value of the ΔC is 50% by mass or less.

An optical film containing cellulose ester of the present invention has a desired retardation and a desired humidity dependence of retardation, and may be used as an optical film having relatively low haze, less haze unevenness, and an excellent appearance in a polarizing plate or a liquid crystal display device. A liquid crystal panel and a liquid crystal display device, using a phase difference film or a polarizing plate manufactured by using the optical film of the present invention, have reduced the occurrence of light unevenness on the display surface when observed from the front surface and the inclined surface, thereby exhibiting excellent reliability.

### DETAILED DESCRIPTION OF THE INVENTION

Hereinafter, the present invention will be described in detail. Meanwhile, in the present specification, when the numerical values represent physical property values, characteristic values and the like, the description “(numerical value 1) to (numerical value 2)” means “(numerical value 1) or more and (numerical value 2) or less”.

The optical film of the present invention is a film containing cellulose ester, an additive and wax component, wherein a total content (Ct, unit: % by weight) of the additive added, a film thickness (d, unit: μm), and a content difference (ΔC=Ct−Cs) of a surface content (Cs, unit: % by mass) of the additive and the total amount (Ct) of the additive added satisfy the following Equations (1) and (2).

|ΔC/Ct|≧0.1×(Ct/d−0.3) Equation (1)

Ct/d≧0.375 Equation (2)

Cs relates to at least one surface of the optical film, which is represented by the following equation.

Cs=(mass of the additive contained in a region from the surface of the optical film to 3 μm away from the surface of the optical film)/(mass of the cellulose ester contained in a region from the surface of the optical film to 3 μm away from the surface of the optical film)×100

Ct is represented by the following equation.

Ct=(total mass of the additive contained in the entire optical film)/(total mass of the cellulose ester contained in the entire optical film)×100

Incidentally, as the additive, additives typically used in cellulose ester (for example, Japan Institute of Invention and Innovation Journal of Technical Disclosure 2001-1745) may be used, and compounds having repeating units as described below are preferable from the viewpoint of inhibiting a bleed out or inhibiting volatilization in the manufacturing process of a film.

In the present invention, the additive is a component other than the wax component and the cellulose ester. When the total content of the additive (Ct) and the surface content of the additive (Cs) are calculated, the additive does not include the wax component and the cellulose ester.

The optical film according to the present invention contains a compound having repeating units under a condition satisfying the Equation (1) based on the cellulose ester, and therefore when continuously manufactured, an increase of the haze may be inhibited, or the generation of haze unevenness in the film may be inhibited.

The Equation (1) more preferably satisfies the following Equation (1a).

|ΔC/Ct|≧0.1×(Ct/d−0.4) Equation (1a)

Also, by incorporating the compound having repeating units to satisfy the Equation (2), it becomes possible to appropriately control the elastic modulus, photoelasticity, film thickness and moisture absorptivity of the film, thereby reducing light unevenness of a liquid crystal display device.

The Equation (2) more preferably satisfies the following Equation (2a).

Ct/d≧0.563 Equation (2a)

The Equation (2) even more preferably satisfies the following Equation (2b).

Ct/d≧0.750 Equation (2b)

In the present invention, the content (% by mass) of the additive based on the cellulose ester represents “phr”.

The total content (Ct) of an additive (preferably a compound having repeating units) is preferably 20 phr to 200 phr, more preferably 30 phr to 180 phr, and even more preferably 45 phr to 150 phr. However, there may be the case where the content of the additive is preferably 2 to 100 phr, more preferably 5 to 50 phr, and even more preferably 6 to 30 phr within the range where the above Equation (2) is satisfied. From the viewpoint of improving the light unevenness, in particular, the latter preferred embodiment may be preferably applied to the case of a film having a thin film thickness. What the addition amount and the film thickness satisfy such conditions is preferred because the light unevenness may be improved. The content of the additive is preferably 200 phr or less because a bleed out from the film is easily inhibited. In the case of a film having a thin film thickness, since a bleed out from the film tends to be promoted, an upper limit of the addition amount is set up low.

The Ct/d value may be adjusted within the range of ±0.05 depending upon the kind of the additive. In the case of an additive having a high effect for reducing a humidity dependence of Rth, the Ct/d value may also be increased, and for example, additives having high compatibility with cellulose ester may be exemplified.

In the present invention, by containing the additive satisfying the condition of the above Equation (2), the light unevenness is improved. For that reason, it has been noted that when the total addition content (Ct) is increased, or the film thickness (d) is decreased, a drying rate during film formation becomes fast. Then, when continuously manufactured, it has been noted that there is caused such a problem that the increase of haze becomes conspicuous. However, when a film satisfying the condition of the above Equation (1) is formed, it has been noted that contamination of the support during film formation or shape transferability of irregularities of the support may be reduced, whereby a film which is inhibited in haze and haze unevenness is obtained. Though a detailed mechanism has not been elucidated yet, it may be conjectured that evils caused due to an increase of Ct reside in the matters that the additive easily bleeds out, whereby the support is easily contaminated; that the glass transition temperature or hydrophilic/hydrophobic properties of the dope change, whereby impurities (for example, metal components or wax components) contained in the cellulose ester easily deposit, and the support is easily contaminated; and that the drying rate becomes fast, and when separated from the support, the amount of the residual solvent becomes small, and thus, the irregular shape of the surface of the once transferred support is hardly achieved for leveling. On the other hand, it may be conjectured that evils caused due to a decrease of d reside in the matters that a bleed out of the additive is promoted due to a conspicuous increase of the drying rate, whereby the support is easily contaminated; that in the case of performing film formation with a mixed solvent, the solvent composition changes in a drying process, whereby hydrophilic/hydrophobic properties of the dope and the like change, and as a result, impurities contained in the cellulose ester are easily transferred; and that when separated from the support, the amount of the residual solvent becomes small, and thus, the irregular shape of the surface of the once transferred support is hardly achieved for leveling.

Meanwhile, when two or more additives are included, the combined content of the two or more additives in the optical film of the present invention may be within the above-described range.

[Compound Having Repeating Units]

Compounds having repeating units used in the present invention will be described.

It is preferred that the optical film of the present invention contains a compound having a molecular mass of 600 to 5,000, and having repeating units.

The number average molecular mass (Mn) of the compound having repeating units according to the present invention is preferably 600 to 3,000, more preferably 650 to 2,300, and most preferably 700 to 1,800. When the number average molecular mass of the compound having repeating units is 600 or more, the compound has low volatility, which makes occurrence of film defects or process contamination from sublimation under a high temperature condition difficult during the formation or stretching of the optical film of the present invention, and at the same time, the changes in retardation observed when the film is kept under a moist heat environment may be inhibited by increasing the molecular mass of the compound. When the number average molecular mass is 5,000 or less, the compatibility with cellulose ester may be secured, and thus it is difficult for the bleed out to occur. However, the compound having repeating units according to the present invention is not limited only to a system consisting solely of a compound having repeating unit moieties, and may be a mixture of such a compound having repeating units and a compound having no repeating unit.

The number average molecular mass of the compound having repeating units according to the present invention may be measured and evaluated by gel permeation chromatography.

The compound having repeating units of the present invention may be either liquid or solid under an environmental temperature or humidity to be used (generally at room temperature, so-called 25° C. and 60% relative humidity). The compound preferably has no or little color and is particularly preferably colorless. The compound is preferably thermally stable at higher temperatures, and preferably has a decomposition onset temperature of 150° C. or higher, and more preferably 200° C. or higher.

Hereinafter, the compound having repeating units for use in the present invention will be described in detail with reference to specific examples thereof, but the compound having repeating units which may be used in the present invention is not limited thereto.

(Kind of Compound Having Repeating Units)

The compound having repeating units which may be used in the optical film of the present invention is not particularly limited, but may include condensates or adducts, and preferred examples of the condensates include a condensate of a polyhydric alcohol and a polybasic acid, a condensate of a polyhydric ether alcohol and a polybasic acid, a condensate of a polyhydric alcohol and a polybasic acid, a condensate with an isocyanate compound, and preferred examples of the adducts include an adduct of acrylic acid ester and an adduct of methacrylic acid ester. At least one compound having a number average molecular mass of 600 or more, which is selected from polyether-based compounds, polyurethane-based compounds, polyether polyurethane-based compounds, polyamide-based compounds, polysulfone-based compounds, polysulfonamide-based compounds and other polymeric compounds to be described below, may be used.

Among them, at least one is preferably a condensate of a polyhydric alcohol and a polybasic acid, a condensate of a polyhydric ether alcohol and a polybasic acid, an adduct of acrylic acid ester, and an adduct of methacrylic acid ester, more preferably a condensate of a polyhydric alcohol and a polybasic acid and a condensate of a polyhydric ether alcohol and a polybasic acid, and even more preferably a condensate of a polyhydric alcohol and a polybasic acid.

Hereinafter, the compound having repeating units preferably used in the present invention will be described in kind.

(Condensate of Polyhydric Alcohol and Polybasic Acid)

First, a condensate of a polyhydric alcohol and a polybasic acid used in the present invention will be described. A preferred condensate of a polyhydric alcohol and a polybasic acid is not particularly limited, but is obtained by a reaction between a dibasic acid and a glycol. Both the terminals of the reactants may be from the reactants per se, but, when a so-called terminal blocking is performed by further reacting the reactants with a monocarboxylic acid or a monohydric alcohol, the changes in retardation observed when the film is kept under a moist heat environment may be preferably inhibited. Since these condensates have a reduced hydroxyl value as compared with non-terminal-blocked condensates, the condensates preferably have a hydroxyl value of less than 40 mgKOH/g, more preferably 20 mgKOH/g or less, and even more preferably 10 mgKOH/g or less.

In the condensate of the polyhydric alcohol and the polybasic acid used in the present invention, the polyhydric alcohol preferably includes a polyhydric alcohol having at least 3 carbon atoms or more from the viewpoint of inhibiting the contamination of a casting support.

The condensate of the polyhydric alcohol and the polybasic acid used in the present invention is preferably synthesized from a glycol having 2 to 12 carbon atoms and a dibasic acid having 4 to 12 carbon atoms.

The dibasic acid which is used in the condensate of the polyhydric alcohol and the polybasic acid of the present invention is preferably an aliphatic dicarboxylic acid residue or an alicyclic dicarboxylic acid residue having 3 to 12 carbon atoms, or an aromatic dicarboxylic acid residue having 8 to 12 carbon atoms. In order to improve the degree of the bleed out due to the heat treatment, it is more preferred to contain an aliphatic polybasic acid having at least 4 carbon atoms or less and/or to include an aromatic polybasic acid. The glycol is preferably an aromatic or alicyclic glycol residue having 2 to 12 carbon atoms or an aromatic glycol residue having 6 to 12 carbon atoms. These may be appropriately selected and used according to a desired retardation, and may be used either alone or in combination of two or more thereof. For example, when it is desired to manufacture a film with reduced retardation, it is preferred to select an aliphatic or alicyclic dicarboxylic acid residue or a phthalic acid residue and an aliphatic or alicyclic glycol residue. When it is desired to manufacture a film with increased retardation, it is preferred to include an aromatic dicarboxylic acid residue and/or an aromatic glycol residue.

Hereinafter, the dibasic acids and glycols that may be preferably used to synthesize the condensate of the polyhydric alcohol and the polybasic acid according to the present invention will be described.

As the dibasic acid, any of aliphatic dicarboxylic acid and aromatic dicarboxylic acid may be used.

Examples of the aliphatic dicarboxylic acid include oxalic acid, malonic acid, succinic acid, maleic acid, fumaric acid, glutaric acid, adipic acid, suberic acid, azelaic acid, cyclohexane dicarboxylic acid, sebacic acid, dodecane dicarboxylic acid and the like. Among them, it is preferred to contain malonic acid, succinic acid and adipic acid from the viewpoint of improving compatibility.

Examples of the aromatic dicarboxylic acid include phthalic acid, terephthalic acid, isophthalic acid, 1,5-naphthalenedicarboxylic acid, 1,4-naphthalenedicarboxylic acid and the like. Among them, phthalic acid and terephthalic acid are preferable, and terephthalic acid is particularly preferable.

The dibasic acid used in the invention preferably has 3 to 12 carbon atoms, more preferably 4 to 8 carbon atoms, and even more preferably 4 to 6 carbon atoms. A mixture of two or more dibasic acids may be used in the present invention, in which case the two or more dibasic acids preferably have an average number of carbon atoms within the above-described range. If the number of the carbon atoms of the dibasic acids is within the above-described range, it is preferred because the condensate achieves not only reduction of light unevenness but also hardly bleeds out even during formation of, or stretching of an optical film under heating due to good compatibility thereof with cellulose ester.

It is also preferred to use an aliphatic dicarboxylic acid and an aromatic dicarboxylic acid in combination. Specifically, a combination of adipic acid and phthalic acid, a combination of adipic acid and terephthalic acid, a combination of succinic acid and phthalic acid, and a combination of succinic acid and terephthalic aid are preferred, and a combination of succinic acid and phthalic acid and a combination of succinic acid and terephthalic acid are more preferred. When an aliphatic dicarboxylic acid and an aromatic dicarboxylic acid are used in combination, the ratio (molar ratio) of both acids is not particularly limited, but is preferably 95:5 to 40:60, and more preferably 55:45 to 45:55.

Examples of the glycol (diol) include aliphatic diols and aromatic diols, and aliphatic diols are preferred.

Examples of the aliphatic diols include alkyl diols or alicyclic diols, for example, ethylene glycol (ethanediol), 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol(neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 1,4-cyclohexanediol, 1,4-cyclohexanedimethanol, 2,2,4-trimethyl-1,3-pentanediol, 2-ethyl-1,3-hexanediol, 2-methyl-1,8-octanediol, 1,9-nonanediol, 1,10-decanediol, diethylene glycol and the like.

Preferred aliphatic diols are at least one of ethylene glycol, 1,2-propanediol and 1,3-propanediol, and particularly preferably at least one of ethylene glycol and 1,2-propanediol. When two kinds thereof are used, it is preferable to use ethylene glycol and 1,2-propanediol.

The glycol preferably has 2 to 10 carbon atoms, more preferably 2 to 6 carbon atoms, and particularly preferably 2 to 4 carbon atoms. When two or more glycols are used, the glycols preferably have an average number of carbon atoms within the above-described range. If the number of the carbon atoms of the glycols is within the above-described range, it is preferred because the condensate achieves not only reduction of light unevenness but also hardly bleeds out even during film formation, and film stretching under heating due to good compatibility thereof with a cellulose ester.

It is preferred that both terminals of the condensate of the polyhydric alcohol and the polybasic acid according to the present invention are protected with a monohydric alcohol residue or a monocarboxylic acid residue. In that case, the monohydric alcohol residue is preferably a substituted or unsubstituted monohydric alcohol residue having 1 to 30 carbon atoms, and may include aliphatic alcohols, such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol and the like, and substituted alcohols, such as benzyl alcohol, 3-phenylpropanol and the like.

When a monocarboyxlic acid residue is used for blocking, monocarboxylic acid used as a monocarboxylic acid residue is preferably a substituted or unsubstituted monocarboxylic acid having 1 to 30 carbon atoms. These carboxylic acids may be aliphatic monocarboxylic acids or aromatic carboxylic acids. First, when preferred aliphatic monocarboxylic acids are described, examples thereof include acetic acid, propionic acid, butanoic acid, caprylic acid, caproic acid, decanoic acid, dodecanoic acid, stearic acid, oleic acid and the like, and examples of the aromatic monocarboxylic acids include benzoic acid, p-tert-butylbenzoic acid, o-toluic acid, m-toluic acid, p-toluoylic acid, dimethylbenzoic acid, ethylbenzoic acid, n-propylbenzoic acid, aminobenzoic acid, acetoxybenzoic acid and the like. These monocarboxylic acids may be used either alone or in mixtures of two or more thereof.

In this case, when the monocarboxylic acid residue on both terminals thereof has 3 carbon atoms or less, the condensate has reduced volatility, and thus the loss of the condensate of the polyhydric alcohol and the polybasic acid on heating may not be increased, thereby preventing the occurrence of process contamination or reducing the occurrence of surface defects. From this viewpoint, the monocarboxylic acids used in blocking are preferably aliphatic monocarboxylic acid. The monocarboxylic acids are more preferably an aliphatic monocarboxylic acid having 2 to 22 carbon atoms, even more preferably an aliphatic monocarboxylic acid having 2 to 3 carbon atoms, and particularly preferably an aliphatic monocarboxylic acid residue having 2 carbon atoms. For example, acetic acid, propionic acid, butanoic acid, benzoic acid, and derivatives thereof are preferred, acetic acid or propionic acid is more preferred, and acetic acid (with the terminals being an acetyl group) is most preferred. Two or more kinds of monocarboxylic acids used for blocking may be mixed.

When both terminals of the condensate of the polyhydric alcohol and the polybasic acid are unblocked, the condensate is preferably a polyester polyol.

In conclusion, specific examples of the preferred condensate of the polyhydric alcohol and the polybasic acid include poly(ethylene glycol/adipic acid)ester, poly(propylene glycol/adipic acid)ester, poly(1,3-butanediol/adipic acid)ester, poly(propylene glycol/sebacic acid)ester, poly(1,3-butanediol/sebacic acid)ester, poly(1,6-hexanediol/adipic acid)ester, poly(propylene glycol/phthalic acid)ester, poly(1,3-butanediol/phthalic acid)ester, poly(propylene glycol/terephthalic acid)ester, poly(propylene glycol/1,5-naphthalene-dicarboxylic acid)ester, poly(propylene glycol/terephthalic acid)ester with both terminals thereof being 2-ethyl-hexyl alcohol ester/poly(propylene glycol, adipic acid)ester with both terminals thereof being 2-ethyl-hexyl alcohol ester, acetylated poly(butanediol/adipic acid) ester and the like.

The condensate of the polyhydric alcohol and the polybasic acid may be easily synthesized by typical methods or any method of a heat melt condensation method by (poly)esterification or interesterification between the dibasic acid or alkyl esters thereof and the glycols and an interfacial condensation method between an acid chloride of these acids and the glycols. The condensate of the polyhydric alcohol and the polybasic acid is described in detailed in “The principle and application of plasticizers” edited by Murai Kouichi (Saiwai Shobo Co., Ltd.), 1st edition, published on Mar. 1, 1973. The raw materials disclosed in Japanese Patent Application Laid-Open No. Hei 05-155809, Japanese Patent Application Laid-Open No. Hei 05-155810, Japanese Patent Application Laid-Open No. Hei 5-197073, Japanese Patent Application Laid-Open No. 2006-259494, Japanese Patent Application Laid-Open No. Hei 07-330670, Japanese Patent Application Laid-Open No. 2006-342227, Japanese Patent Application Laid-Open No. 2007-003679, and the like, may be used.

As commercial products, Adekacizer (various products as Adekacizer P and PN series) described in DIARY 2007, page 55 to page 27, available from ADEKA Corporation, as a condensate of a polyhydric alcohol and a polybasic acid may be used, and various products of Polylite described in “Polymer-related Commodity List (2007)”, page 25 by DIC Corporation, page. 25 or various Polycizers described in “Polymer Modifiers of DIC” (published on Apr. 1, 2004 000VIII), page 2 to page 5 by DIC Corporation may be used. A series of Plasthall P from CP Hall Co., USA may be available. Benzoyl functional polyether is commercially available from Velsicol Chemicals, Rosemont, Ill., USA under the trade name of BENZOFLEX (for example, BENZOFLEX 400, polypropylene glycol dibenzoate).

(Condensate of Polyhydric Ether Alcohol and Polybasic Acid)

Subsequently, a condensate of a polyhydric ether alcohol and a polybasic acid used in the present invention will be described. The condensate of a polyhydric ether alcohol and a polybasic acid of the present invention refers to a condensed polymer of dicarboxylic acid and polyether diol. Examples of the dicarboxylic acid include the same aliphatic dicarboxylic acid residues having 4 to 12 carbon atoms and aromatic dicarboxylic acid residues having 8 to 12 carbon atoms as those described in the condensate of the polyhydric alcohol and the polybasic acid.

In order to prevent the contamination of a casting support in the present invention, it is preferred that at least one of the carbon atoms adjacent to the hydroxyl groups of the polyhydric ether alcohol in the condensate of the polyhydric ether alcohol and the polybasic acid is a secondary or tertiary carbon.

Subsequently, examples of polyethers containing an aliphatic glycol having 2 to 12 carbon atoms include polyethylene ether glycol, polypropylene ether glycol, polytetramethylene glycol, and combinations thereof. Examples of the polyether glycols that are typically useful and commercially available, include Carbowax resins, Pluronics resins and Niax resins. The polyester polyether-based plasticizers used in the present invention may be prepared by any polymerization techniques which are commonly known to a person having ordinary skill in the art and typically used.

The condensate of the polyhydric ether alcohol and the polybasic acid is exemplified by a condensate of a polyhydric ether alcohol and a polybasic acid, which is described in U.S. Pat. No. 4,349,469. Basically, the condensate is a condensate of a polyhydric ether alcohol and a polybasic acid synthesized from for example, 1,4-cyclohexanedicarboxylic acid as a dicarboxylic acid component and 1,4-cyclohexanedimethanol, polytetramethylene ether glycol and the like as a polyether component. Other useful condensates of a polyhydric ether alcohol and a polybasic acid may include commercially available resins, such as Hytrel copolyesters from Du Pont and copolymers such as Galflex polymers from GAF. The materials described in Japanese Patent Application Laid-Open No. Hei 5-197073 may be used to prepare these resins. Adekacizer RS series, which are commercially available from ADEKA Corporation, may be used. Polyether ester plasticizers, which are alkyl functionalized polyalkylene oxides, are commercially available under the trade name of PYCAL from ICI Chemicals, Wilmington, Del. (for example, PYCAL94, polyethylene oxide phenyl ester).

(Condensate of Polyhydric Alcohol and Polybasic Acid and Condensate with Isocyanate Compound)

Condensates of a polyhydric alcohol and a polybasic acid and condensates with an isocyanate compound used in the present invention will be described. This condensate may be obtained by a condensation reaction between a condensate of a polyhydric alcohol and a polybasic acid and an isocyanate compound. First, as the condensate of the polyhydric alcohol and the polybasic acid, the above-described condensate of the polyhydric alcohol and the polybasic acid prior to blocking both terminals may be used as it is, and the materials as described above may be preferably used in the condensate of the polyhydric alcohol and the polybasic acid.

Examples of a diisocyanate component which forms a polyurethane structure include polymethylene diisocyanates represented by OCN(CH₂)ₚNCO (p=2 to 8), such as ethylene diisocyanate, trimethylene diisocyanate, tetramethylene diisocyanate, hexamethylene diisocyanate and the like, aromatic diisocyanates, such as p-phenylene diisocyanate, tolylene diisocyanate, p,p′-diphenylmethane diisocyanate, 1,5-naphthylene diisocyanate and the like, and m-xylylene diisocyanate, and the like, but are not limited thereto. Among them, tolylene diisocyanate, m-xylylene diisocyanate and tetramethylene diisocyanate are particularly preferred.

In the present invention, the condensate of the polyhydric alcohol and the polybasic acid and the condensate with the isocyanate compound may be easily synthesized by a usual synthetic method by mixing and heating the polyester diols and diisocyanate as raw materials while stirring. The materials described in Japanese Patent Application Laid-Open No. Hei 5-197073, Japanese Patent Application Laid-Open No. 2001-122979, Japanese Patent Application Laid-Open No. 2004-175971, Japanese Patent Application Laid-Open No. 2004-175972, and the like, may be used.

(Other Polymer-Based Additives)

In the present invention, not only the above-described condensates but also other polymer-based additives may be used. Examples of the polymer-based additives include aliphatic hydrocarbon polymers, alicyclic hydrocarbon polymers, acrylic polymers, such as polyacrylic esters, polymethacrylic esters and the like (as an ester group, a methyl group, an ethyl group, a propyl group, a butyl group, an isobutyl group, a pentyl group, a hexyl group, a cyclohexyl group, an octyl group, a 2-ethylhexyl group, a nonyl group, an isononyl group, a tert-nonyl group, a dodecyl group, a tridecyl group, a stearyl group, an oleyl group, a benzyl group, a phenyl group and the like), vinyl-based polymers, such as polyvinyl isobutyl ether, poly(N-vinylpyrrolidone) and the like, styrene-based polymers, such as polystyrene, poly(4-hydroxystyrene) and the like, polyethers, such as polyethylene oxide, polypropylene oxide and the like, polyamide, polyurethane, polyurea, phenol-formaldehyde condensates, urea-formaldehyde condensates, polyvinyl acetate and the like.

These polymer additives may be single polymers having repeating units of one kind or copolymers having a plurality of repeating structures. The polymers may be used in combination of two or more kinds. Although these high molecular mass additives may be used either alone or in mixtures thereof, the same effects may be obtained. Among them, copolymer bodies of polyacrylic esters, polymethacrylic esters, or other vinyl monomers are preferred, and polymeric plasticizers based on an acrylic polymer, such as polyacrylic esters, polymethacrylic esters and the like (as an ester group, a methyl group, an ethyl group, a propyl group, a butyl group, a hexyl group, a cyclohexyl group, a 2-ethylhexyl group, an isononyl group, an oleyl group and the like) are particularly preferred.

[Humidity Dependence Decreasing Agent]

The optical film of the present invention also may contain a humidity dependence decreasing agent having ΔRth(A) of −100 nm or more and less than 0 nm, which is defined by the following Equation (A) as a compound that reduces humidity dependence, in addition to the above-described additives. When these additives are used in combination, the humidity dependence of Rth may be reduced more efficiently, and thus the total amount of additives may be reduced. Therefore, it is preferred from the viewpoint of inhibiting the contamination of a casting support.

66 Rth(A)=(ΔRth(rh,A)×ΔRth(rh,0))/Q Equation (A)

In the equation (A), ΔRth(rh,A) represents a value obtained by subtracting Rth of a film to which the compound is added at 25° C. and 80% RH from Rth at 25° C. and 10% RH, ΔRth(rh,0) represents a value obtained by subtracting Rth of a film to which the compound is not added at 25° C. and 80% RH from Rth at 25° C. and 10% RH, and Q represents the mass of the compound, when the mass of the cellulose ester in the film is taken as 100.

When the compound is used, ΔRth may be effectively reduced even in a small amount, and thus, the total amount of additives based on the cellulose ester may be reduced. For example, sublimation of additives during film formation may be inhibited, film conveying properties may be improved, or the bleed out of film may be inhibited. The ΔRth(A) is more preferably −50 nm to 10 nm, and even more preferably −30 nm to 0 nm.

Examples of these compounds include compounds having a high density of hydrogen-bonding groups per molecular mass. The hydrogen-bonding group is preferably a group containing at least one of —OH group or —NH group, and more preferably, for example, a hydroxyl group (—OH), a carboxyl group (—COOH), a carbamoyl group (—CONHR), a sulfamoyl group (—SONHR), an ureido group (—NHCONHR), an amino group (—NHR), a urethane group (—NHCOOR) and an amido group (—NHCOR). However, R represents a hydrogen atom, a hydroxyl group, an amino group, an alkyl group having 1 to 10 carbon atoms, or an aryl group or a heterocyclic group having 6 to 15 carbon atoms, but preferably represents a hydrogen atom. The R is more preferably an amino group, a hydroxyl group, a carboxyl group, a carbamoyl group, a sulfamoyl group, or an ureido group, and even more preferably an amino group or a hydroxyl group. It is also preferred that at least one of the hydroxyl groups is a phenolic hydroxyl group.

Specific examples of the compounds that reduce the humidity dependence of retardation include the following compounds.

(Hydroxyl Group Containing Compounds)

Examples of the compounds containing a hydroxyl group, which are preferably used in the present invention, and the compounds including a phenolic hydroxyl group, which are more preferred include compound A described in Japanese Patent Application Laid-Open No. 2008-89860, pp. 13 to 19, and compounds represented by Formula (1) described in Japanese Patent Application Laid-Open No. 2008-233530, pp. 7 to 9.

(Amino Group Containing Compounds Having Amino Group)

Compounds containing an amino group, which are preferably used in the present invention, are not particularly limited, but are preferably compounds represented by Formula (1) or Formula (2).

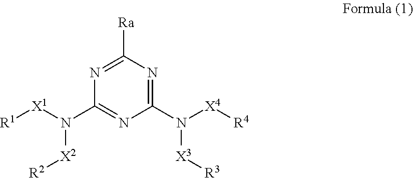

(In Formula (1), Ra represents an alkyl group, an alkenyl group, an alkynyl group, a heterocyclic group or an aryl group. Each of X¹, X², X³, and X⁴ independently represents a single bond or a divalent linking group. Each of R¹, R², R³, and R⁴ independently represents a hydrogen atom, an alkyl group, an alkenyl group, an alkynyl group, an aryl group, an acyl group or a heterocyclic group.)

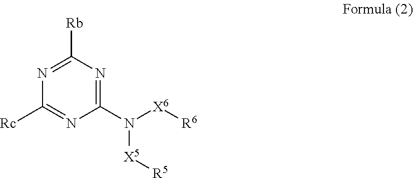

(In Formula (2), each of Rb and Rc independently represents an alkyl group, an alkenyl group, an alkynyl group, a heterocyclic group or an aryl group. Each of X⁵ and X⁶ independently represents a single bond or a divalent linking group. Each of R⁵ and R⁶ independently represents a hydrogen atom, an alkyl group, an alkenyl group, an alkynyl group, an aryl group, an acyl group or a heterocyclic group.)

The X¹ to X⁶ represent a single bond or a divalent linking group, each of X¹ to X⁶ may be the same as or different from every other X¹ to X⁶, and it is preferred that the divalent linking group is selected from the group represented by Formula (3).

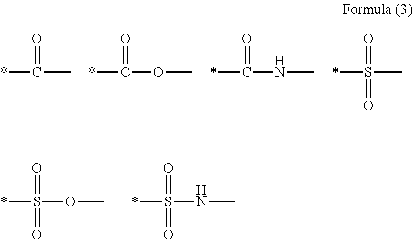

Hereinafter, as compounds having an amino group, compounds that may be preferably used in the present invention are represented.

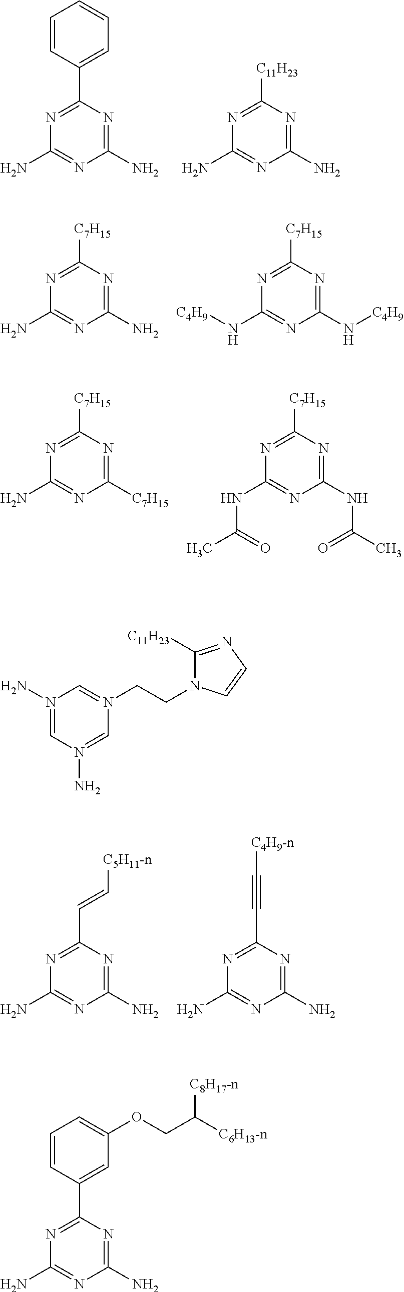

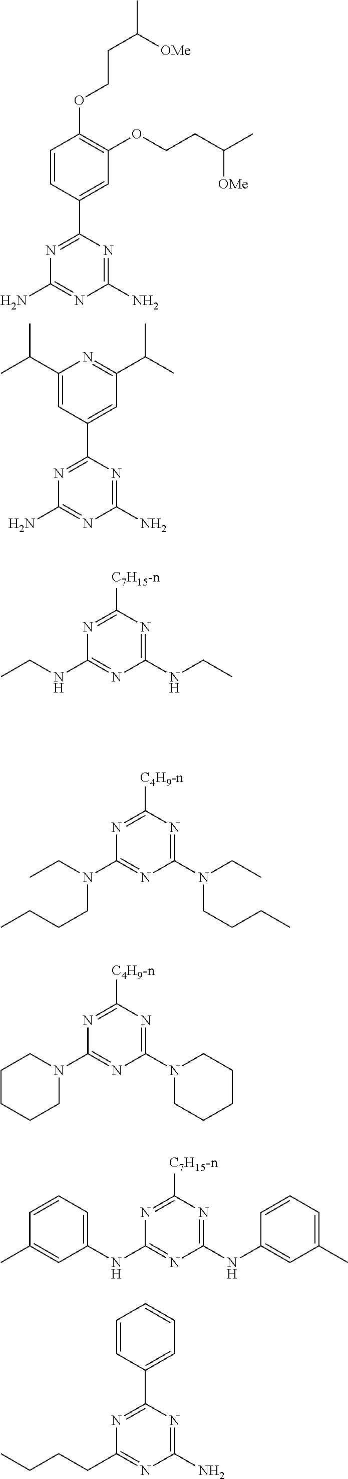

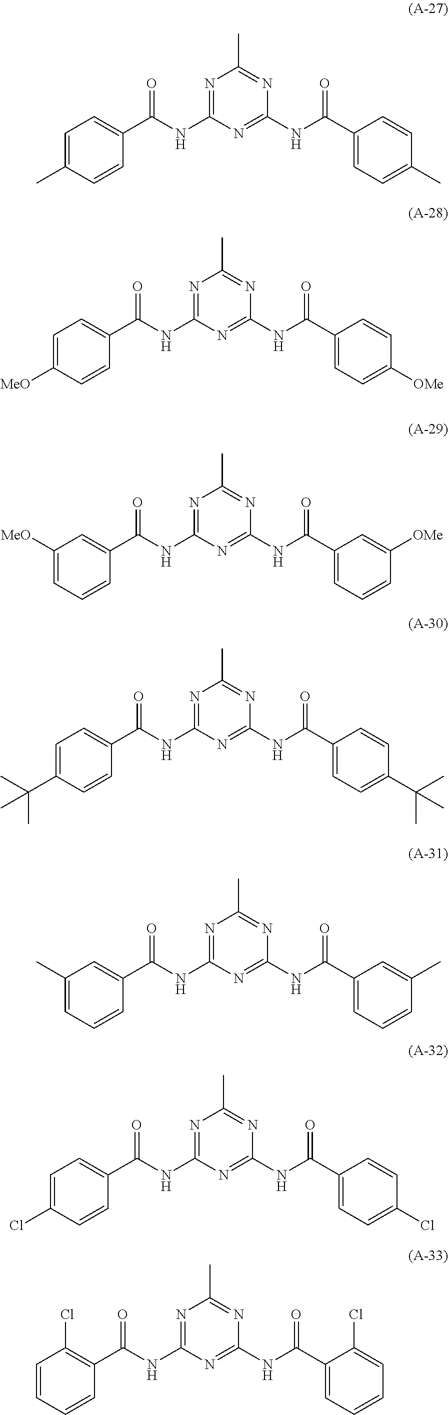

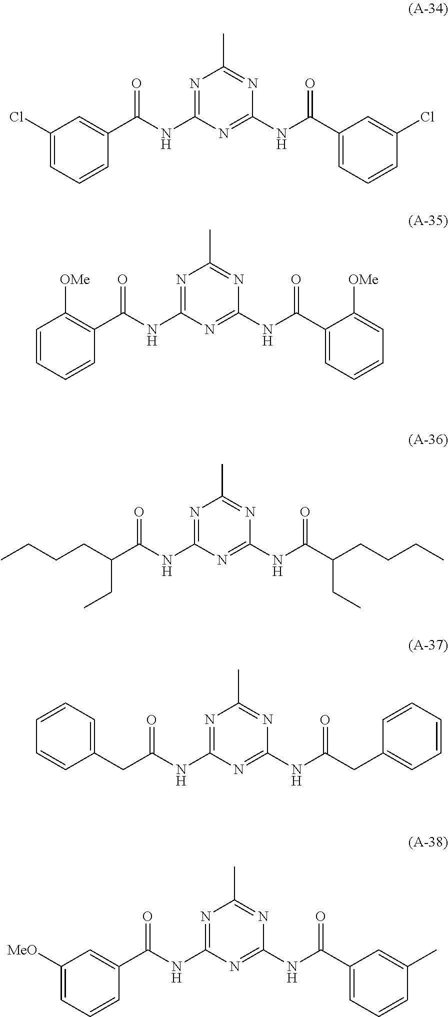

Also included in examples of the compound having an amino group that can be preferably used in the invention is a compound having a pyridine or pyrimidine nucleus and an amino group bonded thereto. Such a compound is exemplified by a compound represented by formula (3):

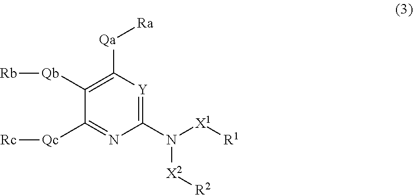

wherein Y represents methine or nitrogen; Qa, Qb, and Qc each independently represent a single bond or a divalent linking group; Ra, Rb, and Rc each independently represent hydrogen, optionally substituted alkyl, optionally substituted alkenyl, optionally substituted alkynyl, optionally substituted aryl, cyano, halogen, optionally substituted heterocyclic, or —N(Rd)(Rd′); Rd and Rd′ each independently represent hydrogen or a substituent; Rd and Rd′ may be taken together to form a ring; Ra and Rb may be taken together to form a ring; X′ represents a single bond or a divalent linking group selected from the group of linking groups (L′) shown below; X² represents a single bond or a divalent linking group; R¹ and R² each independently represent hydrogen, optionally substituted alkyl, optionally substituted alkenyl, optionally substituted alkynyl, optionally substituted aryl, or optionally substituted heterocyclic group; and R¹ and R² may be taken together to form a ring.

### Group of Linking Groups (L′):

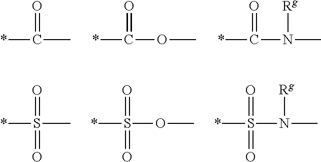

wherein the asterisk * indicates the position of attachment to the nitrogen atom substituting the N-containing aromatic ring; and Rg represents optionally substituted alkyl, optionally substituted alkenyl, optionally substituted alkynyl, optionally substituted aryl, or optionally substituted heterocyclic group.

In formula (3), Y is preferably hydrogen from the viewpoint of enhancing hydrogen bonding.

The divalent linking group as Qa, Qb, or Qc is preferably an oxygen atom, a sulfur atom, or —N(Rf)—, wherein Rf is hydrogen or alkyl. The alkyl as Rf is preferably C1-C10 alkyl, more preferably C1-C5 alkyl.

Qa is preferably a single bond, oxygen, or —NH—, more preferably a single bond or oxygen. Qb is preferably a single bond. Qc is preferably a single bond.

The alkyl as Ra, Rb, or Rc is preferably C1-C12, more preferably C1-C8, even more preferably C1-C6, most preferably C1-C4 alkyl. The alkenyl as Ra, Rb, or Rc is preferably C2-C12, more preferably C2-C6, even more preferably C2-C4 alkenyl. The alkynyl as Ra, Rb, or Rc is preferably C2-C12, more preferably C2-C6, even more preferably C2-C4 alkynyl. The aryl as Ra, Rb, or Rc is preferably C6-C18, more preferably C6-C12, even more preferably C6 (i.e., phenyl) aryl. The heterocyclic group as Ra, Rb, or Rc is exemplified by morpholinyl. Rd and Rd′ in —N(Rd)(Rd′)- as Ra, Rb, or Rc are each preferably hydrogen.

Ra, Rb, and Rc may each have a substituent. Examples of the substituent are the same as those listed for Ra in formula (1).

The ring formed by Ra and Rb taken together is preferably an N-containing aromatic ring, particularly an imidazole ring.

Ra is preferably hydrogen, alkyl, or aryl, more preferably hydrogen or alkyl. Rb is preferably hydrogen. Rc is preferably —N(Rd)(Rd′).

Examples of the substituents as Rd or Rd′ are the same as those described with respect to the substituent that may be possessed by Ra, Rb, and Rc. The substituent as Rd or Rd′ may further have a substituent, suitable examples of which are the same as those described as for the substituent that may be possessed by Ra, Rb, or Rc.

X¹ is preferably any one of the following three linking groups, more preferably carbonyl.

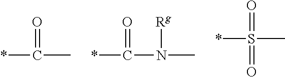

Examples and preferred ranges of the linking group as X² are the same as those described with respect to Qa, Qb, and Qc.

X² is preferably a single bond.

Examples and preferred ranges of the alkyl, alkenyl, alkynyl, aryl, or heterocyclic group as R¹ and R² are the same as those described with respect to Ra, Rb, and Rc. Examples of the substituent R¹ and R² may have are also the same as those described with respect to the substituent Ra, Rb, and Rc may have.

R¹ is preferably optionally substituted aryl. The substituent the aryl as R¹ may have is preferably alkyl, alkoxy, cyano, nitro, halogen, optionally substituted carbamoyl, or optionally substituted sulfamoyl, more preferably C1-C8 alkyl, C1-C8 alkoxy, halogen, optionally substituted carbamoyl, or optionally substituted sulfamoyl. The substituent that the carbamoyl or sulfamoyl may have is preferably alkyl.

R² is preferably hydrogen.

The compound of formula (3) is preferably a compound represented by formula (4):

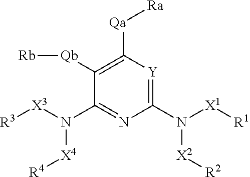

wherein Y, Qa, Qb, Ra, Rb, X¹, X², R¹, and R² are as defined above for formula (3); X³ represents a single bond or a divalent linking group selected from the group of linking groups (L′); X⁴ represents a single bond or a divalent linking group; R³ and R⁴ each independently represent hydrogen, optionally substituted alkyl, optionally substituted alkenyl, optionally substituted alkynyl, optionally substituted aryl, or optionally substituted heterocyclic group; and R³ and R⁴ may be taken together to form a ring.

Examples and preferred ranges of Y, Qa, Qb, Ra, Rb, X¹, X², R¹, and R² in formula (4) are the same as those of as Y, Qa, Qb, Ra, Rb, X¹, X², R¹, and R², respectively, in formula (3).

Examples and preferred ranges of X³ are the same as those for X¹ in formula (3).

Examples and preferred ranges of X⁴ are the same as those for X² in formula (1).

Examples and preferred ranges of R³ and R⁴ are the same as those for R¹ and R² in formula (3).

The compound of formula (4) is preferably a compound represented by formula (5):

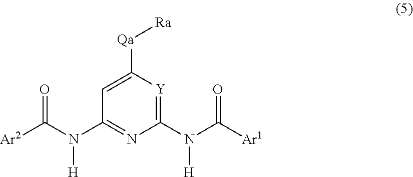

wherein Y, Qa, and Ra have the same meaning as Y, Qa, and Ra, respectively, in formula (4); and Ar¹ and Ar² each independently represent optionally substituted aryl.

Examples and preferred ranges of Y, Qa, and Ra in formula (5) are the same as those in formula (4).

Examples and preferred ranges of the optionally substituted aryl as Ar¹ and Ar² are the same as those described with respect to R¹ in formula (3).

The compound of formula (51 is preferably a compound represented by formula (6):

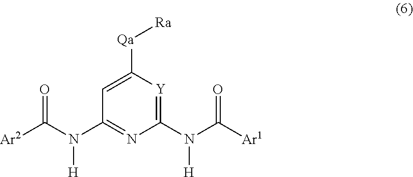

wherein Qa, Ra, Ar¹, and Ar² have the same meaning as Qa, Ra, Ar¹, and Ar², respectively, in formula (5).

Examples and preferred ranges of Qa, Ra, Ar¹, and Ar² are the same as those for formula (5).

The compound of formula (6) is preferably a compound represented by formula (7):

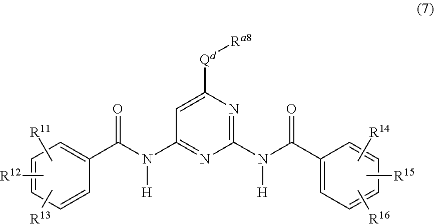

wherein Q^{d} represents a single bond, oxygen, or —NH—; R^{a8} represents C1-C8 alkyl; and R¹¹, R¹², R¹³, R¹⁴, R¹⁵, and R¹⁶ each independently represent hydrogen, halogen, optionally substituted carbamoyl, optionally substituted sulfamoyl, C1-C8 alkyl, or C1-C8 alkoxy.

Q^{d} is preferably a single bond or oxygen.

R¹¹ through R¹⁶ are each preferably hydrogen, optionally substituted carbamoyl, optionally substituted sulfamoyl, C1-C8 alkyl, or C1-C8 alkoxy, more preferably hydrogen or C1-C8 alkyl.

Examples of the compound of formula (3) which are preferably used in the invention are shown below.

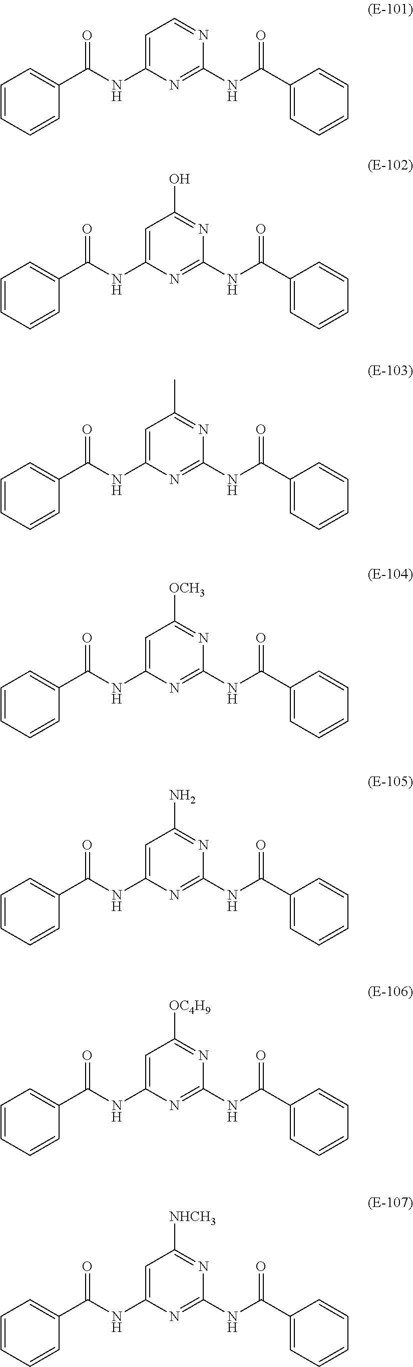

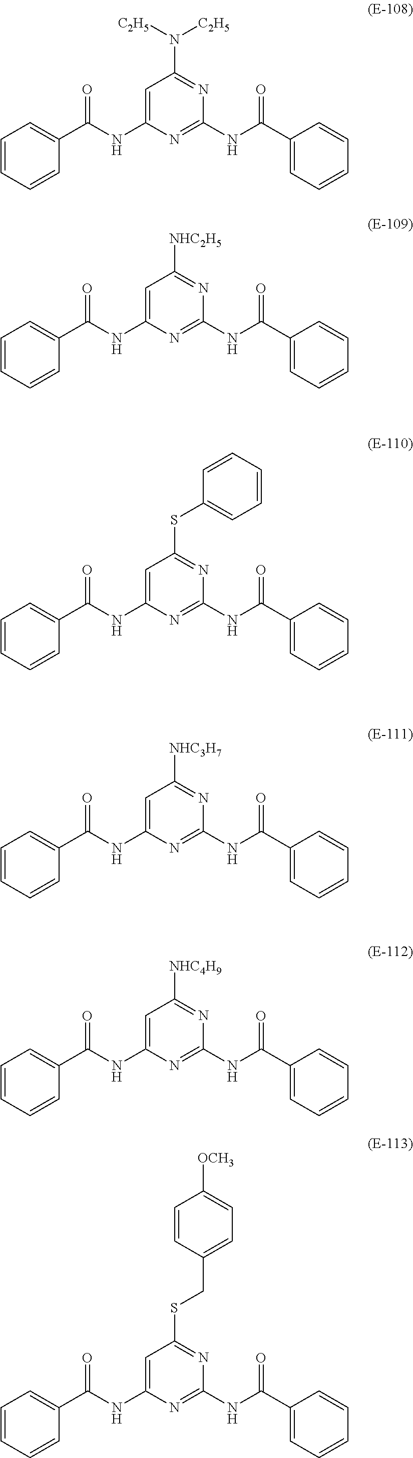

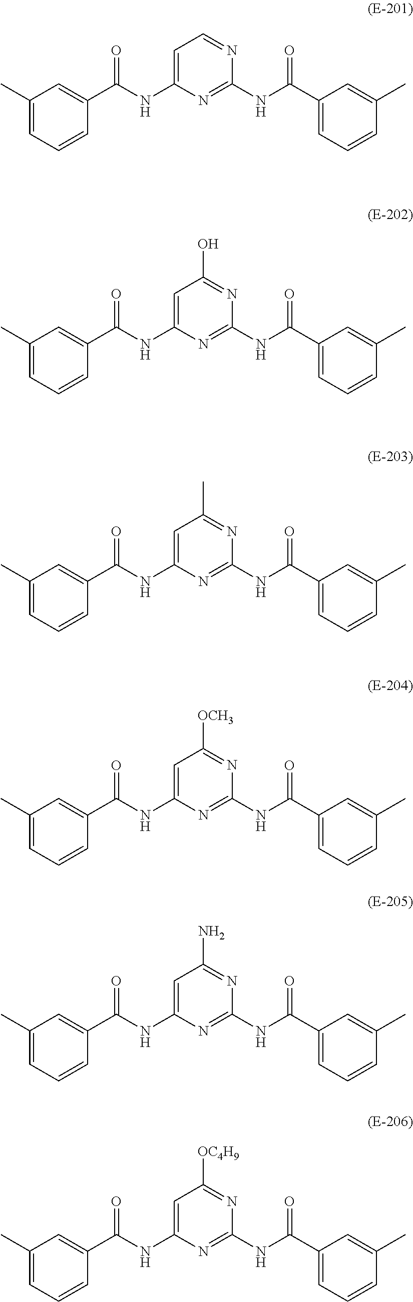

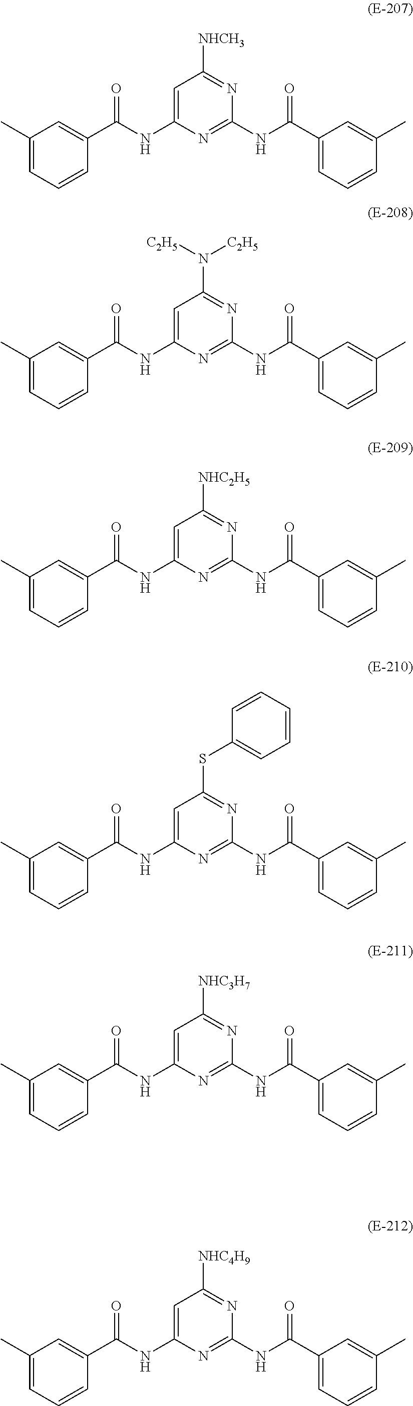

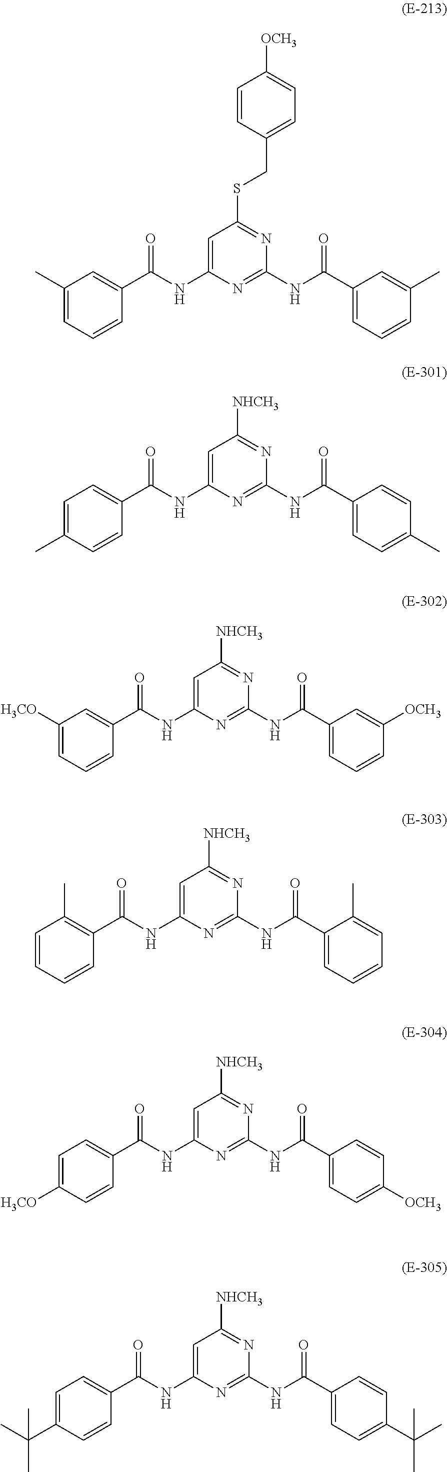

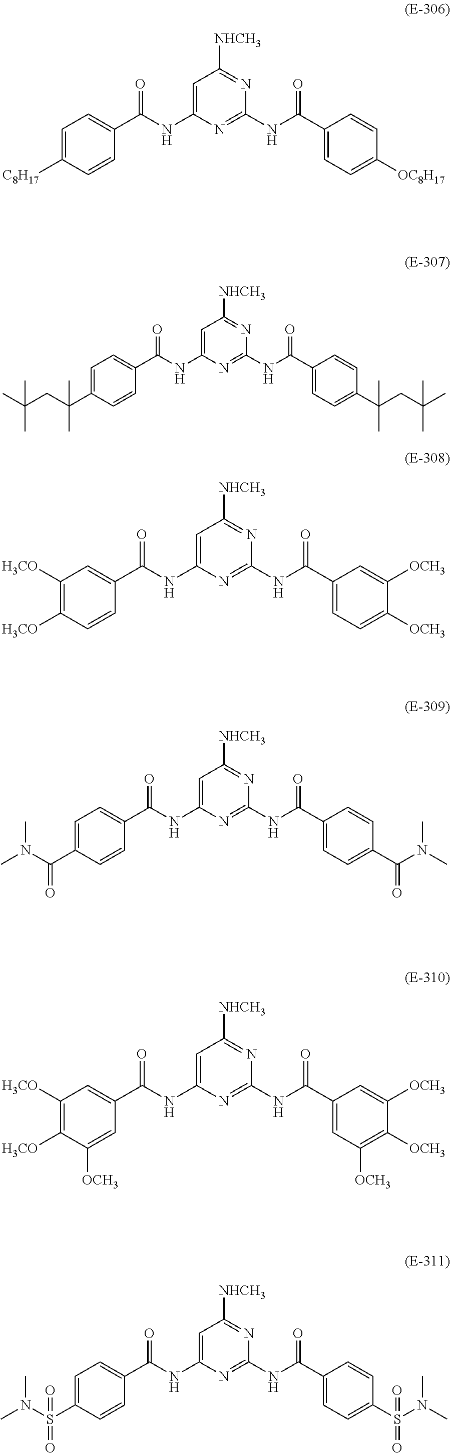

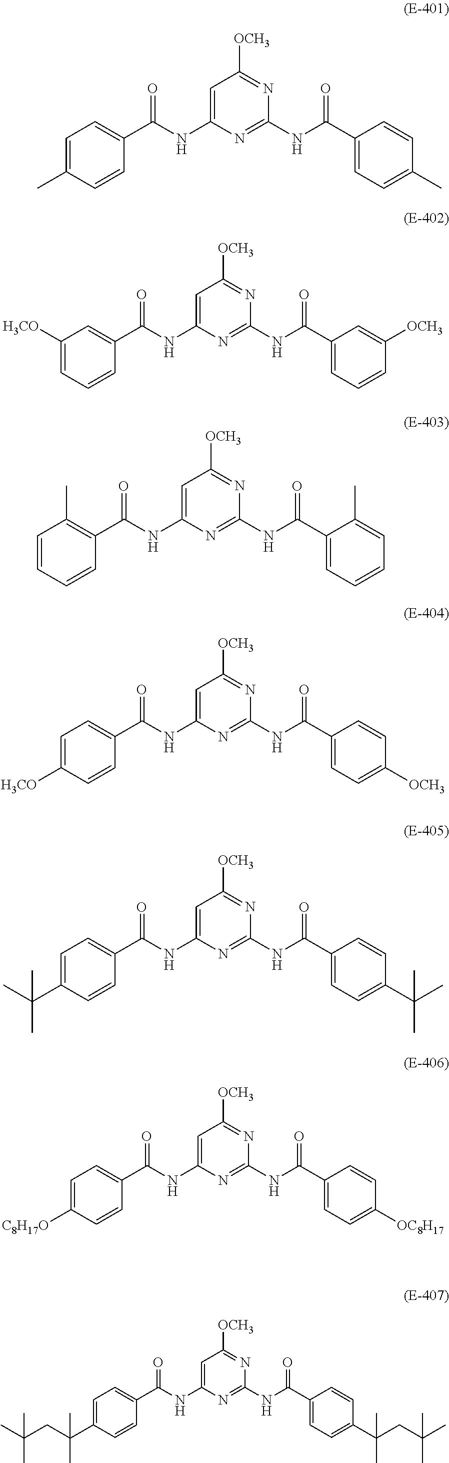

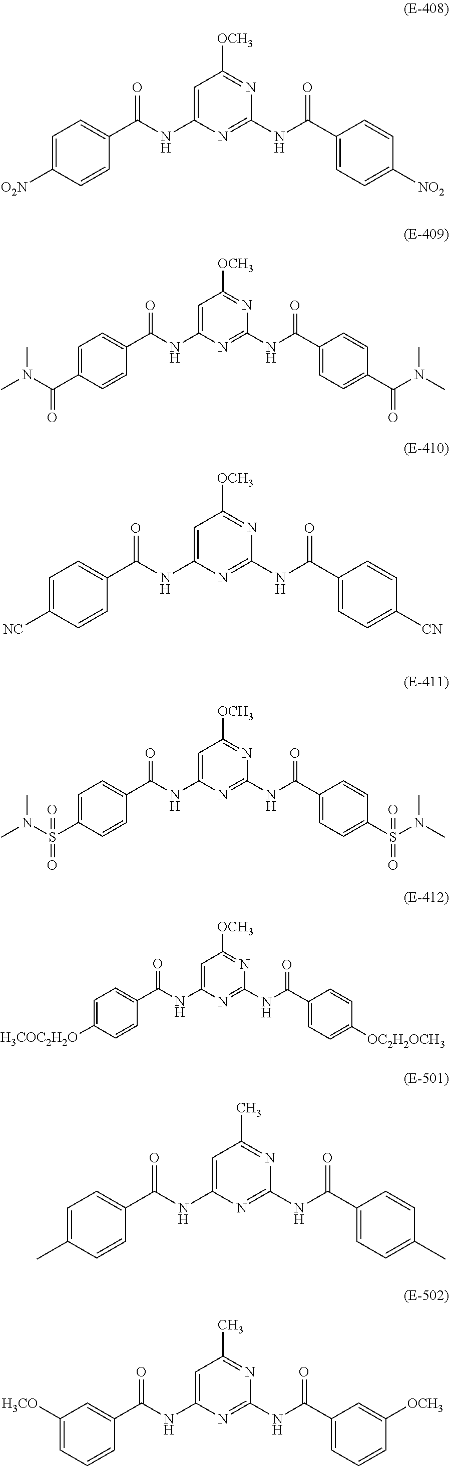

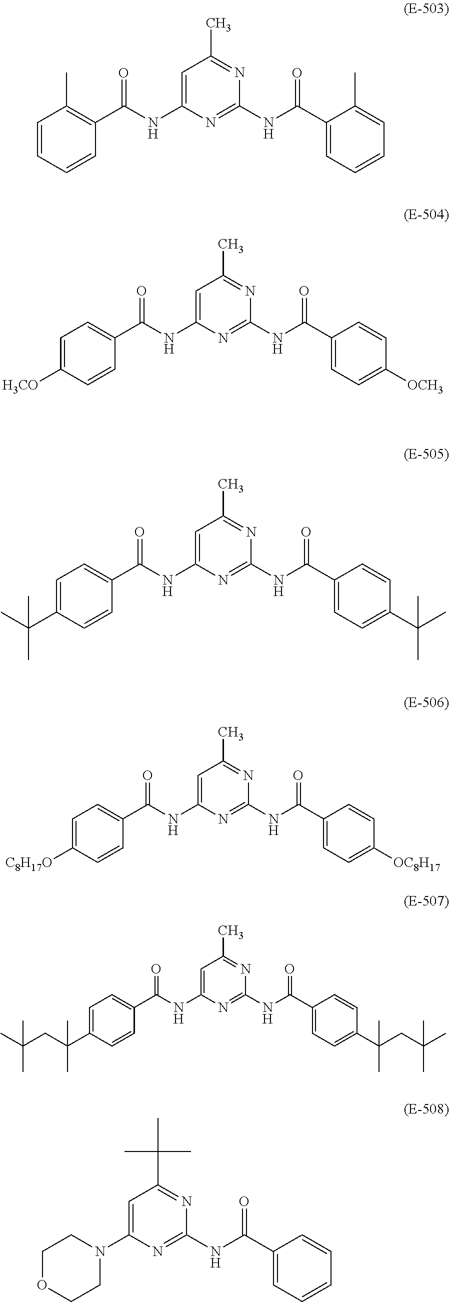

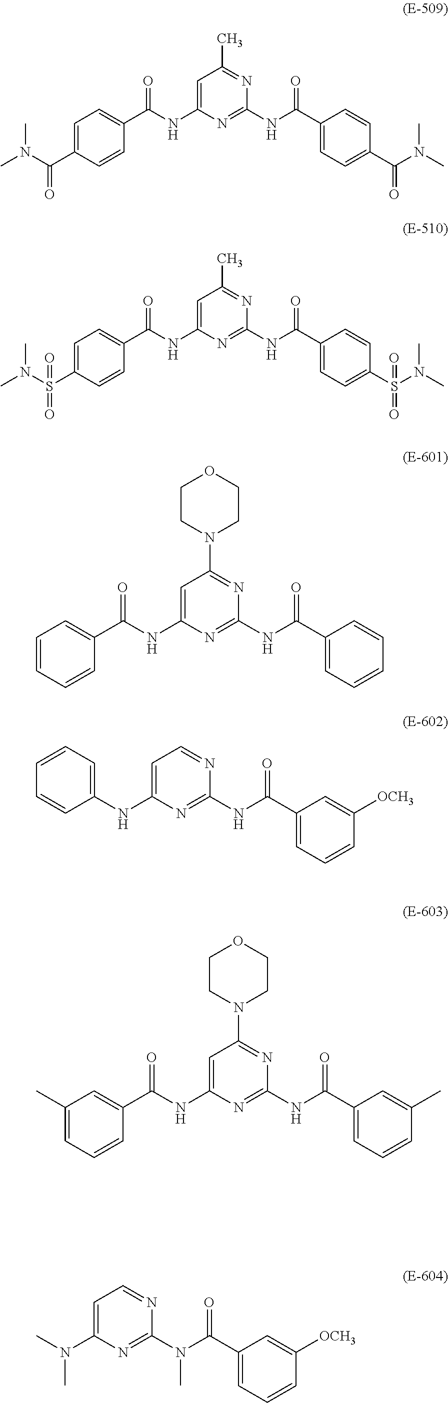

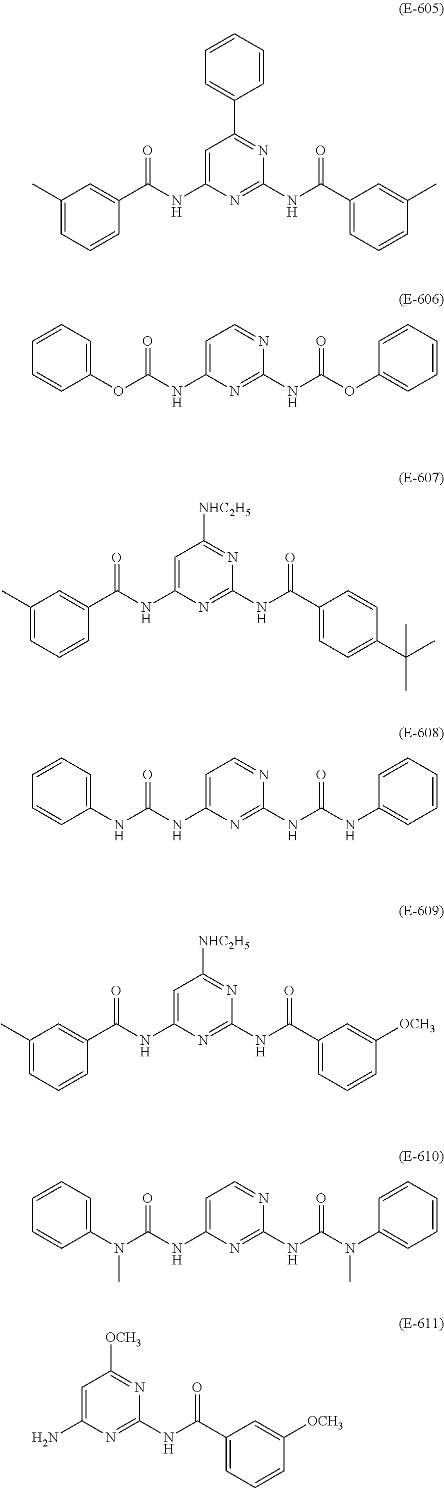

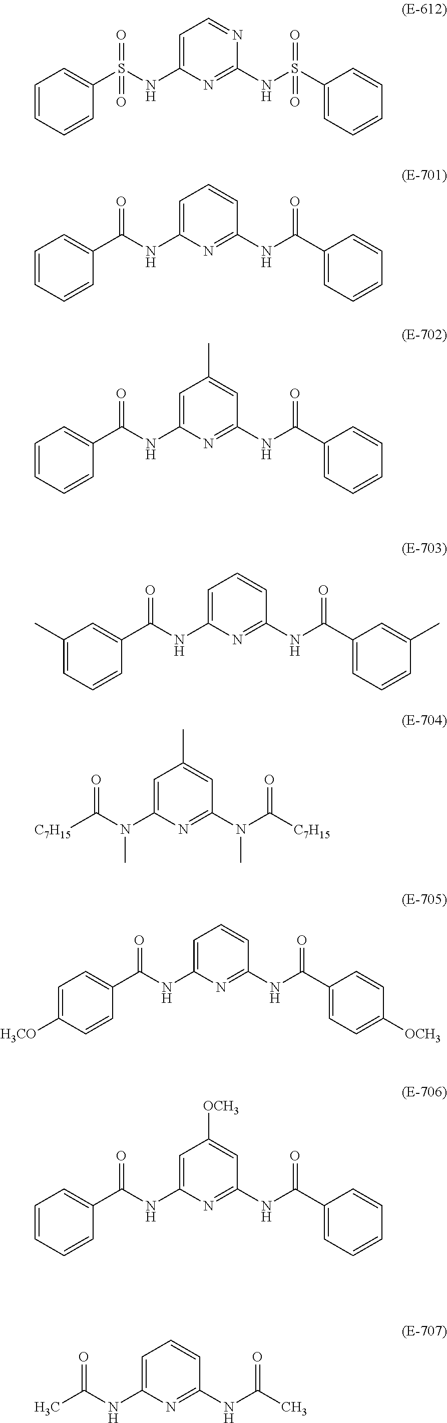

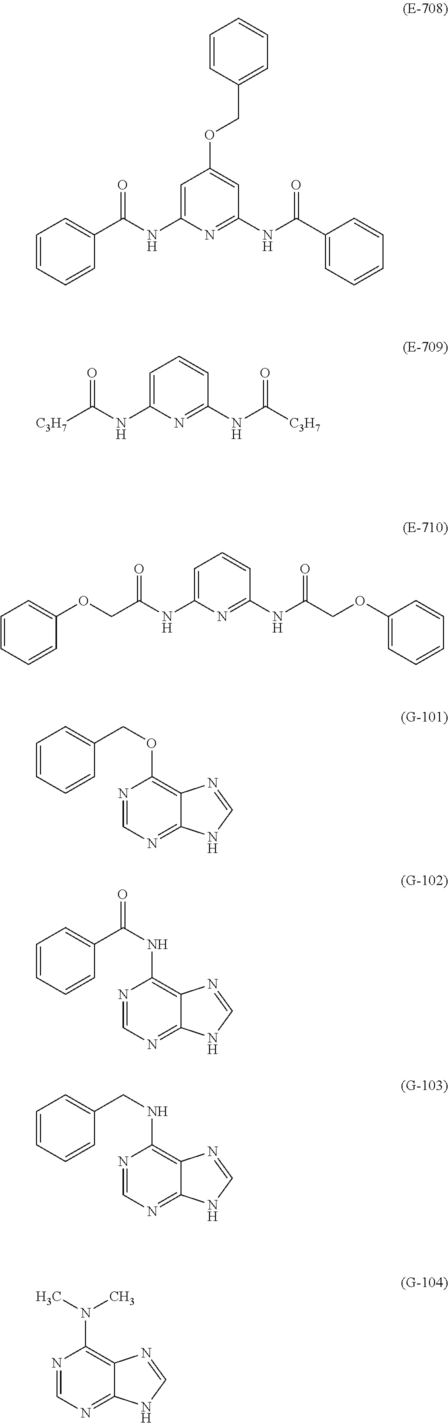

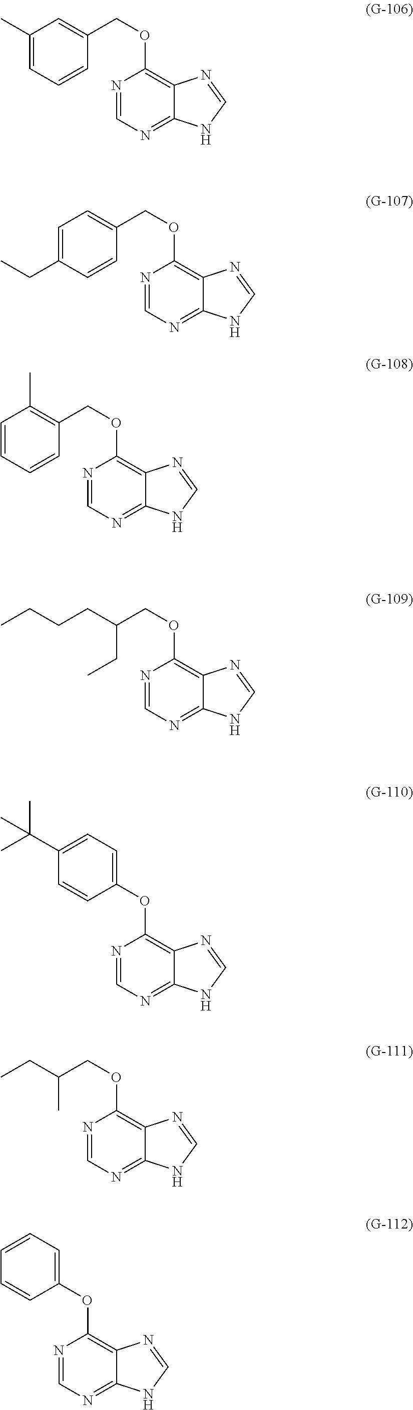

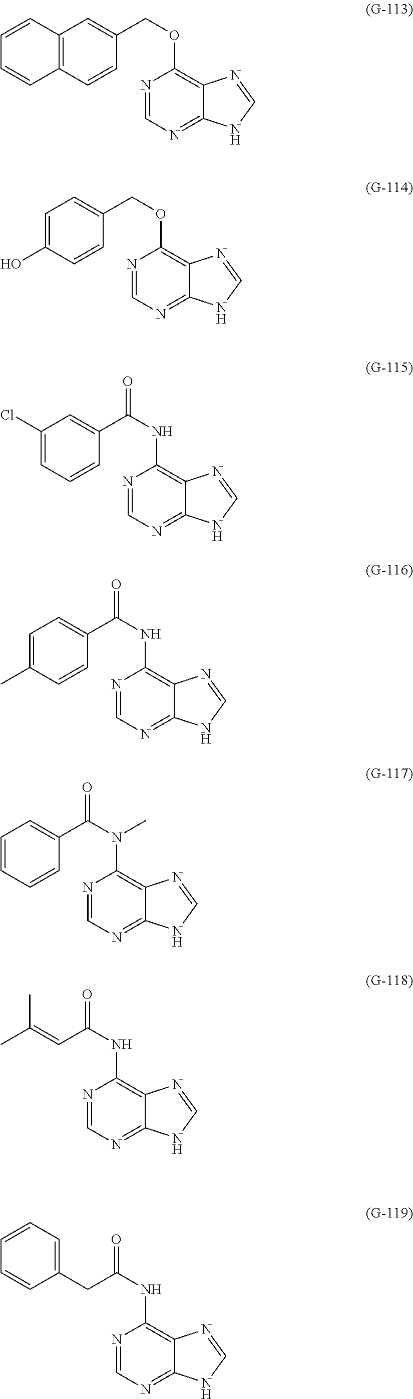

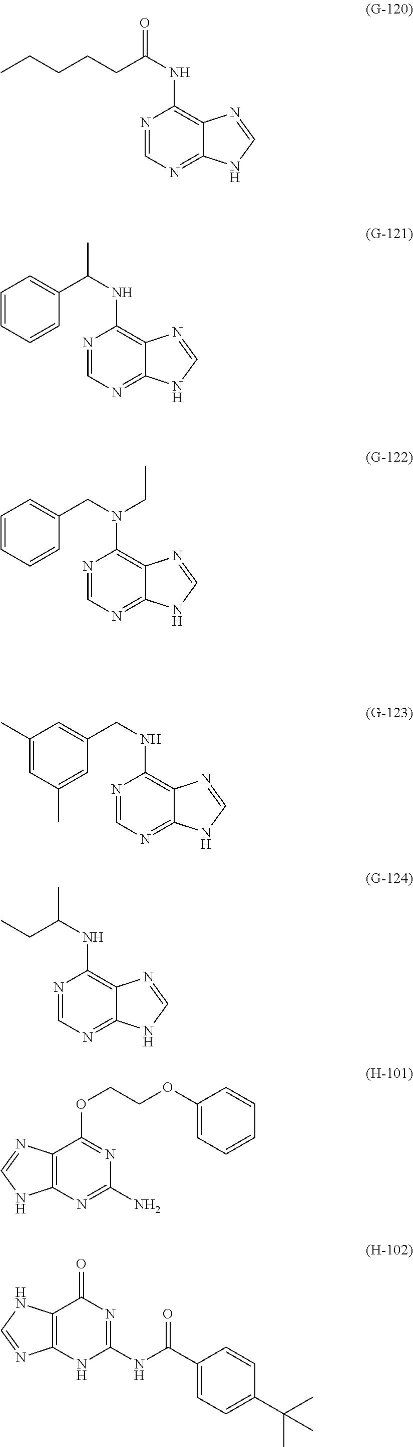

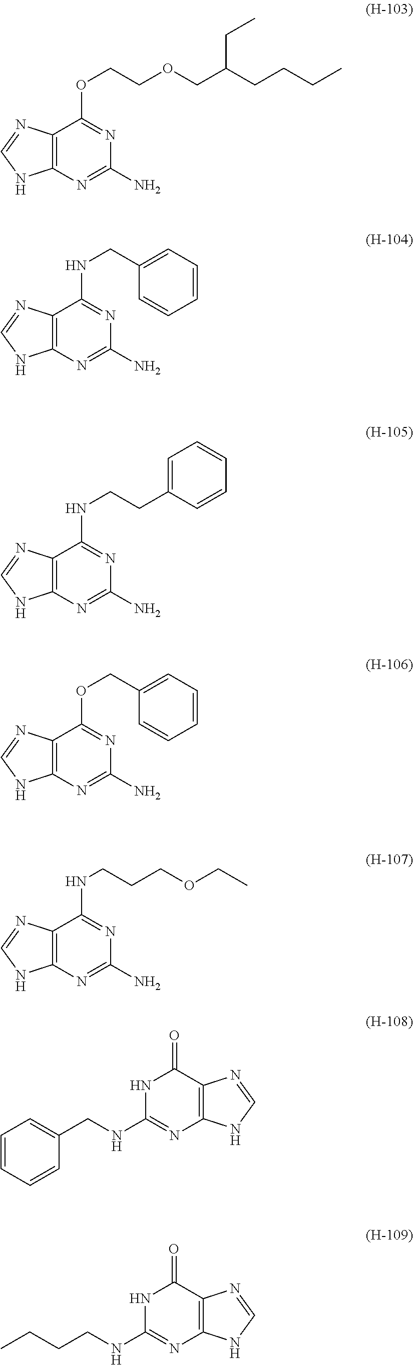

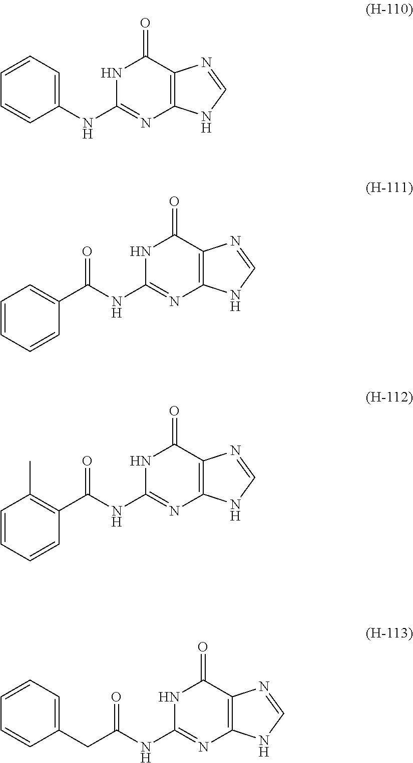

Also included in examples of the compound having an amino group that can be preferably used in the invention is a compound represented by formula (8):

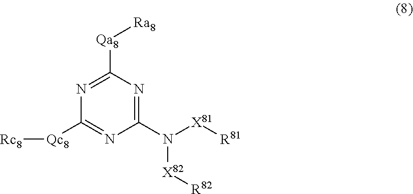

wherein Qa₈ and Qc₈ each independently represent a single bond or a divalent linking group; Ra₈ and Rc₈ each independently represent hydrogen, optionally substituted alkyl, optionally substituted alkenyl, optionally substituted alkynyl, optionally substituted aryl, cyano, halogen, optionally substituted heterocyclic, or —N(Rd)(Rd′) group; Rd and Rd′ each independently represent hydrogen or a substituent; Rd and Rd′ may be taken together to form a ring; X⁸¹ represents a single bond or a divalent linking group selected from the group of linking groups (L′); X⁸² represents a single bond or a divalent linking group; R⁸¹ and R⁸² each independently represent hydrogen, optionally substituted alkyl, optionally substituted alkenyl, optionally substituted alkynyl, optionally substituted aryl, or optionally substituted heterocyclic group; and R⁸¹ and R⁸² may be taken together to form a ring.

Examples of Qa₈ and Qc₈ are the same as those for Qa in formula (3). Examples of Ra₈ and Rc₈ are the same as those for Ra in formula (3). Preferred ranges of X⁸¹, X⁸², R⁸¹, and R⁸² are the same as those described with respect to X¹, X², R¹, R², respectively, in formula (3).

Also included in examples of the compound having an amino group that can be preferably used in the invention is a compound represented by formula (9):

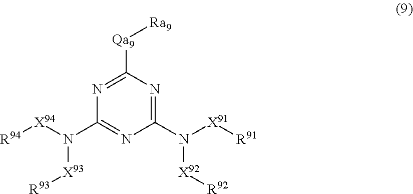

wherein Qa₉ represents a single bond or a divalent linking group; Ra₉ represents hydrogen, optionally substituted alkyl, optionally substituted alkenyl, optionally substituted alkynyl, optionally substituted aryl, cyano, halogen, optionally substituted heterocyclic, or —N(Rd)(Rd′) group; Rd and Rd′ each independently represent hydrogen or a substituent; Rd and Rd′ may be taken together to form a ring; X⁹¹ represents a single bond or a divalent linking group selected from the group of linking groups (L′); X⁹², X⁹³, and X⁹⁴ each independently represent a single bond or a divalent linking group; R⁹¹, R⁹², R⁹³, and R⁹⁴ each independently represent hydrogen, optionally substituted alkyl, optionally substituted alkenyl, optionally substituted alkynyl, optionally substituted aryl, or optionally substituted heterocyclic group; and R⁹¹ and R⁹², and R⁹³ and R⁹⁴ may each be taken together to form a ring.

Examples of Qa₉ and Ra₉ are the same as those for Qa and Ra, respectively, in formula (3). A preferred range of X⁹¹ is the same as that of X¹ in formula (3). Preferred ranges of X⁹² through X⁹⁴ are the same as those for X² in formula (3). A preferred range of R⁹¹ is the same as that for R¹ in formula (3). Preferred ranges of R⁹² through R⁹⁴ are the same as those for R² in formula (3).

Examples of the compounds represented by formula (8) or (9) include, but are not limited to, the following compounds.

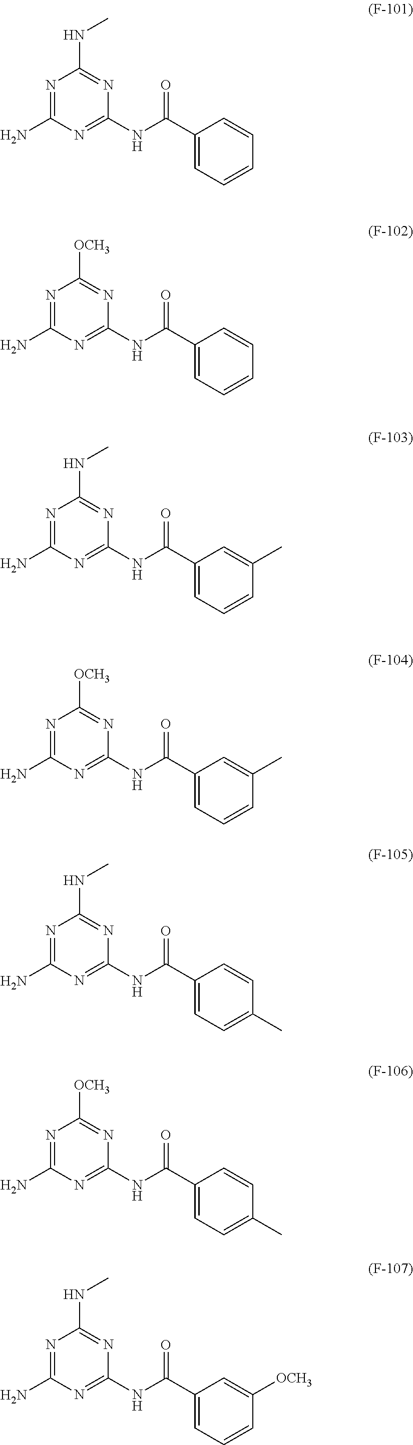

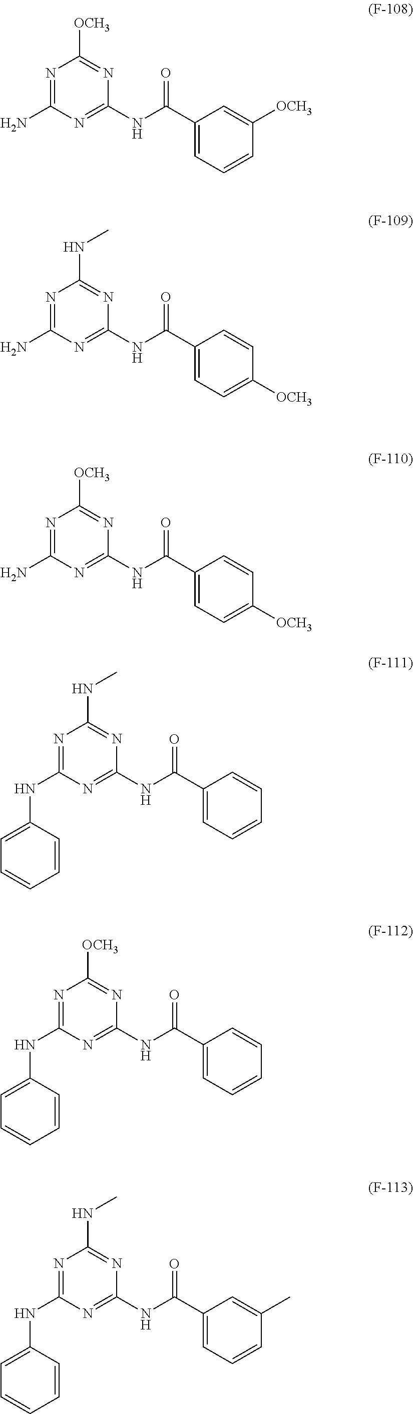

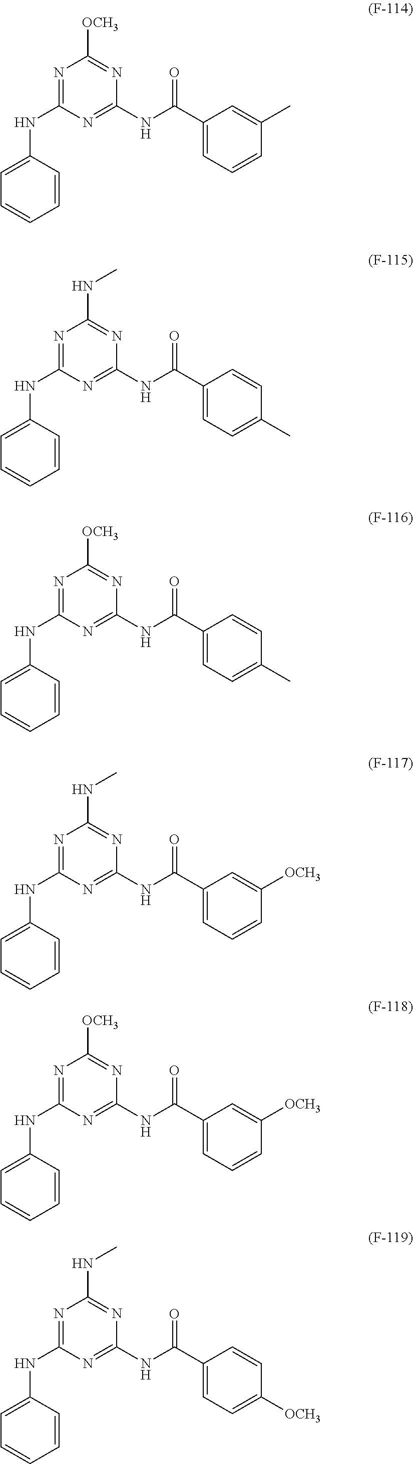

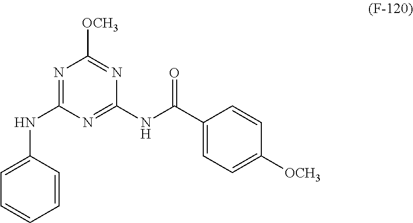

Also included in examples of the compound having an amino group that can be preferably used in the invention is a compound represented by formula (10):

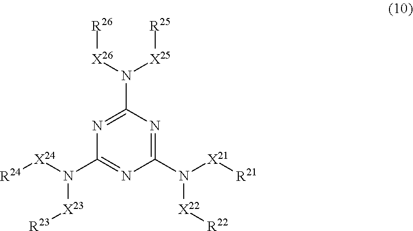

wherein X²¹, X²², X²³, X²⁴, X²⁵, and X²⁶ each independently represent a single bond or a divalent linking group; and R²¹, R²², R²³, R²⁴, R²⁵, and R²⁶ each independently represent hydrogen, alkyl, alkenyl, alkynyl, aryl, acyl, or heterocyclic group.

Examples of the divalent linking group as each of X²¹ through X²⁶ are the same as those described for X¹ in formula (1). Each of X²¹ through X²⁶ is preferably a single bond. Examples of R²¹ through R²⁶ are the same as those described with respect to R¹ in formula (1).

It is preferred that each of R²¹, R²³, and R²⁵ be hydrogen and that each of R²², R²⁴, and R²⁶ be aryl.

Specific but non-limiting examples of the compound of formula (10) are shown below.

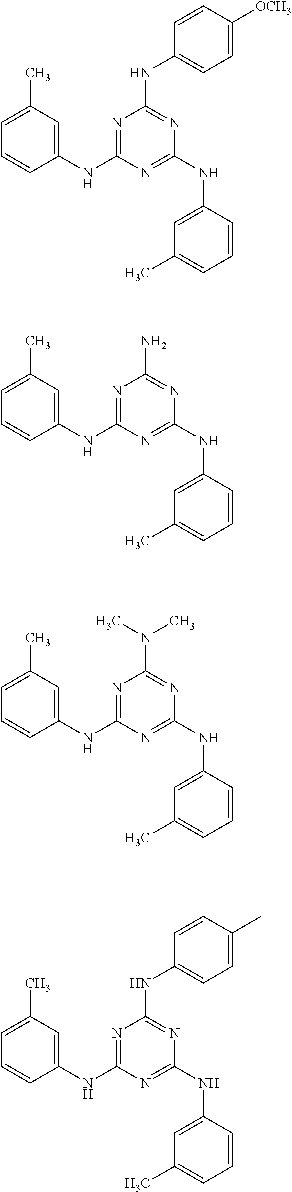

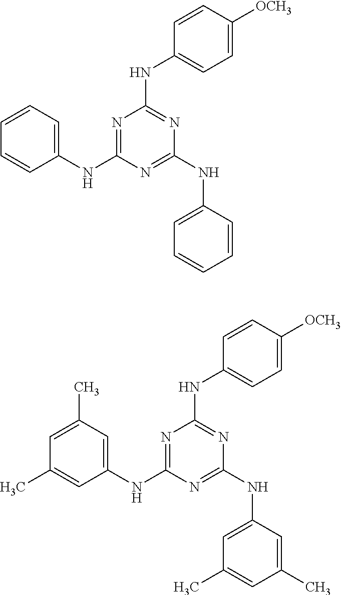

[Compounds Improving Durability of Retardation]

The optical film of the present invention may contain a compound which improves the durability of retardation. The durability of retardation includes durability observed as a change in retardation when a film is kept under a moist heat environment, and a change in retardation when the film is manufactured in the form of a polarizing plate and then kept under a moist heat environment. The former may be improved by using a condensate including a polyhydric alcohol component having at least 3 carbon atoms as described above and/or controlling a dimensional change ratio which will be described below. The latter may be improved by using a condensate including a polyhydric alcohol component having at least 3 carbon atoms as described above and/or adding a compound which improves the durability of retardation. As the compound, compounds having a basic functional group in its molecule may be used, and specific examples thereof include the following compounds.

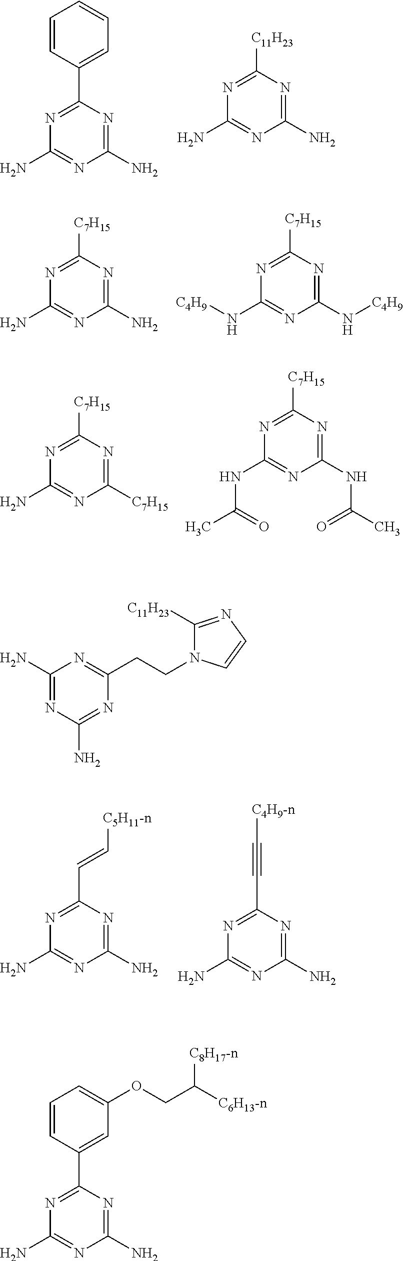

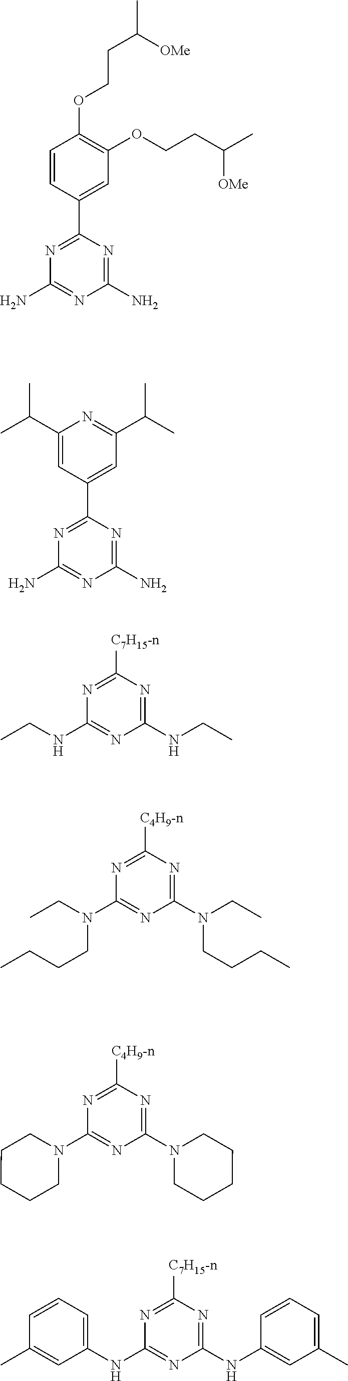

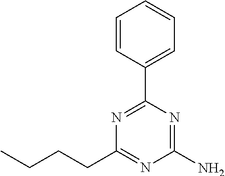

[Cellulose Ester]

Subsequently, cellulose esters according to the present invention will be described.

The optical film of the present invention contains cellulose ester, the content of the cellulose ester is preferably 30% to 77% by mass, more preferably 40 T to 75% by mass, and even more preferably 50% to 75% by mass, and thus an optical film having excellent processability into polarizing plates may be manufactured.

The cellulose ester used in the optical film of the present invention is an ester of cellulose and an acid as raw material, preferably a carboxylic acid ester having about 2 to 22 carbon atoms (so-called a cellulose acylate), and more preferably a lower fatty acid ester having 6 or less carbon atoms. In the cellulose acylate of the present invention, methods for measuring the degree of substitution of acetic acid and/or a fatty acid having 3 to 22 carbon atoms substituted with the hydroxyl groups of cellulose include the method in accordance with ASTM D-817-91 or the NMR method. In the case of a cellulose acylate having about 2 to 22 carbon atoms, a condensate having repeating units is used, and particularly in the case of a cellulose acetate having 2 carbon atoms, the light unevenness of a liquid crystal display device may be reduced by preferably using an adduct having repeating units in addition to the condensate.

Examples of the cellulose as a cellulose ester raw material used in the present invention include cotton linter, wood pulp (broad leaf pulp and needle leaf pulp) and the like, and a cellulose ester obtained from any raw material cellulose may be used. In some cases, such cellulose esters may also be used in mixtures thereof. Details description on these raw material celluloses may be found in, for example, Lecture on Plastic Materials (17) Cellulose Resins (Maruzawa and Uda, THE NIKKAN KOGYO SHIMBUN, LTD., published in 1970) or Japan Institute of Invention and Innovation, Journal of Technical Disclosure 2001-1745 (pp. 7 to 8), and the optical film of the present invention is not particularly limited thereto.

Although the degree of substitution of cellulose substituted with a hydroxyl group in the cellulose acylate of the present invention is not particularly limited, when the film is used as a polarizing plate protective film and an optical film, the degree of substitution of acyl with a hydroxyl group in the cellulose is preferably 2.00 to 3.00 in order to impart moisture permeation or absorption which is appropriate for the film. The degree of substitution is preferably 2.30 to 2.98, more preferably 2.70 to 2.96, and even more preferably 2.80 to 2.94. Also, a degree of substitution (DSs) of acyl of cellulose acylate contained in a region which is 1 μm away from the surface of the film and a degree of substitution (DSc) of acyl of cellulose acylate which is 1 μm away from the center in the thickness direction of the optical film preferably satisfies a relation of DSs≦DSc. DSs may be determined by shaving out a region which is 1 μm away from the surface of the film by a razor blade or the like and measuring the resulting powder by a known method, and DSc may be determined by shaving out the film to an extent of the center in the thickness direction (for example, so far as a film of 50 μm is concerned, after shaving out to an extent of 25 μm, a region of 1 μm is further shaven out) and then measuring.

Among acetic acid and/or an aliphatic acid having 3 to 22 carbon atoms substituted with a hydroxyl group of cellulose, the acyl group having 2 to 22 carbon atoms may be aliphatic or aromatic may be, but not particularly limited thereto, a single kind or a mixture of two or more acyl groups. Examples thereof include alkylcarbonyl ester, alkenylcarbonyl ester, or aromatic carbonyl ester, aromatic alkyl carbonyl ester, and the like, and each of which may have a group further substituted. Examples of the preferred acyl groups include an acetyl group, propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a t-butanoyl group, a cyclohexanecarbonyl group, an oleoyl group, a benzoyl group, a naphthylcarbonyl group, a cinnamoyl group and the like. Among them, acetyl, propionyl, butanoyl, dodecanoyl, octadecanoyl, t-butanoyl, oleoyl, benzoyl, naphthylcarbonyl, cinnamoyl, and the like are preferred and acetyl, propionyl, and butanoyl are more preferred.

Among them, from the viewpoint of ease of synthesis, costs, ease of substituent distribution control and the like, an acetyl group, and a mixed ester of an acetyl group and a propionyl group are particularly preferred.

The polymerization degree of cellulose acylate preferably used in the present invention is 180 to 700 as the viscosity average polymerization degree, and the polymerization degree of cellulose acetate is more preferably 180 to 550, even more preferably 180 to 400, and particularly preferably 180 to 350. When the degree of polymerization is too high, a dope solution of the cellulose acylate tends to be too viscous to be manufactured into a film by casting. When the degree of polymerization is too low, the strength of the manufactured film tends to be decreased. An average degree of polymerization may be measured by the extreme viscosity method of Uda et al. (Kazuo Uda and Hideo Saito, Bulletin of The Society of Fiber Science and Technology, Japan, vol. 18, No. 1, pp. 105 to 120 (1962)). The method is described in detail in Japanese Patent Application Laid-Open No. Hei 9-95538.

The distribution of molecular mass of the cellulose acylate preferably used in the present invention is evaluated by gel permeation chromatography, and it is preferred that the polydispersity index Mw/Mn (Mw is a mass average molecular mass and Mn is a number average molecular mass) is small, while the molecular mass distribution is narrow. Specific values of Mw/Mn preferably range from 1.0 to 4.0, more preferably from 2.0 to 3.5, and most preferably from 2.3 to 3.4.

Removal of low-molecular components results in an increase in average molecular mass (degree of polymerization) but makes the viscosity become lower than that of a typically used cellulose acylate, which is useful. Cellulose acylate having reduced low-molecular components may be obtained by removing low-molecular components from cellulose acylate synthesized by a typical method. The removal of the low-molecular components may be performed by washing the cellulose acylate with an appropriate organic solvent. Meanwhile, when preparing a cellulose acylate having a small amount of low-molecular components, an amount of a sulfuric acid catalyst in the acetification reaction is preferably adjusted within a range of 0.5 parts to 25 parts by mass, based on 100 parts by mass of cellulose. The amount of a sulfuric acid catalyst within the above-mentioned range makes it possible to synthesize cellulose acylate that is preferable in terms of the molecular mass distribution (with narrow molecular mass distribution). When the cellulose acylate is used for preparing a cellulose acylate film of the present invention, the cellulose acylate preferably has a water content of 2% by mass or less, more preferably 1% by mass or less, and particularly preferably 0.7% by mass or less. In general, it is known that the cellulose acylate contains water, and a water content thereof is 2.5% to 5% by mass. In order to attain the aforementioned water content of the cellulose acylate in the present invention, drying is required, and the method thereof is not particularly limited as long as a target water content may be attained. For the cellulose acylate of the present invention, a raw material cotton or a synthesizing method thereof are described in detail in Japan Institute of Invention and Innovation, Journal of Technical Disclosure (Technical Publication No. 2001-1745, Mar. 15, 2001, published by Japan Institute of Invention and Innovation) pp. 7 to 12.

From the viewpoint of substituent, degree of substitution, degree of polymerization, molecular mass distribution and the like, a single kind or two or more different kinds of cellulose acylate may be used use in the present invention.

[Retardation Controlling Agent]

The optical anisotropy of the optical film of the present invention is controlled by the addition of the aforementioned polyester-based oligomer, and another optical anisotropy controlling agent may be added depending on desired retardation. For example, a compound that reduces Rth, as described in Japanese Patent Application Laid-Open No. 2006-30937 pp 23 to 72, may be added, and a compound that raises Rth, specifically, a compound having preferably one or more aromatic rings, more preferably 2 to 15 aromatic rings, and even more preferably 3 to 10 aromatic rings may be added. Each of the atoms other than the aromatic rings in the compound are preferably arranged on a plane near the same plane of the aromatic ring, and when the compound has a plurality of aromatic rings, the aromatic rings are also preferably arranged on a plane near the same plane of the aromatic rings. In order to selectively raise Rth, it is preferred for an additive in the film to align with the plane of the aromatic ring(s) parallel to the film surface.

The additive may be used either alone or in combination of two or more thereof.

Specific examples of the Rth-raising additive include the plasticizers described in Japanese Patent Application Laid-Open No. 2005-104148, pp. 33 to 34, the optical anisotropy controlling agents described in Japanese Patent Application Laid-Open No. 2005-104148, pp. 38 to 89, and the like. Although the detailed reason is unclear, in the present invention, it is preferred to add a low molecular compound having an Rth raising effect in order to inhibit the visibility of circular light unevenness that may be observed when a liquid crystal display device is viewed from the inclined surface.

[Retardation]

In the optical film of the present invention, it is important to adjust an Re and an Rth measured at a wavelength of 590 nm (defined in the following Equations (I) and (II)) to be appropriate for the intended use, and these values may be controlled by selecting the kind or degree of substitution of the substituent of the cellulose ester, the kind or added amount of the above-described compound having repeating units, the film thickness of the film, the process conditions during film formation, the stretching process and the like.

When it is desired for the optical film of the present invention to have reduced retardation for use, for example, in an IPS mode liquid crystal panel, it is preferred that the film satisfies the following Equations (IIIa) and (IVa), and it is also possible that an optical film used as a protective film serves as a support to form a functional layer which will be described below. Accordingly, for example, the contrast of a display screen of a liquid crystal display device may be enhanced or viewing angle characteristics or tint thereof may be improved.

Re=(nx−ny)×d(nm) Equation (I)

Rth={(nx+ny)/2−nz}×d(nm) Equation (II)

Re<10 Equation (IIIa)

|Rth|<25 Equation (IVa)

In the above equations, nx is a refractive index in an in-plane slow axis direction of a film, ny is a refractive index in an in-plane fast axis direction of a film, nz is a refractive index in a thickness direction of a film, and d is a film thickness (nm).

In this case, the azimuth of the in-plane slow axis is not particularly limited but it is preferred that the azimuth is substantially parallel or perpendicular to the azimuth in which the in-plane elastic modulus of the film is the highest. Re is more preferably 0 nm to 5 nm. Rth is more preferably −20 nm to 5 nm, and even more preferably −10 nm to 0 nm When the cellulose acylate film of the present invention is used as a liquid crystal cell side protective film of a polarizing plate of a liquid crystal display device, light leakage from the inclined surface direction may be further reduced to improve display qualities if Re and Rth are within the above range.

When it is desired for the optical film of the present invention to exhibit retardation actively for use, for example, in a VA mode liquid crystal panel, it is preferred that the film satisfies the following Equations (IIIb) and (IVb), and it is also possible that an optical film used as a protective film serves as a support to form a functional layer which will be described below. Accordingly, for example, the contrast of a display screen of a liquid crystal display device may be enhanced or viewing angle characteristics or tint thereof may be improved.

30≦Re≦85 Equation (IIIb)

80≦Rth≦300 Equation (IVb)

In this case, the azimuth of the in-plane slow axis is not particularly limited but it is preferred that the azimuth is substantially parallel or perpendicular to the azimuth in which the in-plane elastic modulus of the film is the highest, and it is more preferred that the azimuth is substantially parallel thereto.

When it is desired for the optical film of the present invention to exhibit retardation actively for use, for example, in an IPS mode liquid crystal panel, it is preferred that the film satisfies the following Equations (IIIc) and (IVc), and it is also possible that an optical film used as a protective film serves as a support to form a functional layer which will be described below. Accordingly, for example, the contrast of a display screen of a liquid crystal display device may be enhanced or viewing angle characteristics or tint thereof may be improved.

60≦Re≦400 Equation (IIIc)

−0.5≦Rth/Re≦0.5 Equation (IVc)

In this case, the azimuth of the in-plane slow axis is not particularly limited but it is preferred that the azimuth is substantially parallel or perpendicular to the azimuth in which the in-plane elastic modulus of the film is the highest.

Meanwhile, Re and Rth may be measured as follows.

(Retardation)

In the present specification, Re and Rth (unit; nm) are obtained according to the following method. First, a film is humidity-controlled at 25° C. and 60% RH for 24 hours, and then the average refractive index (n) represented by the following Equation (B) is obtained by using a prism coupler (MODEL2010 Prism Coupler manufactured by Metricon) and using a solid state laser of 532 nm at 25° C. and 60% RH.

n=(n_{TE}×2+n_{TM})/3 Equation (B)

In the Equation (B), n_{TE} is a refractive index measured using light polarized in the plane direction of the film, and n_{TM} is a refractive index measured using light polarized in the normal direction of the film surface.

In the present specification, Re (λ nm) and Rth (λ nm) represent an in-plane retardation and a retardation in a thickness-direction at a wavelength of λ (unit; nm), respectively. Re (λ nm) is measured by irradiating with an incident light of λ nm in wavelength in the normal direction of the film using KOBRA 21ADH or WR (manufactured by Oji Scientific Instruments Co., Ltd.).

When a film to be measured is represented by a uniaxial or biaxial refractive index ellipsoid, Rth (λ nm) is calculated by the following method.

A total of six points of Re (λ nm) are measured by irradiating with an incident light of λ nm in wavelength from each of the inclined directions at an angle increasing in 10° step increments up to 50° in one direction from the normal direction of the film by taking the in-plane slow axis (decided by KOBRA 21ADH or WR) as an inclined axis (axis of rotation) (when there is no slow axis, any in-plane direction of the film will be taken as an axis of rotation), and then Rth (λ nm) is calculated by KOBRA 21ADH or WR based on the retardation value measured, the average refractive index, and the film thickness value inputted.

When is not particularly described and only described with Re and Rth in the above description, it means that values are measured by using light of 590 nm in wavelength. In the case of a film having a direction in which a retardation value is zero at a certain tilt angle from the normal direction about the in-plane slow axis as an axis of rotation, a retardation value at a tilt angle greater than that certain tilt angle is changed into a minus sign, and then is calculated by KOBRA 21ADH or WR.

Rth may also be calculated based on two retardation values measured in two different directions at any angle by taking the slow axis as an inclined axis (when there is no slow axis, any in-plane direction of the film will be taken as an axis of rotation), the average refractive index, and the film thickness inputted and from the following Equations (3) and (4).

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad Equation ( 3 )$$

[where Re(θ) represents a retardation value in a direction inclined by an angle (θ) from the normal direction. nx represents a refractive index in an in-plane slow axis direction; ny represents a refractive index in an in-plane direction perpendicular to nx, nz represents a refractive index in a thickness direction perpendicular to nx and ny, and d is a film thickness.]

Rth=((nx+ny)/2−nz)×d Equation (4)

When a film to be measured is not represented by a uniaxial or biaxial refractive index ellipsoid, so-called, when the film has no optic axis, Rth(λ nm) is calculated in the following manner.

Eleven points of Re (λ nm) are measured by irradiating with an incident light of λ nm in wavelength from each of the inclined directions at an angle increasing in 10° step increments from −50° to +50° in one direction from the normal direction of the film by taking the in-plane slow axis (decided by KOBRA 21ADH or WR) as an inclined axis (axis of rotation), and then Rth (λ nm) is calculated by KOBRA 21 ADH or WR based on the retardation value measured, the average refractive index, and the film thickness value inputted. nx, ny, and nz are calculated by inputting these average refractive index values and the film thickness into KOBRA 21ADH or WR. Nz=(nx−nz)/(nx−ny) is further calculated from the thus calculated nx, ny and nz.

In the above measurements, values described in a polymer handbook (John Wiley & Sons, Inc.) and catalogues of various optical films may be used as the average refractive index. For films whose average refractive index value is unknown, the value may be measured by using the above-described method. Values of average refractive index of main optical films are illustrated below. Cellulose acylate (1.48), cycloolefin polymer (1.52), polycarbonate (1.59), polymethyl methacrylate (1.49) and polystyrene (1.59)

(Humidity Dependence)

In the present invention, the humidity dependence of Re (ΔRe) and the humidity dependence of Rth (ΔRth) are calculated from values of retardation in an in-plane direction and in a thickness-direction: Re (H %) and Rth (H %) when the relative humidity is H (unit; %) based on the following equations.

ΔRe=Re(10%)−Re(80%)

ΔRthe=Rth(10%)−Rth(80%)

Re (H %) and Rth (H %) are calculated by humidity-controlling a film at 25° C. and 60% RH for 24 hr, then binding the film to a glass plate through an adhesive at 25° C. and 60% RH, humidity-controlling the resulting plate at 60° C. and 90% RH for 48 hr, conditioning the plate at 25° C. and H % RH for 24 hr, and measuring the retardation value at a measuring wavelength of 590 nm and H % RH in the same manner as in the method described above at 25° C. and H % RH. When Re is simply described without the relative humidity being specified, it means that values are measured at 60% RH as described above.

When the humidity of the cellulose acylate film of the present invention is changed, it is preferred that the retardation values satisfy the following relations.

|ΔRe|<30, and

|ΔRth|<30

It is more preferred that the retardation values satisfy the following relations.

|ΔRe|<15, and

|ΔRth|<15

It is more preferred that the retardation values satisfy the following relations.

|ΔRe|<10, and

|ΔRth|<10

It is most preferred that the retardation values satisfy the following relations.

|ΔRe|<5, and

|ΔRth|<5

When the humidity is changed, the retardation values may be controlled to reduce retardation variations with the external environmental changes, and thus a highly reliable liquid crystal display device may be provided. By reducing ΔRth of the optical film of the present invention, preferred effects are obtained in that circular color unevenness which is visible when a liquid crystal display device is observed from a surface inclined to the display surface under a specific condition is reduced. In order to reduce ΔRe or ΔRth effectively, the above-described humidity dependent decreasing agent is preferably used in combination.

[Coefficient of Hygroscopic Expansion of Film]

In the present invention, it was proved that circular color unevenness which is visible when a liquid crystal display device is observed from an inclined surface is difficult to be visible by approximating the coefficient of hygroscopic expansion of a film with that of a polarization film in addition to the above-described humidity dependence of Rth. The coefficient of hygroscopic expansion in the present invention is measured by preparing a film specimen measuring 25 cm in length (in a measuring direction) and 5 cm in width, which is cut out in a longitudinal direction coinciding with a direction in which the elastic modulus is the highest and a specimen which is cut out in a longitudinal length perpendicular to the direction, respectively, making pin holes in the specimens with a 20 cm spacing, conditioning the specimens at 25° C. and 10% RH for 24 hr, and longitudinally measuring the spacing of the pin holes with a pin gauge (making the measured value L₀). Subsequently, the specimens are then humidity-controlled at 25° C. and 80% RH for 24 hours, and the spacing of the pin holes is again longitudinally measured by a pin gauge (making the measured value L₁). These measured values are used to calculate the coefficient of hygroscopic expansion by the following equation.

Coefficient of hygroscopic expansion[ppm/%RH]={(L₁−L₀)/L₀}/70×10⁶

The ‘70’ is the difference in humidities (%) measured.

The coefficient of hygroscopic expansion of the film of the present invention may vary according to the kind of a polarization film to be used, but is preferably 55 ppm/% RH or less, more preferably 3 to 50 ppm/% RH, and even more preferably 5 to 45 ppm/% RH. The coefficient of hygroscopic expansion of the present invention may be reduced by, for example, increasing the crystallinity of the cellulose acylate contained in the optical film of the present invention, stretching the optical film of the present invention, and the like.

[Tensile Elastic Modulus of Film]

It was proved that the circular color unevenness which is visible when a liquid crystal display device is observed from an inclined surface is more difficult to be visible even by reducing the elastic modulus of the film. A tensile elastic modulus of the optical film of the present invention is preferably less than 3.0 GPa, more preferably 1.0 GPa to 3.0 GPa, and even more preferably 1.2 GPa to 2.8 GPa. As a specific measuring method, the elastic modulus is calculated from the slope by measuring the stress at 0.1% elongation and the stress at 0.5% elongation at a tension rate of 10%/min at an atmosphere of 25° C. and 60% RH with a universal tensile tester STM T50BP manufactured by Toyo Baldwin Co., Ltd. In the measurement of elastic modulus, elastic modulus anisotropy may be obtained by changing the azimuth of cutting out the specimen, and the angle (θ) between the conveying direction during manufacture and the azimuth in which elastic modulus is the highest is not particularly limited, but is preferably 0±10° or 90±10°. Meanwhile, the azimuth in which elastic modulus is the highest may be evaluated as a direction in which a sound propagation velocity to be described below is the highest.

Although details on the relation between the coefficient of hygroscopic expansion or tensile elastic modulus (hereinafter described) of the film and the visibility of color unevenness when a liquid crystal display device is observed from the inclined surface are unclear, it may be considered that by reducing a hygroscopic expansion coefficient or tensile elastic modulus of a film, the film is capable of reducing the internal stress generated with environmental humidity changes, while being in a state fixed to a highly rigid support such as glass, and as a result, the variations in retardation of the film may be further suppressed.

[Matting Agent Fine Particles]

It is preferred that fine particles as a matting agent are added to the optical film of the present invention. Examples of the fine particles used in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Fine particles containing silicon are preferred from the viewpoint of reducing the turbidity, and silicon dioxide is particularly preferred. Fine particles of silicon dioxide having an average primary particle diameter of 20 nm or less and an apparent specific gravity of 70 g/L or more are preferred. Those having a small average particle diameter of primary particles as from 5 to 16 nm are more preferred because the haze of the film may be reduced. The apparent specific gravity is preferably 90 g/L to 200 g/L or more, and more preferably 100 g/L to 200 g/L or more. A larger apparent specific gravity is preferred because a dispersion with a high concentration may be prepared, and thus, the haze and the agglomerated material become excellent.

These fine particles usually form secondary particles with an average particle size of 0.1 μm to 3.0 μm, and exist as agglomerates of the primary particles in a film and form unevenness of 0.1 μm to 3.0 μm on the surface of the film. The secondary average particle size is preferably 0.2 μm to 1.5 μm, more preferably 0.4 μm to 1.2 μm, and most preferably 0.6 μm to 1.1 μm. Particles in a film are observed under a scanning electron microscope and the circumscribed circle diameters of the particles are taken as a particle size of the primary or secondary particles. A total of 200 particles at different sites are observed to take the average value thereof as an average particle size.

As fine particles of silicon dioxide, commercially available products, for example, AEROSIL R972, R972V, R974, R812, 200, 200V, 300, 8202, OX50 and TT600 (all manufactured by Nippon Aerosil Co., Ltd.) may be used. As fine particles of zirconium oxide, for example, products under the brand names of AEROSIL R976 and R811 (both manufactured by Nippon Aerosil Co., Ltd.) are commercially available and thus may be used.

Among them, AEROSIL 200V and AEROSIL R972, which are fine particles of silicon dioxide having an average primary particle size of 20 nm or less and an apparent specific gravity of 70 g/L or more, are particularly preferred as being highly effective in reducing a frictional coefficient of the optical film while maintaining the turbidity of the film low.

In order to obtain an optical film having particles with a small average secondary particle size in the present invention, some techniques are proposed in preparing a dispersion of fine particles. For example, there is a method of preparing in advance a fine particle dispersion in which a solvent and fine particles are mixed by stirring to add the fine particle dispersion to a small amount of a separately prepared solution and dissolve the resulting solution by stirring and then mixing the mixture with a main dope solution. The method is preferable because silicon dioxide fine particles may be dispersed well and hardly re-agglomerate. In addition to the method, there is a method of adding a small amount of a cellulose ester to a solvent to be dissolved by stirring, adding the fine particles thereto to be dispersed with a dispersing machine as an addition liquid of fine particles, and thoroughly mixing the resulting addition liquid of fine particles with a dope solution with an in-line mixer. The present invention is not limited to these methods, but in mixing and dispersing the silicon dioxide fine particles in a solvent and the like, the silicon dioxide concentration is preferably 5% to 30% by mass, more preferably 10% to 25% by mass, and most preferably 15% to 20% by mass. A higher dispersion concentration is preferred because the concentration results in a lower liquid turbidity for the amount of addition, leading to reductions in haze and agglomerates.

As for the amount of the matting agent added in a final dope solution, a large amount thereof within a range of the allowable haze of a film is preferred in a soft film in which many additives are present like the present invention, and the amount is preferably 0.01 g/m² to 1.0 g/m², more preferably 0.03 g/m² to 0.3 g/m², and most preferably 0.08 g/m² to 0.16 g/m². When a cellulose acylate film is a multi-layered film formed by a film forming method such as, for example, co-casting, it is preferred that the matting agent is not added to the inner layer but only to the surface layer. In this case, the amount of the matting agent added to the surface layer is preferably 0.001% to 0.2% by mass, and more preferably 0.01% to 0.1% by mass.

The solvent used in the dispersion is preferably lower alcohols, and examples thereof include methyl alcohol, ethyl alcohol, propyl alcohol, isopropyl alcohol, butyl alcohol, and the like. Solvents other than lower alcohols are not particularly limited, but it is preferred that a solvent used during film formation of cellulose acylate is used.

[Other Additives]

In addition to the above-described compounds having repeating units, retardation controlling agents, and mat particles, various additives (for example, plasticizers, UV absorbers, deterioration inhibitors, release agents, IR absorbers, wavelength dispersion controlling agent, and the like) may be added to the optical film of the present invention, and these additives may be either solid or oily. That is, the melting point or boiling point thereof is not particularly limited. Examples thereof include a mixture of a UV absorbing material at 20° C. or less and another UV absorbing material at 20° C. or more, and the same applies to a mixture of plasticizers. Examples of such mixtures are described in Japanese Patent Application Laid-Open No. 2001-151901, and the like. IR absorbing dyes are described in, for example, Japanese Patent Application Laid-Open No. 2001-194522. The additives may be added at any time in the manufacturing process of the dope. However, adding the additives may be performed by including a process for adding additives to the final preparation process in the dope preparation process to prepare the dope solution. The amount of each material added is not particularly limited as long as functions are manifested. When the optical film has a multilayer structure, the kinds or amounts of additives added may differ among each layer. For example, there are descriptions in Japanese Patent Application Laid-Open No. 2001-151902, and the like, but these techniques are known in the related art. For details, materials described in detail in Japan Institute of Invention and Innovation Journal of Technical Disclosure (Technical Publication No. 2001-1745, Mar. 15, 2001, published by Japan Institute of Invention and Innovation), pp. 16 to 22, are preferably used.

[Total Content of Additives (Ct)]

As mentioned previously, when other additives in addition to the above-described compounds having repeating units are added to the optical film of the present invention, the total content of the additives is preferably 20 phr to 200 phr, more preferably 30 phr to 180 phr, and even more preferably 45 phr to 150 phr.

[Content of Additives on Surface (Cs)]

In the optical film of the present invention, from the viewpoint of inhibiting the contamination of a casting support to reduce the haze, it is preferred to reduce the content of additives on the surface thereof. From the viewpoint of increasing the surface hardness to inhibit the haze unevenness, it is preferred to reduce the content of additives on the surface thereof. Accordingly, the content of additives on the surface thereof is preferably 50 phr or less, but when the difference between the content of additives on the surface thereof and the above-described total content of additives added becomes too large, particularly Cs becomes larger than Ct, small wrinkle-like surface defects may occur. Therefore, the content of additives on the surface thereof is preferably 5 phr to 40 phr, more preferably 10 phr to 35 phr, and even more preferably 15 phr to 30 phr. The difference between Cs and Ct (ΔC=Ct−Cs) is preferably 150 phr or less, more preferably 50 phr or less, and even more preferably 30 phr or less while satisfying the Equation (1).

When a compound having repeating units which is preferably used in the present invention is used, it is difficult to induce the distribution of amount of additives in a thickness-direction compared to low molecular compounds used as plasticizers in the related art. Accordingly, in order to achieve the content on the surface thereof, it is preferred that other layers having different additive concentrations are co-cast as described below.

In the present invention, a method for measuring the content on the surface thereof is not particularly limited, but may be evaluated by mounting an ATR prism (for example, MKII Golden Gate Single Reflection ATR System, manufactured by Specac) including, for example, Ge, KRS-5, diamond, ZnSe, and the like on a Fourier transform IR spectrophotometer (for example, NICOLET6700, manufactured by Thermo Fisher Scientific) and performing measurement in a reflective mode to observe a characteristic absorption peak area. Specifically, evaluation may be performed by using a ratio (I₂/I₁) of a polymer-derived absorption peak area (I₁) and an additive-derived peak area (I₂).

A sample obtained by cutting a sample up to 3 μm from the film surface may be measured in a transmisssive mode of a Fourier transform IR spectrophotometer. When the sample cut in this manner is used, evaluation may be performed by using a nuclear magnetic resonance absorption apparatus (¹H-NMR, for example, AVance400, manufactured by Bruker) to perform a measurement and observe a characteristic signal strength ratio.

[Wax Component]

The optical film of the present invention includes a wax component which is different from the additives.

Examples of the wax component include a component originally contained in cellulose and a component secondarily produced together with a cellulose acylate in a step to purify cellulose acylate from cellulose. Specifically, examples of the former include a fatty acid and a fatty acid ester and examples of the latter include a metal salt of fatty acid. As a fatty acid, a component included in the polymer or the additives and having total carbon atoms of 26 or more is preferred because a component having total carbon atoms of 25 or less is easily soluble in a solvent and therefore it is difficult to case precipitation of the component from a casting film. As a fatty acid ester, it may be a component produced by a fatty acid contained in the polymer and alcohol contained in a solvent and a component produced by the additives to be added when preparing dope and alcohol contained in a solvent. Also, as a metal salt of fatty acid, a component to form an ion derived from the fatty acid and a metal ion, specifically, fatty acid calcium and fatty acid magnesium and so on are exemplified.

The wax component preferably contains at least one selected from the group consisting of a fatty acid, a fatty acid ester and a metal salt of fatty acid. The content of the wax component, based on the cellulose ester component, is preferably 0.1 ppm to 1000 ppm, more preferably 0.1 ppm to 500 ppm, even more preferably 1 ppm to 1000 ppm, and particularly preferably 5 ppm to 80 pm. In a case where the content of the wax component is 0.1 ppm or less, there are some cases where a load to peel a web from a support becomes large and thereby surface property of the optical film is deteriorated. On the other hand, in a case where the content of the wax component is 1000 ppm or more, there are some cases where contamination of the support caused by casting with time is drastically promoted and thereby haze of the optical film is increased. Therefore, such contents of the wax component are not preferable and such deteriorations are remarkably caused, particularly when the content of the additive is large and a thickness of the optical film is thin. In the present invention, the content of the wax component can be calculated from a mass of ingredients thereof extracted by hexane.

Compositions of the wax component can be measured by using IR (infrared spectrophotometer), GCMS (gas chromatograph mass spectrometer), NMR (nuclear magnetic resonance apparatus), and so on. The content of the polymer in the film can be measured by GCMS, and so on.

[Manufacturing Method of Optical Film]

(Organic Solvent of Dope Solution)

In the present invention, it is preferred that a film including a cellulose ester is manufactured by a solvent casting method, and a film is prepared by using a solution (dope) in which a polymer including the cellulose ester is dissolved in an organic solvent. The organic solvent preferably used as a main solvent of the present invention is not particularly limited so long as polymers including the cellulose ester are dissolved in the organic solvent, but solvents selected from esters having 3 to 12 carbon atoms, ketone, ether, and halogenated hydrocarbons having 1 to 7 carbon atoms are preferred. The ether, ketone, and ester may have a cyclic structure. Compounds having two or more of any of ester, ketone and ether functional groups (that is, —O—, —CO—, and —COO—) may also be used as a main solvent, and may have other functional groups such as, for example, an alcoholic hydroxyl group.

As described above, a chlorine-based halogenated hydrocarbon may be used as a main solvent in the optical film of the present invention, and as described in Japan Institute of Invention and Innovation Journal of Technical Disclosure 2001-1745 (pp 12 to 16), a non-chlorine-based solvent may be used as a main solvent and the optical film of the present invention is not particularly limited thereto.

Solvents for dope solutions and films of the present invention as well as dissolving methods thereof are disclosed in the following patents, which are a preferred aspect. These solvents and methods are disclosed in, for example, Japanese Patent Application Laid-Open Nos. 2000-95876, Hei 12-95877, Hei 10-324774, Hei 8-152514, Hei 10-330538, Hei 9-95538, Hei 9-95557, Hei 10-235664, Hei 12-63534, Hei 11-21379, Hei 10-182853, Hei 10-278056, Hei 10-279702, Hei 10-323853, Hei 10-237186, Hei 11-60807, Hei 11-152342, Hei 11-292988, Hei 11-60752, Hei 11-60752, and the like. According to these patent documents, there are descriptions about not only solvents preferable for dissolving the cellulose ester of the present invention but also properties of the solutions or substances that may added to the solutions, and the descriptions are a preferred aspect even in the present invention.

(Dissolution Process)

The dissolution method in the preparation of the dope solution of the present invention is not particularly limited, and any method such as a room-temperature dissolving method, a cold dissolving method, a hot dissolving method, and a combination thereof may be used. With respect to each process of preparation of a dope solution and concentration and filtration of solutions according to the dissolution process, the preparation processes described in detail in Japan Institute of Invention and Innovation Journal of Technical Disclosure (Technical Publication No. 2001-1745, Mar. 15, 2001, published by Japan Institute of Invention and Innovation), pp. 22 to 25, are preferably used in the present invention.

(Casting, Drying and Winding Processes)

Subsequently, a method for manufacturing a film by using a dope solution of the present invention will be described. A method and an apparatus for manufacturing an optical film of the present invention may use a solution casting film formation method and a solution casting film formation device that are used in the manufacturing a cellulose triacetate film in the related art. A dope solution prepared in a dissolver (tank) is once stored in a storage tank, and bubbles included in the dope are defoamed to perform a final preparation. The resulting dope is fed from a dope exit to a pressure die through for example, a pressure constant displacement gear pump capable of precise metering and transporting solutions according to the number of rotations and uniformly cast from an inlet member (slit) of the pressure die on an endlessly moving metal support of a casting portion and at a peeling point where the metal support makes almost one revolution, a half-dried doping film (also referred to as a web) is peeled off the metal support. Both edges of the web thus obtained are fixed therebetween by a clip, conveyed and dried by a tenter while the width thereof is maintained, and the film subsequently obtained is mechanically conveyed with a roll group in a heating apparatus and wound in the form of a roll by a winder to a predetermined length. The combination of the tenter and the drying apparatus of the roll group varies depending on the purpose. In another aspect, it is possible to employ various methods of forming a film by using a solvent casting method such as a method including the following process: the doping extruded from a die gels onto a drum which cools the above-described metal support to 5° C. or less, and then at a time point when the metal support makes almost one revolution, is removed from the drum, conveyed while being stretched by a pin-type tenter, and dried.

In the optical film of the present invention, it is preferred to perform casting by a co-casting method. That is, a casting having a plurality of layers is performed by extruding at least two or more dopes which are different in the amount of addition simultaneously or sequentially from an inlet member of a die. In this case, the absolute value of the difference (Δc=c2−c1) between the content (c1[phr]) of additives in at least one dope solution and the content (c2[phr]) of additives of a dope solution to form another layer is 2 phr or more, preferably 5 phr to 150 phr, more preferably 10 phr to 100 phr, and even more preferably 20 phr to 50 phr. It is also preferred to control the thickness of each layer. For example, the contamination of a casting support may be inhibited to reduce the haze of a film or decrease the content of additives of the film on the surface thereof by disposing a layer having a small amount of addition as a layer in contact with the casting support or increasing the film thickness of the layer, and thus these factors may be appropriately controlled while a balance with other required characteristics is confirmed.

For example, in the case where the film is formed of two kinds of dopes, it is preferred to dispose a layer formed of a dope of c2 as a layer in contact with the casting support and a layer formed of a dope of c1 as a layer on the opposite side thereto, respectively, while satisfying a relation of c1>c2; and in the case where the film is formed of three or more kinds of dopes, it is preferred to dispose a layer formed of a dope of c2 as a layer in contact with the casting support and a layer formed of a dope of c1 as other layers, respectively.

A thickness (D) of the layer formed of the dope with the content of the additives of c2 is preferably thicker, specifically, the thickness (D) is preferably 1 μm to 30 μm, more preferably 3 μm to 20 μm, and even more preferably 5 μm to 15 μm. Incidentally, in the present invention, in the case where two layers are present as the layer having a lower content of the additives than that of other layers and are disposed on the outermost surface, the content c2 is sometimes expressed as c2(1) and c2(2), respectively.

A film thickness (D1) formed from c1 and a film thickness (D2) formed from c2 may be the same as or different from each other. Also, in the present invention, in the case where two layers are present as the layer having a lower content of the additives than that of other layers and are disposed on the outermost surface, the film thickness of the layer formed from c2(1) and the layer formed from c2(2) is sometimes expressed as D2(1) and D2(2), respectively. Even when D1 and D2 are the same as each other, or D1 and D2 are different from each other, the case where D1 and D2 are the same as each other is preferable from the viewpoint of curls of the film. In the case where D1 and D2 are different from each other, the manufacturing compatibility may be imparted by making characteristics different between the front and rear surfaces of a film or a web; or the surface hardness may be imparted, or the surface shape of the film may be improved while effects of improving the display unevenness of an image display device are maintained by maintaining a total amount of addition of the film.

In the co-casting, the haze of the film or the content of additives on the surface of the film may be controlled even by controlling the concentration of a solid of a layer in contact with the casting support. For example, it may be difficult to transfer the surface shape of the casting support by reducing the concentration of a solid in the layer. That is, when large amounts of additives are contained or a thickness of the film is small, due to fast drying rate in the dope, the residual solvent amount contained in the dope (web) at being peeled off from the casting support is small and an effect of a leveling in the subsequent process is lowered, and thereby surface unevenness of the casting support is easily transferred. However, such surface unevenness is very small, and therefore it is thought that it is possible to reduce the haze of the film by locally reducing the concentration of a solid in a portion being contact with the coasting support.

Meanwhile, if desired, the diffusivity of additives may be inhibited by increasing the concentration of the solid in the layer being in contact with the casting support and thus the contamination of the casting support may be inhibited or the haze or haze unevenness can be prevented by reducing the content of the additives on the surface of the film. These factors may be appropriately controlled while a balance with other required characteristics is confirmed.

When the co-casting is performed, for example, a feed blocking method by which the number of layers is easily controlled or a multi-manifold method which has excellent thickness precision in each layer may be used, and a feed blocking method may be more preferably used in the present invention.

In a solution casting film formation method used in a functional polarizing plate protective film which is an optical member for electronic displays or a silver halide photographic light-sensitive material, which are the primary uses of the optical film of the present invention, a coating device is often combined with a solution casting film formation device to provide a surface processing on a film such as an undercoat layer, an antistatic layer, an anti-halation layer, a protective layer, and the like. The devices are described in detail in Japan Institute of Invention and Innovation Journal of Technical Disclosure (Technical Publication No. 2001-1745, Mar. 15, 2001, published by Japan Institute of Invention and Innovation), pp. 25 to 30, and classified into casting (including co-casting), metal support, drying, peeling, and the like, which may be preferably used in the present invention.

(Heat Treatment Process)

In the manufacturing method of the optical film of the present invention, a process of subjecting the optical film to further heat treatment may be applied if necessary. Although the effects of the heat treatment process are not particularly limited, it is believed that for example, a coefficient of hygroscopic expansion may be changed by performing heat treatments in which temperature and tensile strength are controlled according to the kind of the film to change the orientation or crystallization of cellulose ester molecules to be included.

[Thickness of Film]

The optical film of the present invention has a thickness of preferably 20 μm to 120 μm, more preferably 30 μm to 90 μm, and particularly preferably 35 μm to 80 μm. However, there may be the case where the thickness of the film is preferably 5 to 80 μm, more preferably 10 to 60 μm, and even more preferably 15 to 50 μm within the range where the above Equation (2) is satisfied. From the viewpoint of satisfying both an improvement of the light unevenness and productivity, in particular, the latter preferred embodiment may be preferably applied to the case of a film having a relatively low content of additives. For use as a polarizer protective film attached to a liquid crystal panel, from the viewpoint of improving warpage of a panel, the thickness is preferably 5 μm to 80 μm, more preferably 15 μm to 65 μm, and particularly preferably 20 μm to 50 μm in reducing light unevenness. When the film thickness is within this range, warpage of the panel according to changes in temperature and humidity may be reduced. Incidentally, what the thickness is too thin as compared with the above range is not preferred because, for example, handling properties in the manufacturing process are deteriorated, or when the polarizing plate is exposed in a wet heat environment, fine wrinkles are produced on the surface of the polarizing plate; and what the thickness is too thick as compared with the above range is not preferred because, for example, a lot of time is required for drying in the manufacturing process, or when the panel is exposed in a wet heat environment, warpage of the panel becomes large, thereby producing light leakage.

[Haze of Film]

The optical film of the present invention preferably has a low haze, and the haze is preferably 0.01% to 2.0%. The haze is more preferably 1.0% or less, and even more preferably 0.5% or less. However, since the haze of the film of the present invention predominantly has surface haze components resulting from the surface shape, the components are eliminated, for example, if an adhesion bond is used to attach the film to a polarization film or an adhesive is coated to change the shape of the surface, and thus even the haze values higher than the values in the preferred range do not have any effects on display characteristics of a liquid crystal display device. However, haze unevenness which are visible in portions where pressure is applied or not applied is problematic as a film appearance for use in the optical film. Thus, the haze unevenness which is evaluated as a haze distribution of the film of the present invention is preferably 0.5% or less, more preferably 0.3% or less, even more preferably 0.1% or less, and most preferably 0.05%. Measurement of haze may be conducted with a optical film sample of the present invention having 40 mm×80 mm at 25° C. and 60% RH in accordance with JIS K-6714 by using a haze meter (HGM-2DP, manufactured by Suga Test Instruments Co., Ltd.), and the like.

[Surface Roughness (Ra)]

The surface of the optical film of the present invention was observed in an AFM mode by using a scanning probe microscope (SPA400, manufactured by SII NanoTechnology Inc.) to obtain a surface average surface roughness (Ra) in a range of 100 μm×100 μm. The optical film of the present invention preferably has a surface roughness of 50 nm or less. It is preferred to have a surface roughness of 50 nm or less from the viewpoint of reducing the haze of the film. It is preferred to have a surface roughness of 1 nm or more from the viewpoint of the sliding property of a base or the adhesion with a polarizer. The surface roughness is preferably 1 nm to 30 nm, more preferably 1 nm to 10 nm, even more preferably 1.5 nm to 5 nm, and most preferably 1.5 nm to 3 nm. Meanwhile, when the surface roughness is more than 3 nm, it is preferred to have a surface hardness within a range to be described below.

[Surface Hardness]

In the present invention, the surface hardness was evaluated as a nanoindentation hardness which will be described below.

<<Measurement of Nanoindentation Hardness (H) and Elastic Modulus (Er)>>

The nanoindentation hardness (H) and nanoindentation elastic modulus (Er) of the outermost surface layer of the optical film of the present invention were measured by using an ultramicro hardness test system PICODENTOR manufactured by Fisher Co., Ltd.

In the measurement, a pyramidal diamond indenter called a Berkovich type indenter (tip angle 142.3°) was used as an indenter.

The pyramidal diamond indenter was put on the surface of the specimen at a right angle, a load was slowly applied thereon, and the load was slowly returned to 0 after the load reached the maximum load. A value P/A obtained by dividing the maximum load P at this time by a projected area A of an indenter contact portion was calculated as a nanoindentation hardness (H). The nanoindentation elastic modulus (Er) was calculated by using the following equation when the slope of an unloading curve was taken as S.

Er=(S×√π)/(2√A)(wherein π is a circumference ratio)

The device was in advance corrected and measurement was performed as to have a hardness of 9.5±1.5 GPa to be obtained as a result of press fitting of a melted quartz which was an auxiliary, as a standard specimen.

The detailed principle, reference is described in Handbook of Micro Nano Tribology (edited by Bharat Bhushan CRC).

The specimen was cured by dropping a drop of an adhesion bond, Aron Alpha, manufactured by TOA GOSEI CO., LTD, on a slide glass, putting a film cut into an angle of about 1 cm thereon, leaving the specimen to stand for 24 hr.

In the measurement of the outermost surface, setting was made to have a maximum load P of 0.2 mN. Loading and unloading was all performed in 5 sec.

If measurement is performed in this way, not only effects of inhibiting haze unevenness, but also the sliding property of the film may be improved, and thus, favorable effects may be obtained, which the roll that winds and attaches the film may have a good shape of winding.

[Spectroscopic Characteristics, Spectral Transmissivity]

Transmissivity may be measured at a wavelength of 300 nm to 450 nm at 25° C. and 60% RH with a spectrophotometer “U-3210” {Hitachi Ltd.} by preparing a 13 mm×40 mm sample of an optical film. The inclination width may be obtained with a 72% wavelength to a −5% wavelength. The threshold wavelength may be represented by (inclination width/2)+5% wavelength, and absorption edge may be represented by a wavelength with 0.4% transmissivity. Transmissivities at 380 nm and 350 nm may be evaluated from this.

When the optical film of the present invention is used on a side facing a protective film to contact the liquid crystal cell of a polarizing plate, it is preferred that the spectral transmissivity measured at a wavelength of 380 nm is 45% to 95%, and the spectral transmissivity measured at a wavelength of 350 nm is 10% or less.

[Glass Transition Temperature]

The glass transition temperature may be determined by using a differential scanning calorimeter (DSC) as an average value of a temperature at which a base line derived from glass transition of a film when measured at a temperature increasing rate of 10° C./min starts to be modified and a temperature at which the glass goes back to the base line.

Measurement of the glass transition temperature may be conducted by using the following dynamic viscoelasticity measuring device. A 5 mm×30 mm specimen (not stretched) of the cellulose acylate film of the present invention is humidity-controlled at 25° C. and 60% RH for at least 2 hours. Measurement is made with a dynamic viscoelasticity measuring device (Vibron: DVA-225 (manufactured by ITK Co., Ltd) at a distance between grips of 20 mm, at a heating rate of 2° C./min, at a measuring temperature range from 30° C. to 250° C., and at a frequency of 1 Hz. When the storage modulus is plotted on a logarithmic ordinate and the temperature (° C.) is plotted on a linear abscissa at the horizontal axis, a straight line 1 and a straight line 2 showing a steep decrease in storage modulus observed at the phase transition from the solid region to the glass transition region are drawn in the solid region and the glass transition region, respectively. The intersection of the lines 1 and 2 indicates the temperature at which the storage modulus starts to decrease abruptly and the film starts to soften during heating, that is, at which the film begins to be transferred to the glass transition region. Therefore, this temperature is referred to as the glass transition temperature Tg (dynamic viscoelasticity).

[Equilibrium Water Content of Film]

The water content (equilibrium water content) of the optical film of the present invention is not particularly limited, but does not harm the adhesion with an aqueous polymer, such as polyvinyl alcohol, and the like when the film is used as a protective film for a polarizing plate. Thus, the water content is preferably 0% to 4% at 25° C. and 80% RH irrespective of film thickness. The water content is more preferably 0.1% to 3.5% and particularly preferably 1% to 3%. With the equilibrium water content of 4% or less, the film is prevented from having too much humidity dependence of retardation, which is preferred for use as a support of a phase difference film.

The water content was measured by a Karl-Fischer's method on a specimen 7 mm×35 mm of the optical film of the present invention using a moisture meter “CA-03” and a specimen drying device “VA-05”, {both of which manufactured by Mitsubishi Chemical Corp.}. The measured amount of water (g) is divided by the specimen mass (g) to give a water content.

[Moisture Vapor Permeability of Film]

The moisture vapor permeability may be determined under conditions of 40° C. and 90% RH based on JIS Z-0208. The moisture vapor permeability of the optical film of the present invention is not particularly limited but preferably is 50 to 1,500 g/m²·24 h. The value is more preferably 100 to 1,000 g/m²·24 h and particularly preferably 200 to 800 g/m²·24 h. If the moisture vapor permeability is within the range, the processability of a polarizing plate and the durability of the polarizing plate to humidity or humid heat are compatible, which is preferred.

(Propagation Velocity of Sound Wave (Sound Velocity))

The direction having the highest propagation velocity of a sound wave in the present invention was determined as the direction in which the longitudinal wave oscillation of ultrasonic pulses propagates at the highest velocity, which was obtained by using a specimen having been humidity-controlled at 25° C. and 60% RH for 24 hr with an orientation measuring device (SST-2500: Nomura Shoji Co., Ltd.). In the present invention, it may be considered that the direction in which the elastic modulus is the highest and the direction in which the propagation velocity of a sound wave is the highest are approximately parallel to each other.

[Photoelastic Coefficient]

When the optical film of the present invention is used as a protective film for a polarizing plate, there may be a change in birefringence (Re, Rth) due to the stress accompanying the shrinkage of a polarizer. Such a change in birefringence due to the stress may be determined in terms of photoelastic coefficient, and the range thereof is preferably 15×10¹² Pa⁻¹ or less (15 Br or less), more preferably −5×10¹² Pa⁻¹ to 12×10¹² Pa⁻¹, and even more preferably −2×10¹² Pa⁻¹ to 11×10¹² Pa⁻¹.

[Contact Angle of Film Surface by Alkali Saponification Treatment]

Since the optical film of the present invention includes cellulose acylate, an alkali saponification treatment may be mentioned as one of effective means of the surface treatment when the optical film of the present invention is used as a protective film of a polarizing plate. In this case, the contact angle of the film surface after the alkali saponification treatment is preferably 55° or less. The contact angle of the film surface is more preferably 50° or less, and even more preferably 45° or less.

[Surface Treatment]

The optical film may be subjected to a surface treatment to achieve the improvement of the adhesion between the optical film and respective functional layers (for example, an undercoat layer and a back layer). For example, a glow discharge treatment, an ultraviolet irradiation treatment, a corona treatment, a flame treatment, and an acid or alkali treatment may be used. As used herein, the glow discharge treatment may be a low temperature plasma caused under a low pressure gas of 10⁻³ Torr to 20 Torr, and further preferably a plasma treatment under an atmospheric pressure. The plasma excitable gas denotes a gas that may be excited into plasma under the conditions as described above, and includes argon, helium, neon, krypton, xenon, nitrogen, carbon dioxide, flons such as tetrafluoromethane, mixtures thereof, and the like. These gases are described in detail in Japan Institute of Invention and Innovation Journal of Technical Disclosure (Technical Publication No. 2001-1745, Mar. 15, 2001, published by Japan Institute of Invention and Innovation) pp. 30 to 32, which may be preferably used in the present invention.

[Functional Layer]

The optical film of the present invention is applied to, for example, an optical use and a photographic photosensitive material as the uses thereof. In particular, the optical use is preferably a liquid crystal display device. The liquid crystal display device is further preferably configured to have a liquid crystal cell including liquid crystal held between two electrode substrates, two polarizing elements disposed on the opposite sides thereof, and at least one optically-compensatory sheet disposed between the liquid crystal cell and the polarizing device. The liquid crystal display devices are preferably of TN, IPS, FLC, AFLC, OCB, STN, ECB, VA and HAN.

At that time, when the optical film of the present invention is used for the optical use as described above, imparting of various functional layers is carried out. Examples thereof include an antistatic layer, a curable resin layer (transparent hard coat layer), an antireflection layer, an easy-to-adhere layer, an antiglare layer, an optically-compensatory layer, an alignment layer, a liquid crystal layer, and the like. The functional layers and materials thereof may include a surfactant, a slipping agent, a matting agent, an antistatic layer, a hard coat layer, and the like, and are described in details in Japan Institute of Invention and Innovation Journal of Technical Disclosure (Technical Publication No. 2001-1745, Mar. 15, 2001, published by Japan Institute of Invention and Innovation) pp. 32 to 45, which may be preferably used in the invention.

<<Phase Difference Film>>

The phase difference film of the present invention includes at least one of the optical film of the present invention.

The optical film of the present invention may be used as a phase difference film. The “phase difference film” is generally used in display devices such as liquid crystal display device, and the like, means an optical material having optical anisotropicity, and is synonymous with a phase difference plate, an optically compensatory film, an optically compensatory sheet, and the like. In the liquid crystal display device, the phase difference film is used for the purpose of enhancing the contrast of a display screen or improving viewing angle characteristics or tint.

Retardation may be freely controlled by using the optical film of the present invention, and thus a phase difference film having excellent adhesion with a polarization film may be manufactured.

The cellulose acylate film of the present invention may be used as a phase difference film by stacking a plurality of optical films of the present invention or stacking the optical film of the present invention with a film out of the present invention to control Re or Rth appropriately. The stacking of films may be performed by using an adhesive or an adhesion bond.

In some cases, the optical film of the present invention may be used as a support of a phase difference film, and then, by providing an optically anisotropic layer including a liquid crystal and the like thereon, a phase difference film is formed. The optically anisotropic layer applied to the phase difference film of the present invention may be formed as, for example, a composition containing liquid crystalline compound, a polymer film having birefringence, and the optical film of the present invention.

As the liquid crystalline compound, discotic liquid crystalline compounds or rod-like liquid crystalline compounds are preferred.

[Discotic Liquid Crystalline Compounds]

Examples of discotic liquid crystal compounds that may be used as the liquid crystalline compounds in the present invention include compounds described in various documents (for example, C. Destrade et al., Mol. Crysr. Liq. Cryst., vol. 71, page 111 (1981); edited by the Chemical Society of Japan, Quarterly Issue Chemistry Review Paper, No. 22, Chemistry of Liquid Crystal, Ch. 5, Ch. 10, Sec. 2 (1994); B. Kohne et al., Angew. Chem. Soc. Chem. Comm., page 1794 (1985); and J. Zhang et al., J. Am. Chem. Soc., vol. 116, page 2655 (1994)).

In the optically anisotropic layer, the discotic liquid crystalline molecules are preferably fixed in an aligned state, and are most preferably fixed by a polymerization reaction. The polymerization of discotic liquid crystalline molecules is described in Japanese Patent Application Laid-Open No. Hei 8-27284. In order to fix the discotic liquid crystalline molecules by polymerization, it is necessary to bind a polymerizable group to the discotic core of the discotic liquid crystalline molecules as a substituent. However, when the polymerizable group is directly bound to the discotic core, it becomes difficult to maintain the orientation state for the polymerization reaction. Thus, a linking group is introduced between the discotic core and the polymerizable group. The discotic liquid crystal molecules having a polymerizable group are described in Japanese Patent Application Laid-Open No. 2001-4387.

[Rod-Like Liquid Crystalline Compounds]

Examples of rod-like liquid crystalline compounds that may be used as the liquid crystalline compounds include azomethines, azoxy compounds, cyanobiphenyls, cyanophenyl esters, benzoic esters, phenyl esters of cyclohexanecarboxylic acid, cyanophenylcyclohexanes, cyano-substituted phenylpyrimidines, alkoxy-substituted phenylpyrimidines, phenyldioxanes, tolans, and alkenylcyclohexylbenzonitriles. As the rod-like liquid crystalline compounds, not only low molecular liquid crystalline compounds, but also high molecular liquid crystalline compounds may be useful.

In the optically anisotropic layer, the rod-like liquid crystalline molecules are preferably fixed in an aligned state, and are most preferably fixed by a polymerization reaction. Examples of polymerizable rod-like liquid crystalline compounds that may be used in the present invention include compounds described, for example, in Makromol. Chem., vol. 190, page 2255 (1989), Advanced Materials, vol. 5, page 107 (1993), U.S. Pat. Nos. 4,683,327, 5,622,648, and 5,770,107, WO 95/22586, 95/24455, 97/00600, 98/23580, and 98/52905, and of Japanese Patent Application Laid-Open Nos. Hei 1-272551, Hei 6-16616, Hei 7-110469, Hei 11-80081, 2001-328973, and the like.

<<Polarizing Plate>>

The polarizing plate of the present invention includes at least one optical film of the present invention or at least one phase difference film of the present invention.

The optical film or phase difference film of the present invention may be used as a protective film of the polarizing plate (the polarizing plate of the invention). The polarizing plate of the present invention includes a polarization film and two polarizing plate protective films (optical films) that protect both sides thereof, and the optical film or phase difference film of the present invention is particularly preferably used as a polarizing plate protective film on at least one side.

When the optical film of the present invention is used as the polarizing plate protective film, the optical film is preferably subjected to a surface treatment for hydrophilization, such as the above described surface treatments (also described in Japanese Patent Application Laid-Open Nos. Hei 6-94915 and Hei 6-118232), and for example, a glow discharge treatment, a corona discharge treatment, an alkali saponification treatment and the like are preferably performed. As the surface treatment, an alkali saponification treatment is used most preferably.

The polarization film may be prepared by, for example, immersing a polyvinyl alcohol film in an iodine solution and stretching the film. When the polarization film prepared by immersing a polyvinyl alcohol film in an iodine solution and stretching the film is used, the optical film of the invention can be attached on its surface treated side directly to both sides of the polarization film with an adhesion bond applied therebetween. In the preparation method of the present invention, it is preferred that the optical film be directly attached to the polarization film in that way. Examples of the adhesion bonds include aqueous solutions of polyvinyl alcohol or polyvinyl acetal (for example, polyvinyl butyral) or latexes of vinyl polymers (for example, polybutyl acrylate). An aqueous solution of completely saponified polyvinyl alcohol is a particularly preferred adhesion bond.

A liquid crystal display device generally has a liquid crystal cell disposed between a pair of polarizing plates and therefore contains four polarizing plate protective films. While the optical film of the present invention may be used as any one or more of the four polarizing plate protective films, it is particularly advantageous to use the optical film of the present invention as the protective film disposed between the polarization film and the liquid crystal layer (liquid crystal cell) in a liquid crystal display device. A transparent hardcoat layer, an antiglare layer, an antireflective layer, and the like may be provided on the protective film disposed on the side opposite to the side of the optical film of the present invention between the polarization films and is particularly preferably used as the polarizing plate protective film of the outermost surface of the display side of a liquid crystal display device.

The polarizing plate is composed of a polarizer and a protective film that protects both sides thereof and combines and is composed of a protective film on one side of the polarizing plate and a separate film on the other side thereof. Both the protective film and the separate film are used for the purpose of protecting the polarizing plate during shipment of the polarizing plate or inspection of the product. In this case, the protective sheet is attached for the purpose of protecting the surface of the polarizing plate, and the polarizing plate is used on the side opposite to the surface in contact with the liquid crystal plate. The separate film is used for the purpose of covering the adhesion bond layer which is attached to the liquid crystal plate, and used on the side which attaches the polarizing plate to the liquid crystal plate.

In the liquid crystal display device, a substrate including a liquid crystal is usually disposed between two polarizing plates, but the polarizing plate protective film to which the optical film of the present invention is applied may provide excellent display qualities even though the protective film may be disposed in any portion. In particular, a transparent hardcoat layer, an antiglare layer, an antireflective layer, and the like are provided on the protective film on the outermost surface on the display side of a liquid crystal display device, and thus the polarizing plate protective film is particularly preferably used on this portion.

<<Liquid Crystal Display Device>>

The optical film, phase difference film, and polarizing plate of the present invention may be used for liquid crystal display devices of various display modes. Hereinafter, each of liquid crystal modes in which these films may be used will be described. Among these modes, the optical film, phase difference film, and polarizing plate of the present invention may be preferably used in all the modes, but are particularly preferably used for liquid crystal display devices of the VA mode and IPS mode. These liquid crystal display devices may be any of a transmissive type, a reflective type and a semi-transmissive type.

(TN Type Liquid Crystal Display Device)

The optical film of the present invention is preferably used as a support of a phase difference film in a TN type liquid crystal display device having a TN mode liquid crystal cell. TN mode liquid crystal cells and TN type liquid crystal display devices have long been known. The phase difference film used in TN type liquid crystal display devices are described in Japanese Patent Application Laid-Open Nos. Hei 3-9325, Hei 6-148429, Hei 8-50206, and Hei 9-26572, and Mori et al., papers (Jpn. J. Appl. Phys., vol. 36 (1997), p. 143 or Jpn. J. Appl. Phys. Vol. 36 (1997), p. 1068).

(STN Type Liquid Crystal Display Device)

The optical film of the present invention may be used as a support of a phase difference film in an STN type liquid crystal display device having an STN mode liquid crystal cell. In common STN type liquid crystal display devices, rod-like liquid crystalline molecules in the liquid crystal cell are twisted in the range of 90° to 360°, and the product (And) of the refractive index anisotropy (Δn) of the rod-like crystalline molecules and the cell gap (d) is in the range of 300 nm to 1500 nm. The phase difference film used in STN type liquid crystal display devices is described in Japanese Patent Application Laid-Open No. 2000-105316.

(VA Type Liquid Crystal Display Device)

The optical film of the present invention is particularly advantageously used as a phase difference film or a support of the phase difference film in a VA type liquid crystal display device having a VA mode liquid crystal cell. The VA type liquid crystal display device may have an alignment division mode as described in, for example, Japanese Patent Application Laid-Open No. Hei 10-123576. In these aspects, a polarizing plate using the optical film of the present invention contributes to the enlargement of viewing angle and the improvement of contrast.

(IPS Type Liquid Crystal Display Device and ECB Type Liquid Crystal Display Device)

The optical film of the present invention is particularly advantageously used as a phase difference film, a support of the phase difference film, or a protective film of a polarizing plate in an IPS type liquid crystal display device having an IPS mode liquid crystal cell and an ECB type liquid crystal display device having an ECB mode liquid crystal cell. When black is displayed, these modes are an aspect in which the liquid crystal materials are aligned substantially in parallel with each other, and the liquid crystal molecules are aligned in parallel with the surface of the substrate in no voltage applied state to achieve a black display. In these aspects, a polarizing plate using the optical film of the present invention contributes to the enlargement of viewing angle and the improvement of contrast.

It is preferred to have |Rth| of less than 25 nm, but it is particularly preferred that the optical film have Rth of 0 nm or less in a region of 450 nm to 650 nm because tint change is small.

In these aspects, it is preferred that among protective films of the polarizing plate on and below the liquid crystal cell, the polarizing plate using the optical film of the present invention is used on and below the liquid crystal cell in a protective film (a protective film on the cell side) disposed between the liquid cell and the polarizing plate. It is more preferred that an optically anisotropic layer set to have a retardation value twice or less the value of Δn·d of the liquid crystal layer is disposed on one side between the protective film of the polarizing plate and the liquid crystal cell.

(OCB Type Liquid Crystal Display Device and HAN Type Liquid Crystal Display Device)

The optical film of the present invention is also advantageously used as a support of a phase difference film in an OCB type liquid crystal display device having an OCB mode liquid crystal cell or an HAN type liquid crystal display device having an HAN mode liquid crystal cell. In the phase difference film used in the OCB type liquid crystal display device or the HAN type liquid crystal display device, it is preferred that the direction in which the absolute retardation value is the lowest exists in neither an in-plane direction nor the nominal direction thereof. The optical properties of the phase difference film used in the OCB type liquid crystal display device or the HAN type liquid crystal display device are also determined by optical properties of the optically anisotropic layer, optical properties of the support, and the arrangement between the optically anisotropic layer and the support. A phase difference film used in the OCB type liquid crystal display device or the HAN type liquid crystal display device is described in Japanese Patent Application Laid-Open Hei 9-197397A. There is a description in a paper (Mori et al., Jpn. J. Appl. Phys., vol. 38 (1999) p. 2837).

<<Refractive Type Liquid Crystal Display Device>>

The optical film of the present invention is also advantageously used as a phase difference film in reflective type liquid crystal display devices of a TN type, a STN type, a HAN type, and a GH (Guest-Host) type. These display modes have long been known. The TN type reflective liquid crystal display devices are described in Japanese Patent Application No. Hei 10-123478, the pamphlet of International Publication No. 98/48320, and Japanese Patent No. 3022477. A phase difference film used in the reflective type liquid crystal display device is described in International Publication No. 00/65384.

(Other Liquid Crystal Display Devices)

The optical film of the present invention is also advantageously used as a support of a phase difference film in ASM (axially symmetric aligned microcell) type liquid crystal display devices having an ASM mode liquid crystal cell. An ASM mode liquid crystal cell is characterized in that the cell thickness is maintained by a resin spacer whose position is adjustable. Other properties are the same as those of a TN mode liquid crystal cell. With respect to the ASM mode liquid crystal cell and the ASM type liquid crystal display device, there is a description in a paper (Kume et al., SID 98 Digest, p. 1089 (1998)).

The optical film of the present invention may also be used as a phase difference film or a support of the phase difference film which is preferably used in an image display panel which may display 3D images Specifically, a λ/4 layer may be formed on the entire surface of the optical film of the present invention or, for example, a patterned phase difference layer having different birefringence refractive index alternately in a line type may be formed. The optical film of the present invention has a smaller dimensional change ratio to a change in humidity than that of the cellulose acylate film in the related art, and thus the optical film may be preferably used in the latter.

(Hardcoat Film, Antiglare Film and Antireflective Film)

The optical film of the present invention is applicable to a hardcoat film, an antiglare film or an antireflective film. Any one or all of a hardcoat layer, an antiglare layer, and an antireflective layer may be provided on one side or both sides of the optical film of the present invention for the purpose of improving visibility of flat panel displays, such as LCDs, PDPs, CRTs, ELs, and the like. Preferred embodiments of such applications as an antiglare film and an antireflective film are described in detail in Japan Institute of Invention and Innovation Journal of Technical Disclosure (Technical Publication No. 2001-1745, Mar. 15, 2001, published by Japan Institute of Invention and Innovation) pp 54 to 57, and the optical film of the present invention may be preferably used.

(Transparent Substrate)

Because the optical film of the present invention may be formed with an optical anisotropy close to zero, has excellent transparency and experiences a small change in retardation even though the film is maintained under a moist heat environment, the optical film may also be used as a substitute for a liquid crystal cell glass substrate of a liquid crystal display device, that is, a transparent substrate for sealing a driving liquid crystal.

The transparent substrate for sealing a liquid crystal is required to have excellent gas barrier properties, and thus a gas barrier layer may be provided on the surface of the optical film of the present invention if necessary. The form or material of the gas barrier layer is not particularly limited, but methods of vapor depositing SiO₂ or the like on at least one side of the optical film of the present invention, or providing a coat layer of a polymer having relatively high gas barrier properties, such as vinylidene chloride-based polymer or vinyl alcohol-based polymer, or stacking these inorganic and organic layers are contemplated, and the methods may be appropriately used.

For use as a transparent substrate for sealing a liquid crystal, a transparent electrode for driving a liquid crystal by application of a voltage may be provided. The transparent electrode is not particularly limited, but a transparent electrode may be provided by stacking a metal film, a metal oxide film, and the like on at least one side of the optical film of the invention. Among them, from the viewpoint of transparency, electrical conductivity, and mechanical properties, metal oxide films are preferred, and among the metal oxide films, a thin film of indium oxide containing mainly tin oxide and zinc oxide in an amount of 2% to 15% may be preferably used. The details of these technologies are disclosed in, for example, Japanese Patent Application Laid-Open Nos. 2001-125079, 2000-227603, and the like.

### Example

Hereinafter, characteristics of the present invention will be described in more detail with reference to Examples. The materials, amounts, ratios, operations, order of operations, and the like shown in Examples below may appropriately be modified without departing from the spirit of the present invention. Therefore, the scope of the present invention should not be construed as being limited by specific Examples shown below.

<<Measurement Methods>>

First, measurement methods and evaluation methods of characteristics are shown below.

[Degree of Substitution]

The degree of substitution of acyl of a cellulose acylate was obtained by ¹³C-NMR analysis in accordance with the methods described in Tezuka et al., Carbohydr. Res., 273 (1995), pp. 83 to 91.

[Residual Solvent Amount]

The residual solvent amount of the web (film) of the present invention was calculated based on the following equation.

Residual solvent amount(% by mass)={(M−N)/N}×100

[where M represents the mass of the web (film), and N represents the mass when the web (film) is dried at 110° C. for 3 hr.]

[Content of Additives on Surface (Cs)]

Among the methods described above, measurements were performed by a method using a Fourier transform IR spectrophotometer equipped with an ATR prism.

[Surface Roughness (Ra)]

Measurements were performed by the method as described above.

[Surface Hardness]

Measurements were performed by the method as described above.

[Retardation]

Five points (a central portion, edge portions (positions at 5% of each of the total width from both ends), and 2 points at the intermediate portions of the central portion and the edge portions of a film) in a width direction of the film were sampled for every 100 m in a longitudinal direction, samples having a size of 5 cm×5 cm were cut, an average value at each point, which was evaluated by the above-described method was calculated to obtain each of Re, Rth, ΔRe and ΔRth.

[Haze]

Thirty points (positions were divided into thirty points at an equal spacing of 30 mm of each point from both edge portions of a film) in a width direction of the film were sampled for every 100 m in a longitudinal direction, samples having a size of 4 cm×4 cm were drawn, and an average value measured by using a haze meter (NDH2000: manufactured by Nippon Denshoku Industries Co., Ltd.) was taken as a haze to use (maximum value−minimum value) as a haze distribution.

[Photoelastic Coefficient]

A sample measuring 1 cm×5 cm was cut out of an optical film manufactured, the in-plane retardation value of the film was determined while applying a stress to the sample at 25° C. using a spectroscopic ellipsometer (M-220, manufactured by JASCO Corporation), and thus the photoelastic coefficient was calculated from the retardation value and the slope of a function of the stress.

[Elastic Modulus]

A sample having a size of 150 mm×10 mm was cut off from the obtained optical film, and the stress at 0.1% elongation and the stress at 0.5% elongation were measured at a tension rate of 10%/min at an atmosphere of 25° C. and 60% RH by using a universal tensile tester STM T50BP manufactured by Toyo Baldwin Co., Ltd. to calculate the elastic modulus from the slope. Incidentally, measurements were carried out in arbitrary two directions being perpendicular to each other and their geometric means are shown in Table 2.

[Water Content]

A sample measuring 7 mm×35 mm was cut out of an optical film manufactured and humidity-controlled at 25° C. and 60% RH for 24 hr, and then the water content was measured by using a moisture meter “CA-03” and a sample drying device “VA-05” {both manufactured by Mitsubishi Chemical Corporation} in accordance with the Karl-Fischer's method.

[Degree of Polarization]

Transmissivity Tp when absorption axes are superimposed in parallel and transmissivity Tc′ when absorption axes are superimposed orthogonal to each other, from two polarizing plates manufactured, were measured, and thus the degree of polarization P was calculated from the following equation.

Degree of Polarization P=((Tp−Tc′)/(Tp+Tc′))^{0.5}

<<1>> Manufacture and Evaluation of Optical Film

The optical film of the present invention was manufactured by selecting the material and manufacturing method described in Table 1 from the following materials and manufacturing methods.

(Preparation of Polymer Solution)

1] Cellulose Acylate

The following cellulose acylate A was used. Each cellulose acylate was dried by heating at 120° C. to make the water content to 0.5% by mass or less, and then was used in an amount of 20 parts by mass.
Cellulose Acylate A:

A powder of cellulose acetate having a degree of substitution of 2.86 was used. Of the cellulose acylate A, the viscosity average degree of polymerization was 300, the degree of substitution of an acetyl group at 6-position was 0.89, the acetone extract was 7% by mass, the ratio of mass average molecular mass/number average molecular mass was 2.3, the water content was 0.2% by mass, the viscosity in 6% by mass of a dichloromethane solution was 305 mPa, the residual acetic acid content was 0.1% by mass or less, the Ca content was 65 ppm, the Mg content was 26 ppm, the Fe content was 0.8 ppm, the sulfate ion content was 18 ppm, the yellow index was 1.9, and the free acetic acid content was 47 ppm. The average particle size of the powder was 1.5 mm and the standard deviation was 0.5 mm.

2] Solvent

The following solvent A was used. Each solvent has a water content of 0.2% by mass or less.

Solvent A dichloromethane/methanol/butanol=81/18/1 (mass ratio)

3] Additives

Additives described in Table 1 were selected from the group of the following additives. With respect to films 30 to 32, the following additive M1 was also used in dopes for a support surface and an air surface, and with respect to the other films the additive M2 was used. However, in Table 1, the “amount” of each additive was given in % by mass based on 100% by mass of the cellulose acylate. Incidentally, the wax component in the film was adjusted by using as, a raw material, cellulose acylate having different content of the wax component.

(Compounds Having Repeating Units)

A-1: Condensate of ethanediol/adipic acid (1/1 molar ratio), both terminals of which are acetic acid ester, number average molecular mass 1000, and the value of a hydroxyl group 0 mgKOH/g

A-2: Condensate of ethanediol/adipic acid (1/1 molar ratio), number average molecular mass 1000, and the value of a hydroxyl group 112 mgKOH/g

A-3: Condensate of ethanediol/1,2-propanediol/adipic acid (3/1/4 molar ratio), both terminals of which are acetic acid ester, number average molecular mass 1000, and the value of a hydroxyl group 0 mgKOH/g

A-4: Condensate of ethanediol/1,2-propanediol/adipic acid/terephthalic acid (1/1/1/1 molar ratio), both terminals of which are acetic acid ester, number average molecular mass 1200, and the value of a hydroxyl group 0 mgKOH/g

A-5: Condensate of ethanediol/1,2-propanediol/adipic acid (7/3/10 molar ratio), both terminals of which are acetic acid ester, number average molecular mass 1000, and the value of a hydroxyl group 0 mgKOH/g

[Other Additives]

L: Compound having the following structure

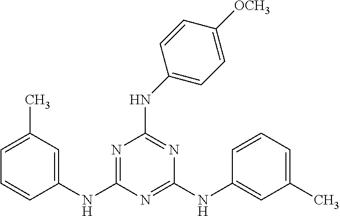

D: Compound having the following structure

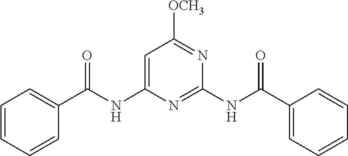

M1: Silicon dioxide fine particle (particle size 20 nm, Moh's hardness about 7) (0.02 parts by mass)

M2: Silicon dioxide fine particle (particle size 20 nm, Moh's hardness about 7) (0.15 parts by mass)

4] Dissolution

The solvent and the additives were introduced into a 400 L stainless steel dissolver tank equipped with a stirring blade and the cellulose acylate was slowly added thereto while the mixture in the tank was dispersed by stirring. After completion of the introduction, the mixture was stirred at room temperature for 2 hr, swollen for 3 hours, and again stirred to obtain a cellulose acylate solution.

For the stirring, a dissolver-type eccentric stirring shaft stirring at a circumferential speed of 5 msec (shear stress 5×10⁴ kgf/m/sec² [4.9×10⁵ N/m/sec²]) and a stirring shaft with an anchor blade was mounted on the central axis thereof, stirring at a circumferential speed of 1 m/sec (shear stress 1×10⁴ kgf/m/sec² [9.8×10⁴ N/m/sec²]), were used. The swelling was carried out by stopping the high-speed stirring shaft and setting the circumferential speed of the stirring shaft having the anchor blade to 0.5 m/sec.

The swollen solution from the tank was then heated to 50° C. through a jacketed pipe and then heated up to 90° C. under a pressure of 1.2 MPa to achieve complete dissolution. The heating time was 15 minutes. In this case, the filter, housing, and piping to be exposed to the high temperature were made of a highly anti-corrosive Hastelloy alloy (registered trademark) and jacketed for circulating a heating medium for heat insulation and heating.

Subsequently, the solution was then cooled to 36° C. to obtain a cellulose acylate solution.

The dope thus obtained prior to concentration was flashed in a tank at a normal pressure at 80° C., and the evaporated solvent was recovered and separated with a condenser. The solid concentration of the dope after the flash was 24.8% by mass. Meanwhile, the condensed solvent was returned to the recovering process so as to be reused as a solvent for the preparation process (the recovery is performed by the distillation process, dehydration process, and the like). The dope was defoamed in the flash tank by rotating the shaft equipped with an anchor blade on the central shaft at a circumferential speed of 0.5 m/sec to stir the dope. The temperature of the dope in the tank was 25° C., and the average retention time in the tank was 50 min.

5] Filtration

Subsequently, the dope was first passed through a sintered woven metal filter having a nominal pore diameter of 10 μm and then through a sintered woven metal filter having a nominal pore diameter of 10 μm in the same manner. The dope was stored in a 2000 L stainless steel stock tank while the temperature of the dope after the filtration was adjusted to 36° C.

(Manufacture of Film)

1] Casting Process

Subsequently, the dope in the stock tank was transferred. The casting die was equipped with a feed block having a width of 2.1 m and which is adjusted for co-casting, and used a device for allowing films to be stacked to form a structure of three layers on both sides thereof in addition to the main stream. In the following explanation, a layer to be formed from the main stream refers to an intermediate layer, a layer on the side of a support surface refers to a support surface, and the opposite surface refers to an air surface. Meanwhile, the solution sending flow channels of the dope use three flow channels for an intermediate layer, a support surface, and an air surface, and each solid concentration was appropriately controlled by adding a solvent to decrease the concentration or by adding a solution having a high solid concentration to increase the concentration.

The casting was performed by controlling the dope flow rate at the die exit point to have a casting width of 2000 mm. In order to control the temperature of the dope to 36° C., a jacket was provided on the casting die to control the temperature of a heat transmitting medium for being supplied to the jacket at the inlet to 36° C.

The die, the feed block and the pipe were all kept at 36° C. during the work process.

2) Casting Die

A material for the die is a two-phase stainless steel having a mixed composition of an austenite phase and a ferrite phase and has a thermal expansion coefficient of 2×10⁻⁶ (° C.⁻¹), and a material having corrosion resistance approximately equivalent to that of SUS 316 when evaluated by a forced corrosion test in an electrolytic aqueous solution was used. As a lip tip of the casting die, a lip tip on which a WC coating is formed by a flame spraying method was used. A mixed solvent (dichloromethane/methanol/butanol (83/15/2 parts by mass)) which is a solvent for solubilizing the dope is supplied to air-liquid interfaces of the bead end and the slit at 0.5 ml/min on one side.

3) Metal Support

As the support, a mirror surface stainless steel support which is a drum having a width of 2.1 m and a diameter of 3 m was used for the dope extruded from the die. Nickel casting and hard chromium plating were performed on the surface thereof. The drum was polished to a surface roughness of 0.01 μm or less, no pin holes of 50 μm or more existed, and a support with pinholes of 10 μm to 50 μm at 1 ea/m² or less and pin holes of 10 μm or less at 2 ea/m² was used. At that time, the temperature of the drum was set to −5° C., and the number of rotations of the drum was set to have a circumferential speed of 50 m/min of the drum. Meanwhile, when the surface of the drum was contaminated by the casting, cleaning was appropriately performed.

4) Casting Drying

Subsequently, the dope which was cast, cooled, and gelled on the drum disposed on the space set at 15° C. was peeled off as a gelled film (web) at a time point when the dope was rotated on the drum at 320°. At that time, the peel-off speed was set to 106% with respect to the support speed.

5) Tenter Conveying•Drying Process Conditions

The peeled-off web was conveyed into a drying zone by a tenter having pin clips while being fixed at both edges thereof, and dried with a drying wind.

6) Post Drying Process Conditions

The trimmed polymer film obtained by the above-described method was further dried in a roller conveying zone. A material of the roller was aluminum or carbon steel, and a surface thereof was plated with hard chromium. The surface of the roller was flat or matted by blasting.

7) Post-Treatment and Winding Conditions

The polymer film after being dried was cooled to 30° C. or less, and trimmed at both edges. The film was trimmed by installing every two devices for slitting each of both edge portions of the film in each of the film (two slitting devices on one side) and slitting the edge portions of the film. The film was knurled at both edges thereof. The knurling was performed by embossing the film on one side thereof. In this manner, a film having a width of 1400 mm as a final product was obtained and wound by a winding machine.

In this manner, a film having a width of 1,400 mm as a final product was obtained and wound by a winding machine. The winding chamber was kept at a room temperature of 25° C. and a humidity of 60%. The diameter of a winding core was set to 169 mm. A tension pattern was set at a winding start tension of 170 N/width and a winding end tension of 160 N/width, and a total length of winding was 2,600 m in a roll form. As to the 10th roll, evaluation of physical properties and examination of the external appearance were performed. The results are shown in Table 2. Furthermore, the roll was stored in a storage rack at 25° C. and a relative humidity of 55% for one month, and the same examination and haze evaluation were performed. The results are shown in Table 2.

(Roll External Appearance)

The roll external appearance was examined and evaluated in accordance with the following standard.

A: No loose winding or wrinkling

B: Slightly loose winding, adhesion or wrinkling was confirmed at edge portions, but practically no problem

C: Slightly loose winding, adhesion or wrinkling was confirmed, but practically no problem

D: Loose winding, adhesion or wrinkling was so severe that the film was not applicable to the optical film

Meanwhile, after the film was formed, no peeled-off residues of the casting film formed as a dope were observed on the drum which was a metal support.

(Manufacture 2 of Film)

Incidentally, films having a film thickness of 15 μm or less (Films Nos. 18, 27, 28, 29, 37, and 39) and films having a film thickness of 20 μm or less and having a Ct of 50 phr or more (Films Nos. 32 and 39) were manufactured by in the above section of (Preparation of polymer solution), filtering the dope before concentration of the dissolution process 4] according to the above filtration process 5] and subjecting the obtained dope to film formation in the following process.

1) Casting Process

As to the obtained dope, dopes for uses of interlayer, support surface and air surface were sent to a casting die capable of achieving co-casting and having a width of 1 m, respectively, and the dope of a three-layer constitution was extruded from the casting die and cast on, as a support, a glass plate set at 15° C. Then, dry air at 45° C. was blown, and after 4 minutes, the resulting dope was stripped off from the support and fixed on a metal frame. The resultant was dried at 100° C. for 5 minutes and further at 140° C. for 10 minutes, and then cooled to room temperature to obtain a film of a three-layer constitution. This process was repeated, and the 100th film was used for the evaluation. Subsequently, the same process was repeated, and the thus obtained 101st to 105th films were laminated. The laminate was sandwiched by SUS304 plates each having a mirror-finished surface and then stored in the environment at 25° C. and a relative humidity of 55%. One month later, among the stored laminated films, the obtained 103rd film was taken out and subjected to the same examination and haze evaluation. The results are shown in Table 2.

Incidentally, in a film manufactured in the same manner as in Film 1 except for replacing the cellulose acylate of Film 1 with a cellulose acylate having content of the wax component of 0.001 ppm, small unevenness in thickness, extending in a direction perpendicular to a conveying direction of the film, was generated. Also, in a film manufactured in the same manner as in Film 1 except for replacing the cellulose acylate of Film with a cellulose acylate to which a methyl stearate was added so as to be content of the wax component of 1000 ppm, haze was increased to 4.3%.

<<2>> Manufacture and Evaluation of Polarizing Plate

(Manufacture of Polarizing Plate)

1] Saponification of Film

Each of the films prepared in Examples and Comparative Examples and Fuji Tack TD60UL (manufactured by Fuji Film Corporation) was immersed in a 4.5 mol/L sodium hydroxide aqueous solution (saponification liquid) which was temperature-controlled at 37° C. for 1 min, and then the film was washed with water, immersed in a 0.05 mol/L sulfuric acid aqueous solution for 30 sec, and again passed through a washing bath. And then, water removal was performed three times with an air knife after water was dropped and dried in a drying zone at 70° C. for a retention time of 15 sec to manufacture a saponified film.

2] Manufacture of Polarizing Plate

A 20 μm thick polarization film was prepared by imparting the difference in circumferential speed to two pairs of nip rolls and stretching the rolls in a longitudinal direction in accordance with Example 1 of Japanese Patent Application Laid-Open No. 2001-141926.

3] Lamination

The thus-obtained polarization film was interposed in between two sheets selected from the saponified films, and then the films were laminated roll-to-roll via a 3% polyvinyl alcohol (manufactured by Kuraray Co., Ltd., PVA-117H) aqueous solution as an adhesion bond such that the axis of polarization and the longitudinal direction of the films are orthogonal to each other, thereby making a polarizing plate. Here, as a film on one side of the polarization film, a film obtained by saponifying one selected from the group of films described in Table 1 was employed and as a film on the other side, a film obtained by saponifying the Fuji Tack TD60UL was employed.

(Evaluation of Polarizing Plate)

1] Initial Degree of Polarization

The degree of polarization of the polarizing plate was calculated by the method previously described, and thus, all the polarizing plates were found to have a degree of polarization of 99.9%.

2] Degree of Polarization with Time

The polarizing plate was laminated to a glass plate on the side of the film described in Table 1 (which was manufactured in the examples and comparative examples) with an adhesive and allowed to stand at conditions of 60° C. and 90% RH for 500 hr. Thereafter, the degree of polarization after being left (the degree of polarization with time) was calculated by the above-described method, and as a result, all the polarizing plates were found to have a degree of polarization of 99.9%.

3] Evaluation of Mounting on Liquid Crystal Display Devices

(Mounting on IPS Type Liquid Crystal Display Devices)

A polarizing plate positioned at a back light side in a pair polarizing plate sandwiching crystal cells was peeled off from a commercially available liquid crystal display television set (slim type 42 type liquid crystal display TV set of IPS mode), and the polarizing plates manufactured above was re-laminated to the liquid crystal cells with an adhesive such that the film side described in Table 1 is disposed on the liquid crystal cell side. Display characteristics of the re-assembled liquid crystal display television set were confirmed and the luminance intensity and tint from the front and the inclined surface were confirmed, and as a result, characteristics equivalent to those before the polarizing plate was peeled off were observed. When the characteristics were observed from the front of the device, the luminance intensity unevenness was observed even in a black display, and then evaluation was performed in accordance with the following standards (initial evaluation). The evaluation results are shown in Table 2.

(Levels of Light Unevenness from Front Direction)

When the characteristics were observed from the front of the device, the luminance intensity unevenness was observed in a black display, and then evaluation was performed in accordance with the following standards.

A: No unevenness was visible under an environment of an illumination intensity of 100 lx

B: Unevenness was rarely visible under an environment of an illumination intensity of 100 lx

C: Dim unevenness was visible under an environment of an illumination intensity of 100 lx

D: Apparent unevenness was visible under an environment of an illumination intensity of 100 lx

E: Apparent unevenness was visible under an environment of an illumination intensity of 300 lx.

The sample was kept under an environment of 50° C. and 85% RH for 10 days, and then transferred to an environment of 25° C. and 60% RH. Illumination was continuously maintained in a black display state. The sample was observed with bare eyes after 48 hr to evaluate the light unevenness (forced evaluation). The evaluation results are shown in Table 2.

(Levels of Light Unevenness from Front Direction)

When the characteristics were observed from the front of the device, the luminance intensity unevenness was observed in a black display, and then evaluation was performed in accordance with the following standards.

A: No unevenness was visible under an environment of an illumination intensity of 100 lx

B: Unevenness was rarely visible under an environment of an illumination intensity of 100 lx

C: Dim unevenness was visible under an environment of an illumination intensity of 100 lx.

D: Apparent unevenness was visible under an environment of an illumination intensity of 100 lx

E: Apparent unevenness was visible under an environment of an illumination intensity of 300 lx.

(Levels of Light Unevenness from Inclined Surface Direction)

The luminance intensity unevenness and tint unevenness were observed in a black display at an azimuth direction of 45° and a polar angle direction of 70° from the front of the device, and then evaluation was performed in accordance with the following standards.

A: No unevenness was visible under an environment of an illumination intensity of 100 lx

B: Unevenness was rarely visible under an environment of an illumination intensity of 100 lx

C: Dim unevenness was visible under an environment of an illumination intensity of 100 lx.

D: Apparent unevenness was visible under an environment of an illumination intensity of 100 lx

E: Apparent unevenness was visible under an environment of an illumination intensity of 300 lx

TABLE 1

| | Interlayer | | | | | | | | |
|---|---|---|---|---|---|---|---|---|---|
| | Compound having a repeating unit | | | | | | | Solids | |
| | | | | | Amount 1 + | Other additive | | content | Film |
| Film | | Amount 1 | | Amount 2 | Amount 2 | | Amount | d1 | thickness |
| No. | Kind 1 | [part] | Kind 2 | [part] | c1 [part] | Kind | [part] | [wt %] | [μm] |
| 1 | A-1 | 55 | — | — | 55 | L | 1.2 | 27.0 | 44 |
| 2 | A-1 | 53 | — | — | 53 | L | 1.2 | 27.0 | 44 |
| 3 | A-1 | 50 | — | — | 50 | L | 1.1 | 27.0 | 44 |
| 4 | A-1 | 59 | — | — | 59 | L | 1.3 | 27.0 | 44 |
| 5 | A-1 | 63 | — | — | 63 | L | 1.4 | 27.0 | 44 |
| 6 | A-1 | 68 | — | — | 68 | L | 1.6 | 27.0 | 44 |
| 7 | A-1 | 68 | — | — | 68 | L | 1.6 | 27.0 | 44 |
| 8 | A-1 | 65 | — | — | 65 | L | 1.8 | 27.5 | 44 |
| 9 | A-1 | 22 | — | — | 22 | — | — | 23.5 | 44 |
| 10 | A-1 | 32 | — | — | 32 | — | — | 24.0 | 44 |
| 11 | A-1 | 37 | — | — | 37 | — | — | 25.0 | 44 |
| 12 | A-1 | 55 | — | — | 55 | L | 1.1 | 27.0 | 44 |
| 13 | A-1 | 55 | A-4 | 1.8 | 56.8 | — | — | 27.0 | 44 |
| 14 | A-2 | 55 | — | — | 55 | L | 1.2 | 27.0 | 44 |
| 15 | A-2 | 16 | — | — | 16 | L | 1.2 | 23.5 | 44 |
| 16 | A-3 | 55 | — | — | 55 | L | 1.2 | 27.0 | 44 |
| 17 | A-5 | 6.5 | — | — | 6.5 | — | — | 23.5 | 34 |
| 18 | A-5 | 6.5 | — | — | 6.5 | — | — | 23.5 | 8 |
| 19 | A-5 | 20 | — | — | 20 | — | — | 23.5 | 26 |
| 20 | A-5 | 15 | — | — | 15 | — | — | 23.5 | 18 |
| 21 | A-5 | 25.5 | — | — | 25.5 | L | 0.1 | 23.5 | 16 |
| 22 | A-5 | 6.5 | — | — | 6.5 | — | — | 23.5 | 22 |
| 23 | A-5 | 15.3 | — | — | 15.3 | — | — | 23.5 | 54 |
| 24 | A-5 | 15.1 | — | — | 15.1 | — | — | 23.5 | 38 |
| 25 | A-5 | 20.1 | — | — | 20.1 | — | — | 23.5 | 38 |
| 26 | A-5 | 25.1 | — | — | 25.1 | L | 0.1 | 23.5 | 38 |
| 27 | A-5 | 10.8 | — | — | 10.8 | — | — | 23.5 | 2 |
| 28 | A-5 | 12 | — | — | 12 | — | — | 23.5 | 8.2 |
| 29 | A-5 | 11.3 | — | — | 11.3 | — | — | 23.5 | 13.5 |
| 30 | A-5 | 42 | — | — | 42 | L | 0.7 | 23.5 | 35.8 |
| 31 | A-5 | 52.5 | — | — | 52.5 | L | 1.1 | 23.5 | 62 |
| 32 | A-5 | 64.2 | — | — | 64.2 | L | 1.6 | 23.5 | 14.5 |
| 33 | A-5 | 7.3 | — | — | 7.3 | — | — | 23.5 | 49 |
| 34 | A-5 | 12.7 | — | — | 12.7 | — | — | 23.5 | 18.5 |
| 35 | A-5 | 25.9 | — | — | 25.9 | L | 0.1 | 23.5 | 55.5 |
| 36 | A-5 | 35.4 | — | — | 35.4 | L | 0.4 | 23.5 | 51 |
| 37 | A-5 | 47.6 | — | — | 47.6 | L | 0.9 | 23.5 | 9 |
| 38 | A-5 | 53.5 | — | — | 53.5 | L | 1.2 | 23.5 | 40.5 |
| 39 | A-5 | 50.5 | — | — | 50.5 | L | 1.1 | 23.5 | 9.2 |
| 40 | A-5 | 63.3 | — | — | 63.3 | L | 1.4 | 23.5 | 25 |
| 41 | A-5 | 15.9 | — | — | 15.9 | — | — | 23.5 | 39 |
| 42 | A-5 | 53.4 | — | — | 53.4 | L | 1.2 | 23.5 | 22.5 |
| 43 | A-5 | 20.1 | — | — | 20.1 | D | 0.6 | 23.5 | 38 |

| | Support surface | | | | | | | | | |
|---|---|---|---|---|---|---|---|---|---|---|
| | Compound having a repeating unit | | | | | | | Solids | | |
| | | | | | Amount 1 + | Other additive | | content | | Film |
| Film | | Amount 1 | | Amount 2 | Amount 2 | | Amount | d2(1) | ΔC | thickness |
| No. | Kind 1 | [part] | Kind 2 | [part] | c2(1) [part] | Kind | [part] | [wt %] | [part] | [μm] |
| 1 | A-1 | 20 | — | — | 20 | — | — | 20 | 35 | 3 |
| 2 | A-1 | 30 | — | — | 30 | — | — | 20 | 23 | 3 |
| 3 | A-1 | 49 | — | — | 49 | — | — | 20 | 1 | 3 |
| 4 | A-1 | 20 | — | — | 20 | — | — | 20 | 39 | 6 |
| 5 | A-1 | 20 | — | — | 20 | — | — | 20 | 43 | 9 |
| 6 | A-1 | 20 | — | — | 20 | — | — | 20 | 48 | 9 |
| 7 | A-1 | 20 | — | — | 20 | — | — | 18 | 48 | 9 |
| 8 | A-1 | 30 | — | — | 30 | — | — | 20 | 35 | 3 |
| 9 | A-1 | 10 | — | — | 10 | — | — | 20 | 12 | 3 |
| 10 | A-1 | 15 | — | — | 15 | — | — | 20 | 17 | 3 |
| 11 | A-1 | 30 | — | — | 30 | — | — | 20 | 7 | 3 |
| 12 | A-1 | 20 | — | — | 20 | — | — | 20 | 35 | 3 |
| 13 | A-1 | 20 | — | — | 20 | — | — | 20 | 37 | 3 |
| 14 | A-1 | 20 | — | — | 20 | — | — | 20 | 35 | 3 |
| 15 | A-1 | 10 | — | — | 10 | — | — | 20 | 6 | 3 |
| 16 | A-1 | 20 | — | — | 20 | — | — | 20 | 35 | 3 |
| 17 | A-4 | 6.5 | — | — | 6.5 | — | — | 20 | 0 | 3 |
| 18 | A-4 | 6.5 | — | — | 6.5 | — | — | 20 | 0 | 1 |
| 19 | A-4 | 20 | — | — | 20 | — | — | 20 | 0 | 2 |
| 20 | A-4 | 15 | — | — | 15 | — | — | 20 | 0 | 1 |
| 21 | A-4 | 23 | — | — | 23 | — | — | 20 | 3 | 4 |
| 22 | A-4 | 6.5 | — | — | 6.5 | — | — | 20 | 0 | 1.5 |
| 23 | A-4 | 10 | — | — | 10 | — | — | 20 | 5 | 3 |
| 24 | A-4 | 10 | — | — | 10 | — | — | 20 | 5 | 1 |
| 25 | A-4 | 15 | — | — | 15 | — | — | 20 | 5 | 1 |
| 26 | A-4 | 20 | — | — | 20 | — | — | 20 | 5 | 1 |
| 27 | A-4 | 7 | — | — | 7 | — | — | 20 | 4 | 2 |
| 28 | A-4 | 6.5 | — | — | 6.5 | — | — | 20 | 6 | 0.8 |
| 29 | A-4 | 8 | — | — | 8 | — | — | 20 | 3 | 1 |
| 30 | A-4 | 25 | — | — | 25 | — | — | 20 | 17 | 2.5 |
| 31 | A-4 | 33 | — | — | 33 | — | — | 20 | 20 | 5 |
| 32 | A-4 | 50 | — | — | 50 | — | — | 20 | 14 | 3 |
| 33 | A-4 | 3 | — | — | 3 | — | — | 20 | 4 | 7 |
| 34 | A-4 | 10 | — | — | 10 | — | — | 20 | 3 | 4 |
| 35 | A-4 | 15 | — | — | 15 | — | — | 20 | 11 | 2.5 |
| 36 | A-4 | 6 | — | — | 6 | — | — | 20 | 29 | 5 |
| 37 | A-4 | 10 | — | — | 10 | — | — | 20 | 38 | 1.7 |
| 38 | A-4 | 10 | — | — | 10 | — | — | 20 | 43 | 10 |
| 39 | A-4 | 45 | — | — | 45 | — | — | 20 | 5 | 0.5 |
| 40 | A-4 | 6.5 | — | — | 6.5 | — | — | 20 | 57 | 3.5 |
| 41 | A-4 | 0 | | | 0 | | | 20 | 16 | 6 |
| 42 | A-4 | 25 | — | — | 25 | — | — | 20 | 28 | 1.5 |
| 43 | A-4 | 15 | — | — | 15 | — | — | 20 | 5 | 1 |
| | Air surface | | | | | | | | | |
| | Compound having a repeating unit | | | | | | | Solids | | |
| | | | | | Amount 1 + | Other additive | | content | | Film |
| Film | | Amount 1 | | Amount 2 | Amount 2 | | Amount | d2(2) | ΔC | thickness |
| No. | Kind 1 | [part] | Kind 2 | [part] | c2(2) [part] | Kind | [part] | [wt %] | [part] | [μm] |
| 1 | A-1 | 20 | — | — | 20 | — | — | 20 | 35 | 3 |
| 2 | A-1 | 30 | — | — | 30 | — | — | 20 | 23 | 3 |
| 3 | A-1 | 49 | — | — | 49 | — | — | 20 | 1 | 3 |
| 4 | A-1 | 20 | — | — | 20 | — | — | 20 | 39 | 3 |
| 5 | A-1 | 20 | — | — | 20 | — | — | 20 | 43 | 3 |
| 6 | A-1 | 20 | — | — | 20 | — | — | 20 | 48 | 6 |
| 7 | A-1 | 20 | — | — | 20 | — | — | 18 | 48 | 6 |
| 8 | A-1 | 30 | — | — | 30 | — | — | 20 | 35 | 3 |
| 9 | A-1 | 10 | — | — | 10 | — | — | 20 | 12 | 3 |
| 10 | A-1 | 15 | — | — | 15 | — | — | 20 | 17 | 3 |
| 11 | A-1 | 30 | — | — | 30 | — | — | 20 | 7 | 3 |
| 12 | A-1 | 20 | — | — | 20 | — | — | 20 | 35 | 3 |
| 13 | A-1 | 20 | — | — | 20 | — | — | 20 | 37 | 3 |
| 14 | A-1 | 20 | — | — | 20 | — | — | 20 | 35 | 3 |
| 15 | A-1 | 10 | — | — | 10 | — | — | 20 | 6 | 3 |
| 16 | A-1 | 20 | — | — | 20 | — | — | 20 | 35 | 3 |
| 17 | A-4 | 6.5 | — | — | 6.5 | — | — | 20 | 0 | 3 |
| 18 | A-4 | 6.5 | — | — | 6.5 | — | — | 20 | 0 | 1 |
| 19 | A-4 | 20 | — | — | 20 | — | — | 20 | 0 | 2 |
| 20 | A-4 | 15 | — | — | 15 | — | — | 20 | 0 | 1 |
| 21 | A-4 | 25.5 | — | — | 25.5 | — | — | 20 | 0 | 0 |
| 22 | A-4 | 6.5 | — | — | 6.5 | — | — | 20 | 0 | 1.5 |
| 23 | A-4 | 15.3 | — | — | 15.3 | — | — | 20 | 0 | 3 |
| 24 | A-4 | 15.1 | — | — | 15.1 | — | — | 20 | 0 | 1 |
| 25 | A-4 | 20.1 | — | — | 20.1 | — | — | 20 | 0 | 1 |
| 26 | A-4 | 25.1 | — | — | 25.1 | — | — | 20 | 0 | 1 |
| 27 | A-4 | 7 | — | — | 7 | — | — | 20 | 4 | 1 |
| 28 | A-4 | 6.5 | — | — | 6.5 | — | — | 20 | 6 | 1 |
| 29 | A-4 | 8 | — | — | 8 | — | — | 20 | 3 | 0.5 |
| 30 | A-4 | 25 | — | — | 25 | — | — | 20 | 17 | 1.7 |
| 31 | A-4 | 33 | — | — | 33 | — | — | 20 | 20 | 3 |
| 32 | A-4 | 50 | — | — | 50 | — | — | 20 | 14 | 2.5 |
| 33 | A-4 | 3 | — | — | 3 | — | — | 20 | 4 | 4 |
| 34 | A-4 | 10 | — | — | 10 | — | — | 20 | 3 | 2.5 |
| 35 | A-4 | 15 | — | — | 15 | — | — | 20 | 11 | 2 |
| 36 | A-4 | 6 | — | — | 6 | — | — | 20 | 29 | 4 |
| 37 | A-4 | 10 | — | — | 10 | — | — | 20 | 38 | 1.3 |
| 38 | A-4 | 10 | — | — | 10 | — | — | 20 | 43 | 9.5 |
| 39 | A-4 | 45 | — | — | 45 | — | — | 20 | 5 | 0.3 |
| 40 | A-4 | 6.5 | — | — | 6.5 | — | — | 20 | 57 | 1.5 |
| 41 | A-4 | 0 | | | 0 | | | 20 | 16 | 5 |
| 42 | A-4 | 25 | — | — | 25 | — | — | 20 | 28 | 1 |
| 43 | A-4 | 20.1 | — | — | 20.1 | — | — | 20 | 0 | 1 |

| | Total sum of film | | | |
|---|---|---|---|---|
| | Compound having a | | Other | |
| | repeating unit | | additive | |
| Film | Amount 1 | Amount 2 | Amount | |
| No. | [part] | [part] | [part] | Remark |
| 1 | 50 | — | 1.0 | Invention |
| 2 | 50 | — | 1.0 | Invention |
| 3 | 50 | — | 1.0 | Comparison |
| 4 | 51 | — | 1.0 | Invention |
| 5 | 51 | — | 1.0 | Invention |
| 6 | 52 | — | 1.1 | Invention |
| 7 | 52 | — | 1.1 | Invention |
| 8 | 60 | — | 1.5 | Invention |
| 9 | 20 | — | — | Invention |
| 10 | 30 | — | — | Invention |
| 11 | 36 | — | — | Invention |
| 12 | 50 | — | 0.9 | Invention |
| 13 | 50 | 1.5 | — | Invention |
| 14 | 50 | — | 1.0 | Invention |
| 15 | 15 | — | 1.0 | Comparison |
| 16 | 50 | — | 1.0 | Invention |
| 17 | 6.5 | — | — | Comparison |
| 18 | 6.5 | — | — | Comparison |
| 19 | 20 | — | — | Comparison |
| 20 | 15 | — | — | Comparison |
| 21 | 25 | — | 0.1 | Comparison |
| 22 | 6.5 | — | — | Comparison |
| 23 | 15 | — | — | Comparison |
| 24 | 15 | — | — | Invention |
| 25 | 20 | — | — | Invention |
| 26 | 25 | | 0.1 | Comparison |
| 27 | 8.5 | — | — | Invention |
| 28 | 11 | — | — | Invention |
| 29 | 11 | — | — | Invention |
| 30 | 40 | — | 0.6 | Invention |
| 31 | 50 | — | 1.0 | Invention |
| 32 | 60 | — | 1.1 | Comparison |
| 33 | 6.5 | — | — | Comparison |
| 34 | 12 | — | — | Invention |
| 35 | 25 | — | 0.1 | Invention |
| 36 | 30 | — | 0.3 | Invention |
| 37 | 36 | — | 0.6 | Invention |
| 38 | 36 | — | 0.7 | Invention |
| 39 | 50 | — | 1.0 | Comparison |
| 40 | 50 | — | 1.1 | Invention |
| 41 | 12 | — | — | Comparison |
| 42 | 50 | — | 1.1 | Comparison |
| 43 | 20 | — | 0.6 | Invention |

TABLE 2

| | Compound having | | | | | | | | | | | |
|---|---|---|---|---|---|---|---|---|---|---|---|---|
| | a repeating unit | | | | | | | | | | | |
| | Surface (Cs) | | Total | | | Equation (1) | | | Support surface | | Air surface | |
| | Support | Air | | Total | Wax | | 0.1 × | | Surface | | Surface | |
| Film | surface | surface | Ct | ΔC | Component | | (Ct/ | Equation | roughness | Hardness | roughness | Hardness |
| No. | [part] | [part] | [part] | [part] | [part] | \|ΔC/Ct\| | d − 0.3) | (2) Ct/d | Ra [nm] | [N/mm²] | Ra [nm] | [N/mm²] |
| 1 | 43 | 46 | 50 | 7 | 21 | 0.14 | 0.07 | 1.000 | 6.8 | 55 | 7.2 | 55 |
| 2 | 46 | 44 | 50 | 6 | 25 | 0.12 | 0.07 | 1.000 | 10.6 | 51 | 7.8 | 51 |
| 3 | 48 | 49 | 50 | 2 | 46 | 0.04 | 0.07 | 1.000 | 15.1 | 44 | 8.1 | 44 |
| 4 | 38 | 45 | 51 | 13 | 47 | 0.25 | 0.07 | 0.962 | 6.9 | 77 | 7.1 | 45 |
| 5 | 31 | 49 | 51 | 20 | 75 | 0.39 | 0.06 | 0.911 | 6.0 | 98 | 7.7 | 35 |
| 6 | 31 | 41 | 52 | 21 | 36 | 0.40 | 0.06 | 0.881 | 7.7 | 93 | 6.8 | 63 |
| 7 | 35 | 42 | 52 | 17 | 40 | 0.33 | 0.06 | 0.881 | 6.9 | 93 | 6.4 | 63 |
| 8 | 54 | 56 | 60 | 6 | 48 | 0.10 | 0.09 | 1.200 | 10.3 | 20 | 8.8 | 20 |
| 9 | 19 | 19 | 20 | 1 | 90 | 0.05 | 0.01 | 0.400 | 11.9 | 148 | 5.1 | 148 |
| 10 | 26 | 27 | 30 | 4 | 90 | 0.13 | 0.03 | 0.600 | 15.3 | 118 | 6.2 | 118 |
| 11 | 34 | 33 | 36 | 3 | 95 | 0.08 | 0.04 | 0.720 | 7.2 | 93 | 6.9 | 93 |
| 12 | 45 | 42 | 50 | 8 | 42 | 0.16 | 0.07 | 1.000 | 7.8 | 55 | 7.3 | 55 |
| 13 | 44 | 46 | 51.5 | 7.5 | 54 | 0.15 | 0.07 | 1.030 | 11.4 | 55 | 6.9 | 55 |
| 14 | 43 | 46 | 50 | 7 | 25 | 0.14 | 0.07 | 1.000 | 11.6 | 55 | 7.9 | 55 |
| 15 | 15 | 14 | 15 | 1 | 53 | 0.07 | 0.00 | 0.300 | 6.0 | 164 | 4.1 | 164 |
| 16 | 44 | 45 | 50 | 6 | 78 | 0.12 | 0.07 | 1.000 | 6.6 | 55 | 8.2 | 55 |
| 17 | 6.5 | 6.5 | 6.5 | 0 | 67 | 0.00 | −0.01 | 0.163 | 5.1 | 192 | 4.7 | 191 |
| 18 | 6.5 | 6.5 | 6.5 | 0 | 25 | 0.00 | 0.04 | 0.650 | 24.5 | 192 | 3.4 | 194 |
| 19 | 20 | 20 | 20 | 0 | 103 | 0.00 | 0.04 | 0.667 | 28.9 | 144 | 5.6 | 147 |
| 20 | 15 | 15 | 15 | 0 | 29 | 0.00 | 0.05 | 0.750 | 26.9 | 165 | 5.2 | 166 |
| 21 | 24 | 25 | 25 | 1 | 39 | 0.04 | 0.10 | 1.250 | 25.3 | 134 | 5.1 | 132 |
| 22 | 6.5 | 6.5 | 6.5 | 0 | 33 | 0.00 | 0.00 | 0.260 | 6.4 | 195 | 4.2 | 191 |
| 23 | 14 | 15 | 15 | 1 | 44 | 0.07 | −0.01 | 0.250 | 5.1 | 169 | 5.4 | 161 |
| 24 | 14.5 | 15 | 15 | 0.5 | 57 | 0.03 | 0.01 | 0.375 | 5.9 | 166 | 5.2 | 161 |
| 25 | 19.5 | 20 | 20 | 0.5 | 52 | 0.03 | 0.02 | 0.500 | 6.5 | 150 | 4.7 | 147 |
| 26 | 24.5 | 25 | 25 | 0.5 | 26 | 0.02 | 0.03 | 0.625 | 8.2 | 131 | 6.1 | 125 |
| 27 | 7 | 8 | 8.5 | 1.5 | 96 | 0.18 | 0.14 | 1.700 | 8.0 | 193 | 4.5 | 187 |
| 28 | 10 | 10 | 11 | 1 | 34 | 0.09 | 0.08 | 1.100 | 10.1 | 182 | 4.6 | 181 |
| 29 | 10.3 | 11 | 11 | 0.7 | 87 | 0.06 | 0.04 | 0.733 | 8.9 | 178 | 4.8 | 178 |
| 30 | 37 | 38 | 40 | 3 | 45 | 0.08 | 0.07 | 1.000 | 14.1 | 89 | 7.5 | 80 |
| 31 | 47 | 48 | 50 | 3 | 25 | 0.06 | 0.04 | 0.714 | 8.9 | 46 | 7.5 | 51 |
| 32 | 56.5 | 57 | 60 | 3.5 | 81 | 0.06 | 0.27 | 3.000 | 30.8 | 26 | 9.0 | 29 |
| 33 | 5.5 | 6 | 6.5 | 1 | 52 | 0.15 | −0.02 | 0.108 | 5.5 | 196 | 3.7 | 193 |
| 34 | 11.5 | 12 | 12 | 0.5 | 88 | 0.04 | 0.02 | 0.480 | 7.8 | 177 | 4.1 | 174 |
| 35 | 24 | 24.5 | 25 | 1 | 41 | 0.04 | 0.01 | 0.417 | 5.1 | 129 | 4.7 | 130 |
| 36 | 24 | 26 | 30 | 6 | 80 | 0.20 | 0.02 | 0.500 | 7.2 | 136 | 5.0 | 125 |
| 37 | 25 | 30 | 36 | 11 | 95 | 0.31 | 0.27 | 3.000 | 12.5 | 127 | 6.5 | 115 |
| 38 | 24 | 25 | 36 | 12 | 37 | 0.33 | 0.03 | 0.600 | 6.1 | 135 | 7.2 | 128 |
| 39 | 49.5 | 50 | 50 | 0.5 | 44 | 0.01 | 0.47 | 5.000 | 18.5 | 56 | 7.0 | 50 |
| 40 | 35 | 37.5 | 50 | 15 | 57 | 0.30 | 0.14 | 1.667 | 10.4 | 96 | 7.9 | 87 |
| 41 | 8.5 | 10 | 12 | 3.5 | 41 | 0.29 | −0.01 | 0.240 | 5.9 | 186 | 4.9 | 181 |
| 42 | 48 | 49 | 50 | 2 | 38 | 0.04 | 0.17 | 2.000 | 22.2 | 41 | 7.9 | 49 |
| 43 | 19.5 | 20 | 20 | 0.5 | 85 | 0.03 | 0.02 | 0.500 | 6.3 | 148 | 4.6 | 146 |

| | Film characteristics | | | | | | | | |
|---|---|---|---|---|---|---|---|---|---|
| | Film | Haze | | Retardation | | | Water | Elastic | |
| Film | thickness | Average | Distribution | Re | Rth | ΔRth | content | modulus | Photoelasticity |
| No. | [μm] | [%] | [%] | [nm] | [nm] | [nm] | [wt %] | [GPa] | [Br] |
| 1 | 50 | 0.3 | 0.1 | 1 | −13 | 6 | 1.5 | 1.2 | 10 |
| 2 | 50 | 0.7 | 0.3 | 1 | −13 | 6 | 1.6 | 1.3 | 10 |
| 3 | 50 | 1.2 | 0.8 | 1 | −13 | 6 | 1.5 | 1.3 | 10 |
| 4 | 53 | 0.3 | 0.0 | 1 | −15 | 6 | 1.5 | 1.2 | 10 |
| 5 | 56 | 0.3 | 0.0 | 1 | −15 | 6 | 1.5 | 1.2 | 10 |
| 6 | 59 | 0.4 | 0.0 | 0 | −16 | 7 | 1.6 | 1.1 | 10 |
| 7 | 59 | 0.3 | 0.0 | 1 | −16 | 6 | 1.5 | 1.1 | 10 |
| 8 | 50 | 0.6 | 0.8 | 1 | −18 | 4 | 1.6 | 0.3 | 9 |
| 9 | 50 | 0.8 | 0.0 | 1 | −6 | 17 | 2.4 | 3.5 | 11 |
| 10 | 50 | 1.2 | 0.0 | 1 | −12 | 12 | 2.0 | 2.8 | 11 |
| 11 | 50 | 0.3 | 0.0 | 0 | −14 | 10 | 1.8 | 2.4 | 11 |
| 12 | 50 | 0.4 | 0.1 | 1 | −13 | 6 | 1.6 | 1.3 | 10 |
| 13 | 50 | 0.7 | 0.2 | 1 | −19 | 6 | 1.5 | 1.2 | 10 |
| 14 | 50 | 0.8 | 0.3 | 1 | −13 | 6 | 1.9 | 1.3 | 10 |
| 15 | 50 | 0.2 | 0.0 | 0 | 4 | 21 | 3.1 | 3.8 | 11 |
| 16 | 50 | 0.3 | 0.1 | 1 | −13 | 6 | 1.6 | 1.3 | 10 |
| 17 | 40 | 0.2 | 0.0 | 1 | 11 | 24 | 3.6 | 4.2 | 11 |
| 18 | 10 | 2.1 | 0.0 | 1 | 3 | 6 | 3.5 | 4.2 | 11 |
| 19 | 30 | 2.5 | 0.0 | 1 | −3 | 10 | 2.4 | 3.5 | 11 |
| 20 | 20 | 2.2 | 0.0 | 1 | 0 | 8 | 2.8 | 3.8 | 11 |
| 21 | 20 | 2.1 | 0.1 | 1 | −3 | 6 | 2.1 | 3.2 | 11 |
| 22 | 25 | 0.3 | 0.0 | 1 | 7 | 15 | 3.6 | 4.2 | 11 |
| 23 | 60 | 0.2 | 0.0 | 0 | 0 | 25 | 2.8 | 3.8 | 11 |
| 24 | 40 | 0.2 | 0.0 | 0 | 0 | 16 | 2.8 | 3.8 | 11 |
| 25 | 40 | 0.3 | 0.0 | 0 | −4 | 13 | 2.5 | 3.5 | 11 |
| 26 | 40 | 0.5 | 0.0 | 1 | −7 | 11 | 2.2 | 3.2 | 11 |
| 27 | 5 | 0.5 | 0.0 | 2 | 2 | 3 | 3.3 | 4.2 | 11 |
| 28 | 10 | 0.7 | 0.0 | 1 | 2 | 5 | 3.1 | 4.0 | 11 |
| 29 | 15 | 0.5 | 0.0 | 1 | 2 | 7 | 3.1 | 4.0 | 11 |
| 30 | 40 | 1.1 | 0.3 | 1 | −9 | 7 | 1.7 | 2.1 | 10 |
| 31 | 70 | 0.6 | 0.2 | 1 | −18 | 9 | 1.6 | 1.2 | 10 |
| 32 | 20 | 2.6 | 1.2 | 3 | −7 | 2 | 1.6 | 0.3 | 9 |
| 33 | 60 | 0.2 | 0.0 | 0 | 16 | 36 | 3.5 | 4.2 | 11 |
| 34 | 25 | 0.4 | 0.0 | 0 | 3 | 12 | 3.0 | 3.9 | 11 |
| 35 | 60 | 0.2 | 0.0 | 0 | −11 | 18 | 2.2 | 3.2 | 11 |
| 36 | 60 | 0.3 | 0.0 | 1 | −13 | 15 | 2.0 | 2.9 | 11 |
| 37 | 12 | 0.9 | 0.0 | 3 | −2 | 2 | 1.8 | 2.4 | 11 |
| 38 | 60 | 0.3 | 0.0 | 0 | −13 | 12 | 1.7 | 2.4 | 11 |
| 39 | 10 | 1.4 | 0.8 | 5 | −2 | 1 | 1.6 | 1.3 | 10 |
| 40 | 30 | 0.7 | 0.2 | 1 | −7 | 4 | 1.6 | 1.3 | 10 |
| 41 | 50 | 0.2 | 0.0 | 1 | 4 | 23 | 3.0 | 4.0 | 11 |
| 42 | 25 | 1.8 | 0.7 | 2 | −6 | 3 | 1.5 | 1.3 | 10 |
| 43 | 40 | 0.3 | 0.0 | 0 | 2 | 11 | 2.5 | 3.5 | 11 |

| | Roll | | | | | | |
|---|---|---|---|---|---|---|---|
| | External | | | | | | |
| | appearance | External | | Evaluation by mounting | | | |
| | immediately | appearance | Haze | Light unevenness | | | |
| Film | after | after | distribution | Initial | Forced | | |
| No. | treatment | lapsing | (%) | front | front | Oblique | Remark |
| 1 | B | B | 0.30 | A | A | A | Invention |
| 2 | B | B | 0.70 | A | A | A | Invention |
| 3 | D | D | 1.40 | A | A | A | Comparison |
| 4 | A | A | 0.10 | A | A | A | Invention |
| 5 | A | A | 0.00 | A | A | A | Invention |
| 6 | A | A | 0.10 | A | A | A | Invention |
| 7 | A | A | 0.00 | A | A | A | Invention |
| 8 | B | C | 0.80 | A | A | A | Invention |
| 9 | A | A | 0.10 | A | C | C | Invention |
| 10 | A | A | 0.10 | A | B | B | Invention |
| 11 | A | A | 0.10 | A | B | B | Invention |
| 12 | B | B | 0.40 | A | A | A | Invention |
| 13 | B | C | 0.70 | A | A | A | Invention |
| 14 | B | C | 0.90 | A | A | A | Invention |
| 15 | A | A | 0.00 | A | E | E | Comparison |
| 16 | A | A | 0.30 | A | A | A | Invention |
| 17 | B | B | 0.00 | A | D | D | Comparison |
| 18 | — | — | 0.00 | A | B | B | Comparison |
| 19 | C | D | 0.10 | A | B | B | Comparison |
| 20 | C | D | 0.00 | A | B | B | Comparison |
| 21 | C | D | 0.20 | A | A | A | Comparison |
| 22 | A | A | 0.00 | A | D | D | Comparison |
| 23 | A | A | 0.00 | A | D | D | Comparison |
| 24 | A | A | 0.00 | A | C | C | Invention |
| 25 | B | C | 0.00 | A | C | C | Invention |
| 26 | C | D | 0.20 | A | B | B | Comparison |
| 27 | — | — | 0.00 | A | A | A | Invention |
| 28 | — | — | 0.00 | A | A | A | Invention |
| 29 | — | — | 0.00 | A | B | B | Invention |
| 30 | C | C | 0.40 | A | A | A | Invention |
| 31 | B | B | 0.60 | A | B | B | Invention |
| 32 | — | — | 3.10 | A | A | A | Comparison |
| 33 | A | A | 0.00 | A | D | D | Comparison |
| 34 | A | B | 0.00 | A | C | C | Invention |
| 35 | A | B | 0.00 | A | C | C | Invention |
| 36 | A | A | 0.00 | A | C | C | Invention |
| 37 | — | — | 0.10 | A | A | A | Invention |
| 38 | A | A | 0.00 | A | B | B | Invention |
| 39 | — | — | 1.60 | A | A | A | Comparison |
| 40 | B | B | 0.30 | A | A | A | Invention |
| 41 | A | A | 0.00 | A | D | D | Comparison |
| 42 | D | D | 2.10 | A | A | A | Comparison |
| 43 | B | C | 0.00 | A | C | B | Invention |

In Table 2, “-” marked in “External appearance” represent that external appearance of the roll cannot be evaluated because the manufactured film does not have a roll shape but a sheet shape.

As shown in Tables 1 and 2, the optical film of the present invention has an excellent external appearance, and a liquid crystal display device into which a polarizing plate using the same as a protective film is inserted could sufficiently improve light leakage when observed from the front and the inclined surface.

What is claimed is:

1. An optical film, comprising:
an additive;
a wax component; and
a cellulose ester,
wherein the optical film satisfies the following equations (1) and (2):

|ΔC/Ct|≧0.1×(Ct/d−0.3) Equation (1)
Ct/d≧0.375 Equation (2)
wherein Ct represents a total content of the additive whose unit is % by mass,
d represents a film thickness whose unit is μm,
ΔC is represented by Ct−Cs:
wherein Cs represents a surface content of the additive in at least one side of the optical film, and
Ct and Cs are represented by the following formulae, respectively:
Ct=(total mass of the additive contained in the entire optical film)/(total mass of the cellulose ester contained in the entire optical film)×100
Cs=(mass of the additive contained in a region from the surface of the optical film to 3 μm away from the surface of the optical film)/(mass of the cellulose ester contained in a region from the surface of the optical film to 3 μm away from the surface of the optical film)×100.

2. The optical film according to claim 1,
wherein the additive is a compound having repeating units.

3. The optical film according to claim 1,
wherein the additive contains a condensate between a polyalcohol and a polybasic acid.

4. The optical film according to claim 3,
wherein the additive is a condensate between a glycol having carbon atoms of 2 to 12 and a dibasic acid having carbon atoms of 4 to 12.

5. The optical film according to claim 1,
wherein the wax component contains at least one selected from the group consisting of a fatty acid, a metal salt of fatty acid and a fatty acid ester.

6. The optical film according to claim 1,
wherein the ΔC is greater than zero.

7. The optical film according to claim 1,
wherein the ΔC is calculated by using a smaller value among Cs at one side of the optical film and Cs at the other side of the optical film

8. The optical film according to claim 1,
wherein absolute value of the ΔC is 50% by mass or less.

9. The optical film according to claim 1,
wherein the Cs is 50% by mass or less.

10. The optical film according to claim 1, further comprising a compound represented by Formula (1) or (2): 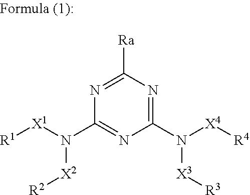
wherein Ra represents a substituted or unsubstituted alkyl group, a substituted or unsubstituted alkenyl group, a substituted or unsubstituted alkynyl group, a substituted or unsubstituted heterocyclic group, or a substituted or unsubstituted aryl group,
X¹, X², X³ and X⁴ each independently represent a single bond or a divalent linking group, and
R¹, R², R³ and R⁴ each independently represent a hydrogen atom, a substituted or unsubstituted alkyl group, a substituted or unsubstituted alkenyl group, a substituted or unsubstituted alkynyl group, a substituted or unsubstituted aryl group, a substituted or unsubstituted acyl group or a substituted or unsubstituted heterocyclic group: 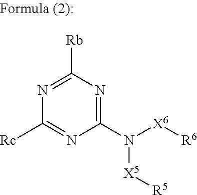
wherein Rb and Rc each independently represent a substituted or unsubstituted alkyl group, a substituted or unsubstituted alkenyl group, a substituted or unsubstituted alkynyl group, a substituted or unsubstituted heterocyclic group, or a substituted or unsubstituted aryl group, and
X⁵ and X⁶ each independently represent a single bond or a divalent linking group,
R⁵ and R⁶ each independently represent a hydrogen atom, a substituted or unsubstituted alkyl group, a substituted or unsubstituted alkenyl group, a substituted or unsubstituted alkynyl group, a substituted or unsubstituted aryl group, a substituted or unsubstituted acyl group, or a substituted or unsubstituted heterocyclic group.

11. The optical film according to claim 1,
wherein a surface roughness (Ra) on at least one surface is more than 3 nm, and
a surface hardness on the surface is 50 N/mm² or more.

12. The optical film according to claim 1,
wherein a surface roughness (Ra) on at least one surface is 3 nm or less.

13. The optical film according to claim 1,
wherein a thickness of the optical film is 5 to 120 μm.

14. The optical film according to claim 1,
wherein the cellulose ester contains at least cellulose acylate, and
the cellulose acylate satisfies a relation of DSs≦DSc:
wherein DSs represents a degree of substitution of acyl of the cellulose acylate contained in a region from the surface of the optical film to 1 μm away in a thickness direction of the optical film, and
DSc represents a degree of substitution of acyl of cellulose acylate contained in a region from the center in the thickness direction of the optical film to 1 μm away in the thickness direction.

15. A laminate comprising at least two optical films according to claim 1.

16. A phase difference film comprising at least the optical film according to claim 1.

17. A polarizing plate comprising at least the optical film according to claim 1.

18. An image display device comprising at least the optical film according to claim 1.

19. A method for manufacturing the optical film according to claim 1, the method comprising:
casting at least two layers by a co-casting method,
wherein at least one layer of the at least two layers is a layer comprising the additive, the wax component and the cellulose ester, and
in the at least two layers, content (c1) of the additive relative to the cellulose ester in a dope solution for forming the at least one layer, whose unit is % by mass, and content (c2) of an additive relative to the cellulose ester in a dope solution for forming a layer other than the at least one layer, whose unit is % by mass, satisfy a relation of |Δc=c2−c1|≧2.

20. The method according to claim 19,
wherein the Δc is greater than zero, and
the dope solution having the additive content of c2 is disposed on a side in contact with a casting support.

21. A method for manufacturing the optical film according to claim 1, the method comprising:
casting at least two layers by a co-casting method,
wherein at least one layer of the at least two layers is a layer containing the additive, the wax component and the cellulose ester,
in the at least two layers, solid concentration (d1) in a dope solution for forming the at least one layer and solid concentration (d2) in a dope solution for forming the other layer satisfy a relationship of d1>d2, and
the dope solution having the solid concentration of d2 is disposed on a side in contact with a casting support.

22. The method according to claim 19,
wherein absolute value of the ΔC is 50% by mass or less.
